(19) United States
(12) Patent Application Publication
(10) Pub. No.: US 2018/0136319 A1
(43) Pub. Date: May 17, 2018

(54) DETECTOR FOR AN OPTICAL DETECTION OF AT LEAST ONE OBJECT

(71) Applicant: trinamiX GmbH, Ludwigshafen (DE)

(72) Inventors: Robert SEND, Karlsruhe (DE); Ingmar BRUDER, Neuleiningen (DE); Sebastian VALOUCH, Lampertheim (DE)

(73) Assignee: trinamiX GmbH, Ludwigshafen (DE)

(21) Appl. No.: 15/567,885

(22) PCT Filed: Apr. 18, 2016
(86) PCT No.: PCT/EP2016/058487

§ 371 Date: Oct. 19, 2017

(30) Foreign Application Priority Data
Apr. 22, 2015 (EP) 15164653.6

(51) Int. Cl. G01S 7/481; G01S 17/66; G01S 17/46

(52) U.S. Cl. CPC G01S 7/4816; G01S 17/46; G01S 17/66

(57) ABSTRACT

A detector for an optical detection of an object, including:
a longitudinal optical sensor having a sensor region and designed to generate a longitudinal sensor signal in a manner dependent on an illumination of the sensor region by a light beam, where the longitudinal sensor signal, given the same total power of the illumination, exhibits a dependency on a beam cross-section of the light beam in the sensor region, and is generated by a semiconducting material contained in the sensor region, where a high-resistive material is present at a part of a surface of the semiconducting material, where the high-resistive material exhibits an electrical resistance which equals or exceeds the electrical resistance of the semiconducting material; and
an evaluation device, where the evaluation device is designed to generate an item of information on a longitudinal position of the object by evaluating the longitudinal sensor signal of the longitudinal optical sensor.

### FIELD OF THE INVENTION

The invention relates to a detector for an optical detection of at least one object, in particular, for determining a position of at least one object, specifically with regard to a depth or both to the depth and a width of object. Furthermore, the invention relates to a human-machine interface, an entertainment device, a tracking system, and a camera. Further, the invention relates to a method for optical detection of at least one object and to various uses of the detector. Such devices, methods and uses can be employed for example in various areas of daily life, gaming, traffic technology, mapping of spaces, production technology, security technology, medical technology or in the sciences. However, further applications are possible.

### PRIOR ART

Various detectors for optically detecting at least one object are known on the basis of optical sensors.

WO 2012/110924 A1 discloses a detector comprising at least one optical sensor, wherein the optical sensor exhibits at least one sensor region. Herein, the optical sensor is designed to generate at least one sensor signal in a manner dependent on an illumination of the sensor region. According to the so-called “FiP-effect”, the sensor signal, given the same total power of the illumination, hereby exhibits a dependency on a geometry of the illumination, in particular on a beam cross-section of the illumination on the sensor region. The detector furthermore has at least one evaluation device designated to generate at least one item of geometrical information from the sensor signal, in particular at least one item of geometrical information about the illumination and/or the object. As an example, the optical sensors may be or may comprise a dye-sensitized solar cell (DSC), preferably a solid dye-sensitized solar cell (sDSC).

WO 2014/097181 A1 discloses a method and a detector for determining a position of at least one object, by using at least one transversal optical sensor and at least one longitudinal optical sensor. Preferably, a stack of longitudinal optical sensors is employed, in particular to determine a longitudinal position of the object with a high degree of accuracy and without ambiguity. In addition, WO 2014/097181 A1 discloses a human-machine interface, an entertainment device, a tracking system, and a camera, each comprising at least one such detector for determining a position of at least one object.

Further, PCT patent application No. PCT/EP2016/051817, filed Jan. 28, 2016, the full content of which is incorporated herein by reference, discloses an optical sensor comprising a photoconductive material, which may be an inorganic photoconductive material, preferably selected from the group consisting of selenium, a metal oxide, a group IV element or compound, a III-V compound, a II-VI compound, and a chalcogenide, or an organic photoconductive material.

Despite the advantages implied by the above-mentioned devices and detectors, specifically by the detectors as disclosed in WO 2012/110924 A1, WO 2014/097181 A1 and PCT patent application No. PCT/EP2016/051817, filed Jan. 28, 2016, there still is a need for improvements with respect to a simple, cost-efficient and, still, reliable spatial detector. In particular, it would be desirable to use a single FiP sensor and still be able to determine a longitudinal position of the object without ambiguity.

### Problem Addressed by the Invention

Therefore, a problem addressed by the present invention is that of specifying a device and a method for optically detecting at least one object which at least substantially avoid the disadvantages of known devices and methods of this type. In particular, an improved spatial detector for determining the position of an object in space which could provide a low detection noise level would be desirable.

### SUMMARY OF THE INVENTION

This problem is solved by the invention with the features of the independent patent claims. Advantageous developments of the invention, which can be realized individually or in combination, are presented in the dependent claims and/or in the following specification and detailed embodiments.

As used herein, the expressions “have”, “comprise” and “contain” as well as grammatical variations thereof are used in a non-exclusive way. Thus, the expression “A has B” as well as the expression “A comprises B” or “A contains B” may both refer to the fact that, besides B, A contains one or more further components and/or constituents, and to the case in which, besides B, no other components, constituents or elements are present in A.

In a first aspect of the present invention, a detector for optical detection, in particular, for determining a position of at least one object, specifically with regard to a depth or to both the depth and a width of the at least one object is disclosed.

The “object” generally may be an arbitrary object, chosen from a living object and a non-living object. Thus, as an example, the at least one object may comprise one or more articles and/or one or more parts of an article. Additionally or alternatively, the object may be or may comprise one or more living beings and/or one or more parts thereof, such as one or more body parts of a human being, e.g. a user, and/or an animal.

As used herein, a “position” generally refers to an arbitrary item of information on a location and/or orientation of the object in space. For this purpose, as an example, one or more coordinate systems may be used, and the position of the object may be determined by using one, two, three or more coordinates. As an example, one or more Cartesian coordinate systems and/or other types of coordinate systems may be used. In one example, the coordinate system may be a coordinate system of the detector in which the detector has a predetermined position and/or orientation. As will be outlined in further detail below, the detector may have an optical axis, which may constitute a main direction of view of the detector. The optical axis may form an axis of the coordinate system, such as a z-axis. Further, one or more additional axes may be provided, preferably perpendicular to the z-axis.

Thus, as an example, the detector may constitute a coordinate system in which the optical axis forms the z-axis and in which, additionally, an x-axis and a y-axis may be provided which are perpendicular to the z-axis and which are perpendicular to each other. As an example, the detector and/or a part of the detector may rest at a specific point in this coordinate system, such as at the origin of this coordinate system. In this coordinate system, a direction parallel or antiparallel to the z-axis may be regarded as a longitudinal direction, and a coordinate along the z-axis may be considered a longitudinal coordinate. An arbitrary direction perpendicular to the longitudinal direction may be considered a transversal direction, and an x- and/or y-coordinate may be considered a transversal coordinate.

Alternatively, other types of coordinate systems may be used. Thus, as an example, a polar coordinate system may be used in which the optical axis forms a z-axis and in which a distance from the z-axis and a polar angle may be used as additional coordinates. Again, a direction parallel or antiparallel to the z-axis may be considered a longitudinal direction, and a coordinate along the z-axis may be considered a longitudinal coordinate. Any direction perpendicular to the z-axis may be considered a transversal direction, and the polar coordinate and/or the polar angle may be considered a transversal coordinate.

As used herein, the detector for optical detection generally is a device which is adapted for providing at least one item of information on the position of the at least one object. The detector may be a stationary device or a mobile device. Further, the detector may be a stand-alone device or may form part of another device, such as a computer, a vehicle or any other device. Further, the detector may be a hand-held device. Other embodiments of the detector are feasible.

The detector may be adapted to provide the at least one item of information on the position of the at least one object in any feasible way. Thus, the information may e.g. be provided electronically, visually, acoustically or in any arbitrary combination thereof. The information may further be stored in a data storage of the detector or a separate device and/or may be provided via at least one interface, such as a wireless interface and/or a wire-bound interface.

The detector for an optical detection of at least one object according to the present invention comprises:
at least one longitudinal optical sensor, wherein the longitudinal optical sensor has at least one sensor region, wherein the longitudinal optical sensor is designed to generate at least one longitudinal sensor signal in a manner dependent on an illumination of the sensor region by a light beam, wherein the longitudinal sensor signal, given the same total power of the illumination, exhibits a dependency on a beam cross-section of the light beam in the sensor region, wherein the longitudinal sensor signal is generated by at least one semiconducting material comprised in the sensor region, wherein a high-resistive material is present at a part of a surface of the semiconducting material, wherein the high-resistive material exhibits an electrical resistance which equals or exceeds the electrical resistance of the semiconducting material;
and
at least one evaluation device, wherein the evaluation device is designed to generate at least one item of information on a longitudinal position of the object by evaluating the longitudinal sensor signal of the longitudinal optical sensor.

Herein, the components listed above may be separate components. Alternatively, two or more of the components as listed above may be integrated into a single component. Further, the at least one evaluation device may be formed as a separate evaluation device independent from the transfer device and the longitudinal optical sensors, but may preferably be connected to the longitudinal optical sensors in order to receive the longitudinal sensor signal. Alternatively, the at least one evaluation device may fully or partially be integrated into the longitudinal optical sensors.

As used herein, the “longitudinal optical sensor” is generally a device which is designed to generate at least one longitudinal sensor signal in a manner dependent on an illumination of the sensor region by the light beam, wherein the longitudinal sensor signal, given the same total power of the illumination, is dependent, according to the FiP-effect on a beam cross-section of the light beam in the sensor region. The longitudinal sensor signal may generally be an arbitrary signal indicative of the longitudinal position, which may also be denoted as a depth. As an example, the longitudinal sensor signal may be or may comprise a digital and/or an analog signal. As an example, the longitudinal sensor signal may be or may comprise a voltage signal and/or a current signal. Additionally or alternatively, the longitudinal sensor signal may be or may comprise digital data. The longitudinal sensor signal may comprise a single signal value and/or a series of signal values. The longitudinal sensor signal may further comprise an arbitrary signal which is derived by combining two or more individual signals, such as by averaging two or more signals and/or by forming a quotient of two or more signals. For potential embodiments of the longitudinal optical sensor and the longitudinal sensor signal, reference may be made to the optical sensor as disclosed in WO 2012/110924 A1 or WO 2014/097181 A1.

Herein, the at least one longitudinal optical sensor exhibits at least one sensor region, wherein the sensor region comprises at least one semiconducting material, wherein the semiconducting material may comprise a single-phase material or at least two, preferably two or three, separate phases of semiconducting materials. As further used herein, the term “phase” may refer to a homogeneous composition within a definite volume of the material or a part thereof. Herein, the definite volume may exhibit a coherent arrangement, such as in form of a bulk material or in form of a porous material, in which pores may comprise one or more further phases which may each exhibit a second material, such as a further semiconducting material, a low-resistive material, such as a metallically conducting material, a high-resistive material, such as an isolating material, or a fluid, such as a gaseous or liquid composition. Alternatively or in addition, the volume may exhibit an incoherent arrangement, such as by forming individual volumes which may be separated by one or more further phases, which may each comprise one of the second materials as described above. Preferably, the semiconducting material may comprise an extrinsic semiconductor, in which electronic properties of the semiconducting material have been altered by introducing a doping agent, thus influencing a charge carrier concentration within the semiconducting material. As known from the state of the art, the semiconducting material may, thus, be selected from an n-type semiconducting material, in which the charge carriers are predominantly provided by electrons, or a p-type semiconducting material, in which the charge carriers are predominantly provided by holes. Further, an undoped intrinsic i-type semiconducting material may still be located between the n-type semiconducting material and the p-type semiconducting material. However, further arrangements may be feasible.

Generally, the semiconducting material exhibits an electrical conductivity typically having a value from 10⁻⁶ S/m to 10³ S/m, i.e. between the electrical conductivity of a metallic material (10³ S/m or above, in particular 10⁶ S/m or above) and of an isolating material (below 10⁻⁶ S/m, in particular 10⁻⁸ S/m or below). Hereby, the value of the electrical conductivity determines a capability of the mentioned materials to carry an electrical current. With particular respect to the semiconducting material, the electrical conductivity, in general, depends on the number of charge carriers, wherein the number of charge carriers is dependent on the type of material as well as on the type and amount of a dopant as inserted into the material. As further used herein, an “electrical resistance” of a specific material denotes the reciprocal value of the electrical conductivity. Thus, the semiconducting material in the sensor region exhibits a specific value for the electrical resistance.

For the purposes of the present invention, the semiconducting material as comprised in the sensor region of the longitudinal optical sensor may, preferably, comprise an inorganic semiconducting material, an organic semiconducting material or a combination thereof.

Within this regard, the inorganic semiconducting material may, in particular, comprise one or more of selenium, tellurium, a selenium-tellurium alloy, a metal oxide, a group IV element or compound, i.e. at least one element from group IV or a chemical compound with at least one group IV element, a group III-V compound, i.e. a chemical compound with at least one group III element and at least one group V element, a group II-VI compound, i.e. a chemical compound with at least one group II element and at least one group VI element, and/or a chalcogenide. However, other inorganic semiconducting materials may equally be appropriate.

With regard to the metal oxide, this kind of semiconducting material may be selected from a group comprising copper (II) oxide (CuO), copper (I) oxide (CuO₂), nickel oxide (NiO), zinc oxide (ZnO), silver oxide (Ag₂O), manganese oxide (MnO), titanium dioxide (TiO₂), barium oxide (BaO), lead oxide (PbO), cerium oxide (CeO₂), bismuth oxide (Bi₂O₃), and cadmium oxide (CdO). Further ternary, quarternary or higher metal oxides may also be applicable.

With regard to a group IV element or compound, this kind of semiconducting material may be selected from a group comprising doped diamond (C), doped silicon (Si), silicon carbide (SiC), and silicon germanium (SiGe).

With regard to the III-V compound, this kind of semiconducting material may be selected from a group comprising indium antimonide (InSb), boron nitride (BN), boron phosphide (BP), boron arsenide (BAs), aluminum nitride (AlN), aluminum phosphide (AlP), aluminum arsenide (AlAs), aluminum antimonide (AlSb), indium nitride (InN), indium phosphide (InP), indium arsenide (InAs), indium antimonide (InSb), gallium nitride (GaN), gallium phosphide (GaP), gallium arsenide (GaAs), and gallium antimonide (GaSb).

With regard to the II-VI compound, this kind of semiconducting material may be selected from a group comprising cadmium sulfide (CdS), cadmium selenide (CdSe), cadmium telluride (CdTe), zinc sulfide (ZnS), zinc selenide (ZnSe), zinc telluride (ZnTe), mercury sulfide (HgS), mercury selenide (HgSe), mercury telluride (HgTe), cadmium zinc telluride (CdZnTe), mercury cadmium telluride (HgCdTe), mercury zinc telluride (HgZnTe), and mercury zinc selenide (CdZnSe). However, other II-VI compounds may be feasible.

With regard to the chalcogenide, this kind of semiconducting material may be selected from a group comprising sulfide chalcogenides, selenide chalcogenides, telluride chalcogenides, ternary chalcogenides, quaternary and higher chalcogenides, as long as they exhibit suitable semiconducting properties.

In particular, the sulfide chalcogenide may be selected from a group comprising lead sulfide (PbS), cadmium sulfide (CdS), zinc sulfide (ZnS), mercury sulfide (HgS), silver sulfide (Ag₂S), manganese sulfide (MnS), bismuth trisulfide (Bi₂S₃), antimony trisulfide (Sb₂S₃), arsenic trisulfide (As₂S₃), tin (II) sulfide (SnS), tin (IV) disulfide (SnS₂), indium sulfide (In₂S₃), copper sulfide (CuS), cobalt sulfide (CoS), nickel sulfide (NiS), molybdenum disulfide (MoS₂), iron disulfide (FeS₂), and chromium trisulfide (CrS₃).

In particular, the selenide chalcogenide may be selected from a group comprising lead selenide (PbSe), cadmium selenide (CdSe), zinc selenide (ZnSe), bismuth triselenide (Bi₂Se₃), mercury selenide (HgSe), antimony triselenide (Sb₂Se₃), arsenic triselenide (As₂Se₃), nickel selenide (NiSe), thallium selenide (TlSe), copper selenide (CuSe), molybdenum diselenide (MoSe₂), tin selenide (SnSe), and cobalt selenide (CoSe), and indium selenide (In₂Se₃).

In particular, the telluride chalcogenide may be selected from a group comprising lead telluride (PbTe), cadmium telluride (CdTe), zinc telluride (ZnTe), mercury telluride (HgTe), bismuth tritelluride (Bi₂Te₃), arsenic tritelluride (As₂Te₃), antimony tritelluride (Sb₂Te₃), nickel telluride (NiTe), thallium telluride (TlTe), copper telluride (CuTe), molybdenum ditelluride (MoTe₂), tin telluride (SnTe), and cobalt telluride (CoTe), silver telluride (Ag₂Te), and indium telluride (In₂Te₃).

In particular, the ternary chalcogenide may be selected from a group comprising mercury cadmium telluride (HgCdTe), mercury zinc telluride (HgZnTe), mercury cadmium sulfide (HgCdS), lead cadmium sulfide (PbCdS), lead mercury sulfide (PbHgS), copper indium disulfide (CuInS₂), cadmium sulfoselenide (CdSSe), zinc sulfoselenide (ZnSSe), thallous sulfoselenide (TlSSe), cadmium zinc sulfide (CdZnS), cadmium chromium sulfide (CdCr₂S₄), mercury chromium sulfide (HgCr₂S₄), copper chromium sulfide (CuCr₂S₄), cadmium lead selenide (CdPbSe), copper indium diselenide (CuInSe₂), indium gallium arsenide (InGaAs), lead oxide sulfide (Pb₂OS), lead oxide selenide (Pb₂OSe), lead sulfoselenide (PbSSe), arsenic selenide telluride (As₂Se₂Te), indium gallium phosphide (InGaP), gallium arsenide phosphide (GaAsP), aluminium gallium phosphide (AlGaP), cadmium selenite (CdSeO₃), cadmium zinc telluride (CdZnTe), and cadmium zinc selenide (CdZnSe), further combinations by applying compounds from the above listed binary chalcogenides and/or binary III-V-compounds.

Alternatively or in addition, the organic semiconducting material may, in particular, be or comprise a semiconducting organic compound selected from the group comprising phthalocyanines, naphthalocyanines, subphthalocyanines, perylenes, anthracenes, pyrenes, oligo- and polythiophenes, fullerenes, indigoid dyes, bis-azo pigments, squarylium dyes, thiapyrilium dyes, azulenium dyes, dithioketo-pyrrolopyrroles, quinacridones, dibromoanthanthrone, polyvinylcarbazole, derivatives and combinations thereof.

Further, PCT patent application No. PCT/EP2016/051817, filed Jan. 28, 2016, the full content of which is incorporated herein by reference, discloses a number of semiconducting materials which may equally be applicable for the purposes of the present invention.

Further, the sensor region of the longitudinal optical sensor comprising the semiconducting material is illuminated by at the least one light beam. Given the same total power of the illumination, a photocurrent within the semiconducting material in the sensor region, therefore, depends on the beam cross-section of the light beam in the sensor region, be denominated as a “spot size” generated by the incident beam within the sensor region. Thus, the observable property that the photocurrent within the semiconducting material in the sensor region depends on an extent of the illumination of the sensor region which comprises the semiconducting material by an incident light beam particularly accomplishes that two light beams comprising the same total power but impinging with different spot sizes onto the sensor region provide different values for the photocurrent within the semiconducting material in the sensor region and are, consequently, distinguishable with respect to each other.

It is generally assumed that the photocurrent in the sensor region may be attributed to the charge carriers which, as described above, are available within the semiconducting material. In order to be able to actually determine at least one value of the photocurrent within the semiconducting material in the sensor region, the semiconducting material may, preferably, be embedded between at least two electrodes, wherein the electrodes may, in particular, exhibit a value for the electrical conductivity which is above the value for the electrical conductivity for the semiconducting material in order to provide a high conductivity for the charge carriers therein. As a result, the one or more values of the photocurrent may be acquired by measuring one or more of an electrical current or an electrical voltage across the sensor region or a part thereof by using the electrodes. For this purpose, an electrical field may, thus, be applied and/or created across at least a part of the semiconducting material in the sensor region. Hereby, one or more values of the longitudinal sensor signal as generated by the optical detector which are based on the at least one value of the photocurrent may be obtained.

In order to allow the light beam to impinge on the semiconducting material within the sensor region, preferably, at least one of the electrodes may be transparent with respect to a wavelength of the incident light beam. Thus, the transparent electrode may be selected from an electrically conducting transparent substance, preferably from a transparent conducting oxide, in particular from indium tin oxide (ITO, or tin-doped indium oxide), i.e. a solid solution of indium(III) oxide (In₂O₃) and tin(IV) oxide (SnO₂), such as 90 wt % In₂O₃ and 10 wt % SnO₂, which, according to the state of the art, comprises a high electrical conductivity. Simultaneously, ITO is known to be transparent and colorless in thin layers in the visible spectral range from 380 nm to 780 nm while it exhibits opaque properties in both the infrared (IR) spectral range and the ultraviolet (UV) spectral range. However, other transparent electrode materials may be used, such as, in the visible spectral range, layers of one or more of fluorine tin oxide (SnO₂:F or FTO), aluminum zinc oxide (ZnO:Al or AZO), antimony tin oxide (SnO₂:Sb or ATO), or graphene. However, for other spectral ranges, further materials may be suited.

According to the present invention, the semiconducting material is arranged within the sensor region in a manner that a part of a surface of the semiconducting material may experience a value for the electrical resistance which may at least equal or, preferably, exceed the value of the electrical resistance as determined for the phase of the semiconducting material. According to the present invention, this kind of arrangement is achieved by providing a high-resistive material being present at a part of the surface of the semiconducting material. Herein, the term “high-resistive material” refers to a material which exhibits an electrical resistance that at least equals or, preferably, exceeds the electrical resistance of the semiconducting material which is located adjacent to the high-resistive material but does not constitute an isolating material as defined above. Within this regard, it may particularly be sufficient that charge carriers which may reach the surface of the semiconducting material may encounter with the high-resistive material, wherein the high-resistive material may, preferably, be different from the semiconducting material but may, alternatively, even comprise the same kind of semiconducting material as long as the high-resistive material may at least be separated from the semiconducting material by a boundary, an interface and/or a junction. As used herein, any of the terms “boundary”, “interface” and “junction” may refer to a scaling behavior of the involved materials, i.e. the semiconducting material and the high-resistive material being located at at least two sides of the boundary, the interface and/or the junction, with respect to their electrically conducting properties. Herein, the scaling behavior which, in particular, occurs within the boundary, the interface and/or the junction of the involved materials comprises an alteration of a value of their electrically conducting properties. Whereas in theory the scaling behavior may be described by a non-continuous function, in the real boundary, the interface and/or the junction always a continuous transition may be observed.

In particular, the resistive behavior within the boundary, the interface and/or the junction between the semiconducting material and the high-resistive material may comprise a nonlinear form. In a preferred embodiment, the nonlinear behavior of the electrical resistance within the boundary, the interface and/or the junction between the semiconducting material and the high-resistive material may, thus, be tailored in order to cause a linear dependence of the photocurrent with respect to the focus spot diameter. As will be explained below in more detail, the high-resistive material may, thus, assume a number of different forms, and may, in particular, be selected from at least one of a high-resistive layer, a high-resistive coating, a high-resistive depletion zone, a high-resistive tunneling barrier, a high-resistive band-to-band interface, a high-resistive Schottky barrier.

By this kind of arrangement, the illumination of the sensor region which comprises the semiconducting material located adjacently to the high-resistive material may be capable of generating an additional electrical field within the semiconducting material which may be oriented in an opposing direction with respect to the electrical field as applied and/or generated when determining the photocurrent in the semiconducting material. As already described above, it is generally assumed that the photocurrent in the sensor region may be attributed to the charge carriers within the semiconducting material. However, the additional electrical field oriented in the opposing direction may exert a kind of influence onto the charge carriers available in the semiconducting material. Whereas the electrical field used for determining the photocurrent in the semiconducting material may, preferably, be applied for collecting those charge carriers which comprise a specific charge, i.e. the negatively charged electrons separately from the positively charged holes, within the semiconducting material in order to guide them to the corresponding electrode, the orientation of the additional electrical field may, on the other hand, decrease the influence of the existing electrical field and, moreover, lead to a recombination of charge carriers which comprise the opposite charge, in particular by recombining a negatively charged electron with a positively charged hole. By the described effect of recombination, however, the number of charge carriers which are available within the semiconducting layer is diminished.

Consequently, in the area of the sensor region which is illuminated by the incident light beam, i.e. within a spot on the sensor region at which the light beam impinges onto the semiconducting material, the number of available charge carriers is reduced. However, the intensity of the additional electrical field within the semiconducting material depends on the power of the illumination of the semiconducting material. Given the same power of the illumination, the intensity of the additional field per illuminated area, thus, increases with decreasing spot size. As a result, the photocurrent which may be determined in the semiconducting material exhibits a dependency on the area in the sensor region which is illuminated by the incident light beam, i.e. on a beam cross-section of the light beam impinging onto the sensor region. Thus, provided the same total power of the illumination is impinging onto the sensor region, the longitudinal sensor signal which depends on the number of charge carriers in the semiconducting material exhibits a dependency on the beam cross-section of the light beam within the sensor region. This result, however, describes nothing else but the desired FiP-effect which can, thus, also be observed in the optical detector according to the present invention, i.e. the optical detector comprising the at least one semiconducting material comprised in the sensor region, wherein a part of the surface of the semiconducting material is adjacent to the above-defined high-resistive material.

As a result, the longitudinal optical sensor which comprises the semiconducting material located adjacent to the high-resistive material within the sensor region, thus, principally allows determining the beam cross-section of the light beam in the sensor region from a recording of the longitudinal sensor signal, such as by comparing at least two longitudinal sensor signals, at least one item of information on the beam cross-section, specifically on the beam diameter. Further, since the beam cross-section of the light beam in the sensor region, according to the above-mentioned FiP-effect, given the same total power of the illumination, depends on the longitudinal position or depth of an object which emits or reflects the light beam which impinges on the sensor region, the longitudinal optical sensor may, therefore, be applied to determining a longitudinal position of the respective object.

As already known from WO 2012/110924 A1, the longitudinal optical sensor is designed to generate at least one longitudinal sensor signal in a manner dependent on an illumination of the sensor region, wherein the sensor signal, given the same total power of the illumination depends on a beam cross-section of the illumination on the sensor region. As an example, a measurement of a photocurrent as a function of a position of a lens is provided there, wherein the lens is configured for focusing electromagnetic radiation onto the sensor region of the longitudinal optical sensor. During the measurement, the lens is displaced relative to the longitudinal optical sensor in a direction perpendicular to the sensor region in a manner that, as a result, the diameter of the light spot on the sensor region changes. In this particular example in which a photovoltaic device, in particular, a dye solar cell, is employed as the material in the sensor region, the signal of the longitudinal optical sensor, in this case a photocurrent, clearly depends on the geometry of the illumination such that, outside a maximum at the focus of the lens, the photocurrent falls to less than 10% of its maximum value.

Thus, according to the FiP-effect, the longitudinal sensor signal, given the same total power, may exhibit at least one pronounced maximum for one or a plurality of focusings and/or for one or a plurality of specific sizes of the light spot on the sensor region or within the sensor region. For purposes of comparison, an observation of a maximum of the longitudinal sensor signal in a condition in which the corresponding material is impinged by a light beam with the smallest possible cross-section, such as when the material may be located at or near a focal point as affected by an optical lens, may be denominated as a “positive FiP-effect”. As has been described in WO 2012/110924 A1, the above-mentioned photovoltaic devices, in particular, the dye-sensitized solar cell (DSC), preferably a solid dye-sensitized solar cell (sDSC), provide a positive FiP-effect under these circumstances.

On the other hand, among further materials, such as the material classes which are disclosed in PCT patent application No. PCT/EP2016/051817, filed Jan. 28, 2016, also the semiconducting material located adjacent to the high-resistive material within the sensor region as described herein may exhibit a “negative FiP-effect”, which, in correspondence to the definition of the positive FiP-effect, describes an observation of a minimum of the longitudinal sensor signal under a condition in which the corresponding material is impinged by a light beam with the smallest available beam cross-section, in particular, when the material may be located at or near a focal point as effected by an optical lens. As presented above, the occurrence of the negative FiP-effect may be explained by the observation that the number of charge carriers within the semiconducting material experiencing the high-resistive material may be diminished in illuminated areas of the sensor region by the recombination as caused by the additional electrical field generated within the spot of the light beam in the sensor region. Since the intensity of the additional electrical field is dependent on the power of the illumination of the semiconducting material, the intensity of the additional field per illuminated area increases with decreasing spot size, given the same power of the illumination. As a result, the recombination rate of the charge carriers and, thus, the number of the remaining charge carriers in the semiconducting material may depend on the spot size. Consequently, the photocurrent which depends on the number of the charge carriers may be smaller in a case of a small beam cross-section compared to the case of a large beam cross-section, thus, resulting in the observation of the negative FiP-effect in the optical detector according to the present invention.

It is emphasized here that the described effect of the recombination of charge carriers within the semiconducting material may only be observed in the arrangement as disclosed herein, in which a part of the surface of the semiconducting material being adjacent to the high-resistive material acts as a high-resistive boundary, interface and/or junction with respect to the semiconducting material, in particular for a purpose of restricting the mean free path of the charge carriers to a volume particularly located within the semiconducting layer and, thus, enabling the recombination of the charge carriers being constrained in such a way. Whereas the charge carriers within the semiconducting material of a conventional silicon diode may assume a large mean free path allowing them to diffuse over considerably large volumes, the charge carriers in the arrangement according to the present invention can, thus, easily recombine at the high-resistive boundary, the interface or the junction that may be available in the present arrangement.

This observation concerning the occurrence of the FiP-effect in the longitudinal optical sensor according to the present invention is, therefore, in a particularly striking contrast with regard to comparative measurements as, for example, described in WO 2012/110924 A1, wherein classical sensors, i.e. conventional inorganic photo detecting devices, such as silicon diodes, germanium diodes, or CMOS devices, have been employed as the semiconducting material in the sensor region. Thus, in the arrangement as described in WO 2012/110924 A1, in which the classical sensors are used, the longitudinal sensor signal, given the same total power of the illumination, is substantially independent of the geometry of the illumination of the sensor region. The reason for this different behavior as found in the classical sensors may, however, be explained by the observation that in the classical sensors no high-resistive boundary, interface and/or junction is present at the surface of the semiconducting material but that therein the surface of the semiconducting material is adjacent to a low-resistive, i.e. high-conductive, electrode material. The classical sensors being used in the state of the art are therefore—in marked contrast to the present invention—devoid of being capable of providing a significant rate of recombination of the charge carriers within the semiconducting material upon impingement by incident light. As a result, no FiP-effect which may be based on the described mechanism can be observed in the classical sensors, such as silicon diodes, germanium diodes, or CMOS devices, albeit they comprise semiconducting materials. Only the allocation of the high-resistive material at a considerable part of the surface of the semiconducting material allows an appreciable recombination being sufficient for providing the FiP-effect.

Further, the kinds of materials addressed here and a photovoltaic material may be emphasized. In a longitudinal optical sensor comprising a photovoltaic material, an illumination of the respective sensor region may generate charge carriers which may provide a photoelectric current or a photoelectric voltage across the sensor region to be determined. As an example, when a light beam may be incident upon a photovoltaic material, the electrons which may be present in a valence band of the material may absorb energy and, thus being excited, may jump to the conduction band where they may behave as free conductive electrons. In contrast to the photovoltaic material, the FiP-effect which may be observed in the semiconducting material comprising the high-resistive boundary, interface and/or junction is, as described above, based on an increase of the recombination rate of the charge carriers in the illuminated areas within the sensor region.

For the sensor region in the optical detector according to the present invention, wherein a high-resistive material is present at a part of a surface of the semiconducting material, wherein the high-resistive material exhibits an electrical resistance above the electrical resistance of the semiconducting material, various embodiments may preferably be used.

In a particularly preferred embodiment, the semiconducting layer may be provided in form of a semiconducting layer, wherein the semiconducting layer may comprise two opposing surface areas. As used herein, the term “layer” refers to an element having an elongated shape and a thickness, wherein an extension of the element in a lateral dimension exceeds the thickness of the element, such as by at least a factor of 10, preferably of 20, more preferably of 50 and most preferably of 100 or more. Herein, the term “surface areas” refers to the two surfaces of the layer which are arranged, preferably in a form of planes, along the elongated shape perpendicular to the dimension of the thickness of the layer. Hereby, the other surfaces of the layer may be disregarded, in particular with respect to their insignificant extensions with respect to the surface areas. This consequence shall particularly be applicable to the part of the surface of the semiconducting material which is addressed as the part of the surface of the semiconducting material which, as described above, is located adjacently to the high-resistive material.

In addition, it may particularly be advantageous for the FiP-effect that the semiconducting layer may exhibit an anisotropic behavior of the electrical conductivity, in particular that a comparatively high value of the electrical conductivity may be observable in a first direction perpendicular to the surface areas of the semiconducting layer whereas a comparatively low value of the electrical conductivity may be observable in a second direction parallel to the surface areas of the semiconducting layer. This kind of arrangement may provide the advantage that the charge carriers may preferably move within the first direction perpendicular to the surface areas of the semiconducting layer while their movement within the second direction parallel to the surface areas of the semiconducting layer may be impeded. Thus, this kind of arrangement may allow, preferably simultaneously, a fast generation of the photocurrent along the first direction, i.e. across the semiconducting layer, and a space-resolved determination of the photocurrent along the second direction, i.e. within the semiconducting layer. As a result, lateral sensing by using the semiconducting layer in this particular embodiment may be improved.

This purpose may particularly be achieved by providing a further embodiment of the present invention, wherein the semiconducting phase within the semiconducting layer may comprise semiconducting microcrystalline needles, wherein at least a part of the needles, preferably most of the needles, most preferred all of the needles, may be oriented within the first direction perpendicular to the surface areas of the semiconducting layer. As used herein, the term “needle” may refer to a body having an elongated shape and a diameter, wherein an extension of the element along the elongation exceeds the diameter of the body, such as by at least a factor of 2, preferably of 5, more preferably of 10 and most preferably of 20 or more. Taking into account that the mobility of the charge carriers which are present within a crystalline phase may typically be higher compared to the mobility of the charge carriers at a boundary surface of the crystalline phase and, possibly, outside the crystalline phase, each of the microcrystalline needles may, thus, constitute a volume which exhibits a high electrical conductivity, thereby, increasing the electrical conductivity within the predominant orientation of the microcrystalline needles. Preferably, the semiconducting microcrystalline needles may be or comprise semiconducting microcrystalline silicon. However, the semiconducting material in the microcrystalline phase may, generally, be selected from one or more of the semiconducting materials as mentioned above and/or below as long as these kinds of semiconducting materials may exhibit a microcrystalline phase.

In a further particularly preferred embodiment, the semiconducting layer may be arranged in a manner within the sensor region of the optical detector that at least one of the two surface areas of the semiconducting layer may be adjacent to a high-resistive layer. As further used herein, the term “high-resistive layer” may relate to a further layer being present within the sensor region of the optical detector which comprises the high-resistive material that exhibits a value of the electrical resistance exceeding the electrical resistance of the semiconducting layer. However, the value of the electrical conductivity of the high-resistive layer shall, preferably, not be too low, such as in the insulating regime, in order to still enable a non-negligible transport of charge carriers from the semiconducting layer via the high-resistive layer to an electrode layer as described below in more detail.

In a further embodiment of the present invention, the semiconducting layer may be arranged in a manner within the sensor region of the optical detector that at least one of the two surface areas of the semiconducting layer is adjacent to a metal layer. As particularly known from a Schottky diode, which is also denominated as a Schottky barrier diode, a high-resistive boundary, in particular a high-resistive depletion zone, may, thus, be located between the semiconducting layer and the adjacent metal layer. Again, the high-resistive boundary being present at the surface area of the semiconducting layer may enable the occurrence of the FiP-effect in the optical detector equipped with this kind of arrangement as described above.

In a further particularly preferred embodiment, the semiconducting layer may be arranged within the sensor region of the optical detector in a manner that the semiconducting material comprises at least one n-type semiconducting layer and at least one p-type semiconducting layer, wherein at least one junction may be located at a boundary between the two semiconducting layers. Herein, the n-type semiconducting layer comprises an n-type semiconducting material, in which, as described above, the charge carriers are predominantly provided by electrons, while the p-type semiconducting layer comprises a p-type semiconducting material, in which the charge carriers are predominantly provided by holes. As further used herein, the term “junction” refers to a boundary or to an interface which may be present between the n-type semiconducting layer and the p-type semiconducting layer as described here. Whereas a diode may usually have a single p-n junction, a transistor may comprise two p-n junctions in a series, such as in form of n-p-n junctions or p-n-p junctions. Further, an undoped intrinsic i-type semiconducting material may be located at the junction between the n-type semiconducting layer and the p-type semiconducting layer. Generally, these electronic components, such as diodes and transistors, have in common with further suitable electronic components that they exhibit a non-linear I-V-characteristic, i.e. a behavior with respect to an increase of a recorded current I flowing through the electronic component which does not exhibit a linear dependency on the voltage V applied at the electronic component.

Alternatively or in addition, the semiconducting layer may comprise an amorphous semiconducting material. As used herein, the semiconducting material” may be denominated by the term “amorphous as long as it may refer to a class of materials which comprises semiconducting particles which may, preferably, be present in a homogenous or a crystalline phase, and which are separated from each other by a high-resistive phase, wherein the high-resistive phase provides an electrical resistance at a part of a surface of the semiconducting particles which is above the electrical resistance of the semiconducting bulk material within the semiconducting particles. This arrangement may, however, not exclude an allocation of a separate high-resistive layer which might still be provided in a manner that it may be adjacent to at least one of the surface areas of the semiconducting layer comprising the amorphous semiconducting material.

Alternatively or in addition, the semiconducting layer may comprise a bulk-hetero junction, i.e. a nanoscale blend of the n-type semiconducting material and the p-type semiconducting material, such as provided by suitable organic semiconductors. Also here this arrangement may not exclude the allocation of a separate high-resistive layer which might still be provided in a manner that it may be adjacent to at least one of the surface areas of the semiconducting layer comprising the bulk-hetero junction.

Thus, the at least one semiconducting layer may comprise a single junction or a plurality of junctions located between the n-type semiconducting material and the p-type semiconducting material, irrespective whether a further undoped intrinsic i-type semiconducting material may be present at the at least one junction or not. Within this regard, the plurality of the junctions may, in a further preferred embodiment, be located in a one-dimensional or two-dimensional fashion within the semiconducting layer. Hereby, the two adjacent junctions may be separated by a semiconducting material or by an insulating layer. Various examples of preferred embodiments of the arrangement of the semiconducting layer and optional additional layers within the sensor region will be described below in more detail.

In a further particularly preferred embodiment the semiconducting phase within the semiconducting layer may comprise wells of pn-junctions which form diodes with a size of preferably smaller than 1 μm×1 μm, less preferable 2 μm×2 μm or 5 μm×5 μm. These diodes are on at least one surface connected to a high-resistive layer. The mentioned embodiment has the advantage of restricting the flow of charge carriers in a manner that charge carriers cannot diffuse laterally, which would diminish the FiP-effect. In a preferable configuration the high resistivity material is also structured in a way, that each single pn-junction has an individual high-resistive electrode, which connects the pn-junction to the common, low-resistivity electrode layer.

In a particular preferred embodiment, the semiconducting layer may be embedded between at least two electrode layers, wherein the electrode layers may be adapted to provide the longitudinal sensor signal. Herein, the electrode layers may be connected to the evaluation device, in particular by signal leads which are configured for this purpose. As a preferred example, the semiconducting layer which, as described above, may comprise two opposing surfaces areas may be arranged in a manner that one surface area may be adjacent to the high-resistive layer while the other surface area may be adjacent to one of the electrode layers. Further in this preferred example, the high-resistive layer which also may comprise two opposing surfaces areas may be arranged in a manner that one surface area may, thus, be adjacent to the semiconducting layer while the other surface area may be adjacent to the other of the electrode layers. However, other arrangements may be feasible.

Further, the electrode layers within this particularly preferred embodiment of the optical detector may be configured for applying a bias voltage across the two electrode layers and, in case the semiconducting layer may be embedded between the electrode layers in this embodiment, also across the semiconducting layer. In this particular embodiment the bias voltage may, thus, be capable for being used to tune the dependency of the longitudinal sensor signal on the beam cross-section of the light beam in the sensor region. Hereby, the longitudinal optical sensor may be switched between a first state in which the longitudinal optical sensor may be dependent on the beam cross-section of the light beam in the sensor region, i.e. showing the above described FiP-effect, and a second state in which the longitudinal optical sensor may be independent on the beam cross-section of the light beam in the sensor region, i.e. showing no FiP-effect but behaving in a manner as a classical optical sensor. Depending on the particular arrangement, further states between the first state and the second state of the longitudinal optical sensor may be obtained, such as demonstrated below in a particular example. This kind of tuning of the FiP-effect may practically be achieved by altering a value for the bias voltage which may be applied across the semiconducting layer, by which alteration a threshold for the occurrence of the FiP-effect may be shifted.

As a result, this particular embodiment may, thus, provide an optical detector in which the intensity of the FiP-effect may be adjusted in an arbitrary manner, such as switched on, switched off, or set to a predefined level. This kind of adjusting the FiP-effect may be used for a number of practical purposes. As a preferred example, a sensitivity of the longitudinal optical sensor may be adjusted to be able to better cope with considerably different illumination conditions, such as with an indoor illumination on one hand and with an outdoor illumination on the other hand. This advantage may particularly be employed in a camera or in a tracking system in which the field of view may move from a first illumination condition, such as an outdoor scene, to a second illumination condition, such as an indoor scene. However, further applications may be feasible.

Furthermore, by varying the bias voltage accordingly, the longitudinal optical sensor which comprises this particular embodiment may be employed for additionally determining its baseline. In contrast to the state of the art in which at least two, in a case where a dark current may not vanish due to an applied bias voltage at least three, longitudinal optical sensors may be required, a single longitudinal optical sensor may be sufficient according to the present invention. Thus, depending on the actually applied value for the bias voltage, the same individual longitudinal optical sensor may be employed as a FiP sensor on one hand and as a classical sensor as described above on the other hand. Consequently, by adjusting the bias voltage to a first value at which the individual longitudinal optical sensor may behave as a classical sensor, a value of the baseline of the respective longitudinal optical sensor may be determined. For further measurements it may then be feasible to adjust the bias voltage to a second value at which the individual longitudinal optical sensor may behave as a FiP sensor and derive a value of the beam cross-section of the incident light beam by measuring the longitudinal sensor signal, thereby taking into account the value of the baseline as previously determined. In contrast to the embodiment as, for example, disclosed in WO 2014/097181 A1, it is possible according to the present embodiment to determine the longitudinal position of the object with a high degree of accuracy and without ambiguity with a single longitudinal optical sensor as described here without having a necessity to use a second or even third longitudinal optical sensor for being able to perform this task.

As used herein, the term “evaluation device” generally refers to an arbitrary device designed to generate the items of information, i.e. the at least one item of information on the position of the object. As an example, the evaluation device may be or may comprise one or more integrated circuits, such as one or more application-specific integrated circuits (ASICs), and/or one or more data processing devices, such as one or more computers, preferably one or more microcomputers and/or microcontrollers. Additional components may be comprised, such as one or more preprocessing devices and/or data acquisition devices, such as one or more devices for receiving and/or preprocessing of the sensor signals, such as one or more AD-converters and/or one or more filters. As used herein, the sensor signal may generally refer to one of the longitudinal sensor signal and, if applicable, to the transversal sensor signal. Further, the evaluation device may comprise one or more data storage devices. Further, as outlined above, the evaluation device may comprise one or more interfaces, such as one or more wireless interfaces and/or one or more wire-bound interfaces.

The at least one evaluation device may be adapted to perform at least one computer program, such as at least one computer program performing or supporting the step of generating the items of information. As an example, one or more algorithms may be implemented which, by using the sensor signals as input variables, may perform a predetermined transformation into the position of the object.

The evaluation device may particularly comprise at least one data processing device, in particular an electronic data processing device, which can be designed to generate the items of information by evaluating the sensor signals. Thus, the evaluation device is designed to use the sensor signals as input variables and to generate the items of information on the transversal position and the longitudinal position of the object by processing these input variables. The processing can be done in parallel, subsequently or even in a combined manner. The evaluation device may use an arbitrary process for generating these items of information, such as by calculation and/or using at least one stored and/or known relationship. Besides the sensor signals, one or a plurality of further parameters and/or items of information can influence said relationship, for example at least one item of information about a modulation frequency. The relationship can be determined or determinable empirically, analytically or else semi-empirically. Particularly preferably, the relationship comprises at least one calibration curve, at least one set of calibration curves, at least one function or a combination of the possibilities mentioned. One or a plurality of calibration curves can be stored for example in the form of a set of values and the associated function values thereof, for example in a data storage device and/or a table. Alternatively or additionally, however, the at least one calibration curve can also be stored for example in parameterized form and/or as a functional equation. Separate relationships for processing the sensor signals into the items of information may be used. Alternatively, at least one combined relationship for processing the sensor signals is feasible. Various possibilities are conceivable and can also be combined.

By way of example, the evaluation device can be designed in terms of programming for the purpose of determining the items of information. The evaluation device can comprise in particular at least one computer, for example at least one microcomputer. Furthermore, the evaluation device can comprise one or a plurality of volatile or nonvolatile data memories. As an alternative or in addition to a data processing device, in particular at least one computer, the evaluation device can comprise one or a plurality of further electronic components which are designed for determining the items of information, for example an electronic table and in particular at least one look-up table and/or at least one application-specific integrated circuit (ASIC).

The detector has, as described above, at least one evaluation device. In particular, the at least one evaluation device can also be designed to completely or partly control or drive the detector, for example by the evaluation device being designed to control at least one illumination source and/or to control at least one modulation device of the detector. The evaluation device can be designed, in particular, to carry out at least one measurement cycle in which one or a plurality of sensor signals, such as a plurality of sensor signals, are picked up, for example a plurality of sensor signals of successively at different modulation frequencies of the illumination.

The evaluation device is designed, as described above, to generate at least one item of information on the position of the object by evaluating the at least one sensor signal. Said position of the object can be static or may even comprise at least one movement of the object, for example a relative movement between the detector or parts thereof and the object or parts thereof. In this case, a relative movement can generally comprise at least one linear movement and/or at least one rotational movement. Items of movement information can for example also be obtained by comparison of at least two items of information picked up at different times, such that for example at least one item of location information can also comprise at least one item of velocity information and/or at least one item of acceleration information, for example at least one item of information about at least one relative velocity between the object or parts thereof and the detector or parts thereof. In particular, the at least one item of location information can generally be selected from: an item of information about a distance between the object or parts thereof and the detector or parts thereof, in particular an optical path length; an item of information about a distance or an optical distance between the object or parts thereof and the optional transfer device or parts thereof; an item of information about a positioning of the object or parts thereof relative to the detector or parts thereof; an item of information about an orientation of the object and/or parts thereof relative to the detector or parts thereof; an item of information about a relative movement between the object or parts thereof and the detector or parts thereof; an item of information about a two-dimensional or three-dimensional spatial configuration of the object or of parts thereof, in particular a geometry or form of the object. Generally, the at least one item of location information can therefore be selected for example from the group consisting of: an item of information about at least one location of the object or at least one part thereof; information about at least one orientation of the object or a part thereof; an item of information about a geometry or form of the object or of a part thereof, an item of information about a velocity of the object or of a part thereof, an item of information about an acceleration of the object or of a part thereof, an item of information about a presence or absence of the object or of a part thereof in a visual range of the detector.

The at least one item of location information can be specified for example in at least one coordinate system, for example a coordinate system in which the detector or parts thereof rest. Alternatively or additionally, the location information can also simply comprise for example a distance between the detector or parts thereof and the object or parts thereof. Combinations of the possibilities mentioned are also conceivable.

Although, as described above, it may be sufficient to employ a single longitudinal optical sensor in order to determine the longitudinal position of the object with a high degree of accuracy and without ambiguity, the detector may still comprise at least two longitudinal optical sensors, wherein each longitudinal optical sensor may be adapted to generate at least one longitudinal sensor signal. As an example, the sensor regions or the sensor surfaces of the longitudinal optical sensors may, thus, be oriented in parallel, wherein slight angular tolerances might be tolerable, such as angular tolerances of no more than 10°, preferably of no more than 5°. Herein, preferably all of the longitudinal optical sensors of the detector, which may, preferably, be arranged in form of a stack along the optical axis of the detector, may be transparent. Thus, the light beam may pass through a first transparent longitudinal optical sensor before impinging on the other longitudinal optical sensors, preferably subsequently. Thus, the light beam from the object may subsequently reach all longitudinal optical sensors present in the optical detector. Herein, the different longitudinal optical sensors may exhibit the same or different spectral sensitivities with respect to the incident light beam.

Preferably, the detector according to the present invention may comprise a single longitudinal optical sensor or, alternatively, a stack of longitudinal optical sensors, particularly preferred in combination with one or more transversal optical sensors as disclosed in WO 2014/097181 A1. As an example, one or more transversal optical sensors may be located on a side of the longitudinal optical sensor facing towards the object. Alternatively or additionally, one or more transversal optical sensors may be located on a side of the longitudinal optical sensor facing away from the object. Again, additionally or alternatively, one or more transversal optical sensors may be interposed in between the longitudinal optical sensors of the stack. However, embodiments which may only comprise a single longitudinal optical sensor but no transversal optical sensor may still be possible, such as in a case wherein only determining the depth of the object may be desired.

As used herein, the term “transversal optical sensor” generally refers to a device which is adapted to determine a transversal position of at least one light beam traveling from the object to the detector. With regard to the term position, reference may be made to the definition above. Thus, preferably, the transversal position may be or may comprise at least one coordinate in at least one dimension perpendicular to an optical axis of the detector. As an example, the transversal position may be a position of a light spot generated by the light beam in a plane perpendicular to the optical axis, such as on a light-sensitive sensor surface of the transversal optical sensor. As an example, the position in the plane may be given in Cartesian coordinates and/or polar coordinates. Other embodiments are feasible. For potential embodiments of the transversal optical sensor, reference may be made to WO 2014/097181 A1. However, other embodiments are feasible and will be outlined in further detail below.

The transversal optical sensor may provide at least one transversal sensor signal. Herein, the transversal sensor signal may generally be an arbitrary signal indicative of the transversal position. As an example, the transversal sensor signal may be or may comprise a digital and/or an analog signal. As an example, the transversal sensor signal may be or may comprise a voltage signal and/or a current signal. Additionally or alternatively, the transversal sensor signal may be or may comprise digital data. The transversal sensor signal may comprise a single signal value and/or a series of signal values. The transversal sensor signal may further comprise an arbitrary signal which may be derived by combining two or more individual signals, such as by averaging two or more signals and/or by forming a quotient of two or more signals.

In a first embodiment similar to the disclosure according to WO 2014/097181 A1, the transversal optical sensor may be a photo detector having at least one first electrode, at least one second electrode and at least one photovoltaic material, wherein the photovoltaic material may be embedded in between the first electrode and the second electrode. Thus, the transversal optical sensor may be or may comprise one or more photo detectors, such as one or more organic photodetectors and, most preferably, one or more dye-sensitized organic solar cells (DSCs, also referred to as dye solar cells), such as one or more solid dye-sensitized organic solar cells (s-DSCs). Thus, the detector may comprise one or more DSCs (such as one or more sDSCs) acting as the at least one transversal optical sensor and one or more DSCs (such as one or more sDSCs) acting as the at least one longitudinal optical sensor.

In contrast to this known embodiment, a preferred embodiment of the transversal optical sensor according to the present invention may comprise a layer of the photoconductive material, preferably an inorganic photoconductive material, such as one of the photoconductive materials as described in PCT patent application No. PCT/EP2016/051817, filed Jan. 28, 2016. Herein, the layer of the photoconductive material may comprise a composition selected from a homogeneous, a crystalline, a polycrystalline, a microcrystalline, a nanocrystalline and/or an amorphous phase. Preferably, the layer of the photoconductive material may be embedded in between two layers of a transparent conducting oxide, preferably comprising indium tin oxide (ITO), fluorine doped tin oxide (FTO), or magnesium oxide (MgO), wherein one of the two layers may be replaced by metal nanowires, in particular by Ag nanowires. However, other material may be feasible, in particular according to the desired transparent spectral range.

Further, at least two electrodes may be present for recording the transversal optical signal. In a preferred embodiment, the at least two electrodes may actually be arranged in the form of at least two physical electrodes, wherein each physical electrode may comprise an electrically conducting material, preferably a metallically conducting material, more preferred a highly metallically conducting material such as copper, silver, gold, an alloy or a composition thereof, or graphene. Herein, each of the at least two physical electrodes may, preferably, be arranged in a manner that a direct electrical contact between the respective electrode and the semiconducting layer in the optical sensor may be achieved, particularly in order to acquire the transversal sensor signal with as little loss as possible.

However, In a particular embodiment, one or more of the mentioned physical electrodes may be replaced at least partially by an electrically conducting beam, in particular a beam of electrically conducting particles, preferably electrons, which may be arranged in a manner that the electrically conducting beam impinges on the sensor region and, thereby, may be capable of generating a direct electrical contact between the respective electrically conducting beam and the semiconducting layer in the optical sensor. By providing this direct electrical contact to the photoconductive layer, the electrically conducting beam may, similarly, act as a means for transporting at least a part of the transversal sensor signal from the optical sensor to the evaluation device.

Preferably, in a particularly preferred embodiment according to the present invention at least one of the electrode layers of the optical sensor may be a split electrode having at least two partial electrodes. Generally, as used herein, the term “partial electrode” may refer to an electrode out of a plurality of electrodes, adapted for measuring at least one current and/or voltage signal, preferably independent from other partial electrodes. Thus, in case a plurality of partial electrodes is provided, the respective electrode is adapted to provide a plurality of electric potentials and/or electric currents and/or voltages via the at least two partial electrodes, which may be measured and/or used independently. According to the present invention, the at least two partial electrodes may be used as the transversal optical sensor, wherein, as described above, the transversal optical sensor may be adapted to determine the transversal position of the light beam traveling from the object to the detector, the transversal position being a position in at least one dimension perpendicular an optical axis of the detector. For this purpose, the transversal optical sensor may be adapted to generate at least one transversal sensor signal, wherein the evaluation device is further designed to generate at least one item of information on a transversal position of the object by evaluating the transversal sensor signal. Accordingly, the at least one transversal sensor signal may, thus indicate an x- and/or a y-position of the incident light beam within the sensor region. Consequently, the transversal sensor signal may thus indicate a position of a light spot generated by the light beam in a plane of the sensor region of the transversal optical sensor.

The transversal optical sensor may further be adapted to generate the transversal sensor signal in accordance with the electrical currents through the partial electrodes. Thus, a ratio of electric currents through two horizontal partial electrodes may be formed, thereby generating an x-coordinate, and/or a ratio of electric currents through to vertical partial electrodes may be formed, thereby generating a y-coordinate. The detector, preferably the transversal optical sensor and/or the evaluation device, may be adapted to derive the information on the transversal position of the object from at least one ratio of the currents through the partial electrodes. Other ways of generating position coordinates by comparing currents through the partial electrodes are feasible.

The partial electrodes may generally be defined in various ways, in order to determine a position of the light beam in the sensor area. Thus, two or more horizontal partial electrodes may be provided in order to determine a horizontal coordinate or x-coordinate, and two or more vertical partial electrodes may be provided in order to determine a vertical coordinate or y-coordinate. Thus, the partial electrodes may be provided at a rim of the sensor area, wherein an interior space of the sensor area remains free and may be covered by one or more additional electrode materials. As will be outlined in further detail below, the at least two partial electrodes may be arranged at different locations on a medium-resistive layer, wherein the medium resistive layer may be adjacent to the high-resistive layer. As used herein, the “medium-resistive layer” may refer to a further layer within the optical sensor which may be defined by an observation that the electrical resistivity of the medium-resistive layer exceeds the electrical resistivity of the partial electrode but falls below the electrical resistivity of the high-resistive layer. In a similar manner as with the high-resistive layer, a suitable semiconducting material may be selected to be employed as the medium-resistive layer in the optical sensor according to the present invention. With regard to this embodiment, it may, thus, particularly be preferred that the at least two partial electrodes of the optical sensor are applied on the same side of the medium-resistive layer.

By using the transversal optical sensor, wherein one of the electrodes is a split electrode with three or more partial electrodes, currents through the partial electrodes may be dependent on a position of the light beam in the sensor area. This may generally be due to the fact that Ohmic losses or resistive losses may occur on the way from a location of generation of electrical charges due to the impinging light onto the partial electrodes. Thus, besides the partial electrodes, the split electrode may comprise one or more additional electrode materials connected to the partial electrodes, wherein the one or more additional electrode materials provide an electrical resistance. Thus, due to the Ohmic losses on the way from the location of generation of the electric charges to the partial electrodes through with the one or more additional electrode materials, the currents through the partial electrodes depend on the location of the generation of the electric charges and, thus, to the position of the light beam in the sensor area. For details of this principle of determining the position of the light beam in the sensor area, reference may be made to the preferred embodiments below and/or to the physical principles and device options as disclosed in WO 2014/097181 A1 and the respective references therein.

Further embodiments of the present invention referred to the nature of the light beam which propagates from the object to the detector. As used herein, the term “light” generally refers to electromagnetic radiation in one or more of the visible spectral range, the ultraviolet spectral range and the infrared spectral range. Therein, the term visible spectral range generally refers to a spectral range of 380 nm to 780 nm. The term infrared (IR) spectral range generally refers to electromagnetic radiation in the range of 780 nm to 1000 μm, wherein the range of 780 nm to 1.4 μm is usually denominated as the near infrared (NIR) spectral range, and the range from 15 μm to 1000 μm as the far infrared (FIR) spectral range. The term ultraviolet spectral range generally refers to electromagnetic radiation in the range of 1 nm to 380 nm, preferably in the range of 100 nm to 380 nm. Preferably, light as used within the present invention is visible light, i.e. light in the visible spectral range.

The term “light beam” generally refers to an amount of light emitted into a specific direction. Thus, the light beam may be a bundle of the light rays having a predetermined extension in a direction perpendicular to a direction of propagation of the light beam. Preferably, the light beam may be or may comprise one or more Gaussian light beams which may be characterized by one or more Gaussian beam parameters, such as one or more of a beam waist, a Rayleigh-length or any other beam parameter or combination of beam parameters suited to characterize a development of a beam diameter and/or a beam propagation in space.

The light beam might be admitted by the object itself, i.e. might originate from the object. Additionally or alternatively, another origin of the light beam is feasible. Thus, as will be outlined in further detail below, one or more illumination sources might be provided which illuminate the object, such as by using one or more primary rays or beams, such as one or more primary rays or beams having a predetermined characteristic. In the latter case, the light beam propagating from the object to the detector might be a light beam which is reflected by the object and/or a reflection device connected to the object.

As outlined above, the at least one longitudinal sensor signal, given the same total power of the illumination by the light beam, is, according to the FiP-effect, dependent on a beam cross-section of the light beam in the sensor region of the at least one longitudinal optical sensor. As used herein, the term beam cross-section generally refers to a lateral extension of the light beam or a light spot generated by the light beam at a specific location. In case a circular light spot is generated, a radius, a diameter or a Gaussian beam waist or twice the Gaussian beam waist may function as a measure of the beam cross-section. In case non-circular light-spots are generated, the cross-section may be determined in any other feasible way, such as by determining the cross-section of a circle having the same area as the non-circular light spot, which is also referred to as the equivalent beam cross-section. Within this regard, it may be possible to employ the observation of an extremum of the longitudinal sensor signal, in particular a global extremum, under a condition in which the corresponding material may be impinged by a light beam with the smallest possible cross-section. In case the extremum is a maximum, this observation may be denominated as the positive FiP-effect, while in case the extremum is a minimum, this observation may be denominated as the negative FiP-effect.

Thus, given the same total power of the illumination of the sensor region by the light beam, a light beam having a first beam diameter or beam cross-section may generate a first longitudinal sensor signal, whereas a light beam having a second beam diameter or beam-cross section being different from the first beam diameter or beam cross-section generates a second longitudinal sensor signal being different from the first longitudinal sensor signal. Thus, by comparing the longitudinal sensor signals, at least one item of information on the beam cross-section, specifically on the beam diameter, may be generated. For details of this effect, reference may be made to WO 2012/110924 A1. Accordingly, the longitudinal sensor signals generated by the longitudinal optical sensors may be compared, in order to gain information on the total power and/or intensity of the light beam and/or in order to normalize the longitudinal sensor signals and/or the at least one item of information on the longitudinal position of the object for the total power and/or total intensity of the light beam. Thus, as an example, a maximum value of the longitudinal optical sensor signals may be detected, and all longitudinal sensor signals may be divided by this maximum value, thereby generating normalized longitudinal optical sensor signals, which, then, may be transformed by using the above-mentioned known relationship, into the at least one item of longitudinal information on the object. Other ways of normalization are feasible, such as a normalization using a mean value of the longitudinal sensor signals and dividing all longitudinal sensor signals by the mean value. Other options are possible. Each of these options may be appropriate to render the transformation independent from the total power and/or intensity of the light beam. In addition, information on the total power and/or intensity of the light beam might, thus, be generated.

Specifically in case one or more beam properties of the light beam propagating from the object to the detector are known, the at least one item of information on the longitudinal position of the object may thus be derived from a known relationship between the at least one longitudinal sensor signal and a longitudinal position of the object. The known relationship may be stored in the evaluation device as an algorithm and/or as one or more calibration curves. As an example, specifically for Gaussian beams, a relationship between a beam diameter or beam waist and a position of the object may easily be derived by using the Gaussian relationship between the beam waist and a longitudinal coordinate. For further details with regard to determining the at least one item of information on the longitudinal position of the object by employing the evaluation device according to the present invention, reference may made to the description in WO 2014/097181 A1. Thus, generally, the evaluation device may be adapted to compare the beam cross-section and/or the diameter of the light beam with known beam properties of the light beam in order to determine the at least one item of information on the longitudinal position of the object, preferably from a known dependency of a beam diameter of the light beam on at least one propagation coordinate in a direction of propagation of the light beam and/or from a known Gaussian profile of the light beam. In addition, at least one transversal coordinate of the object may be determined. Thus, generally, the evaluation device may further be adapted to determine at least one transversal coordinate of the object by determining a position of the light beam on the at least one transversal optical sensor, which may be a pixelated, a segmented or a large-area transversal optical sensor, as further outlined also in WO 2014/097181 A1.

In addition, the detector may comprise at least one transfer device, such as an optical lens, in particular one or more refractive lenses, particularly converging thin refractive lenses, such as convex or biconvex thin lenses, and/or one or more convex mirrors, which may further be arranged along the common optical axis. Most preferably, the light beam which emerges from the object may in this case travel first through the at least one transfer device and thereafter through the single transparent longitudinal optical sensor or the stack of the transparent longitudinal optical sensors until it may finally impinge on an imaging device. As used herein, the term “transfer device” refers to an optical element which may be configured to transfer the at least one light beam emerging from the object to optical sensors within the detector, i.e. the at least two longitudinal optical sensors and the at least one optional transversal optical sensor. Thus, the transfer device can be designed to feed light propagating from the object to the detector to the optical sensors, wherein this feeding can optionally be effected by means of imaging or else by means of non-imaging properties of the transfer device. In particular the transfer device can also be designed to collect the electromagnetic radiation before the latter is fed to the transversal and/or longitudinal optical sensor.

In addition, the at least one transfer device may have imaging properties. Consequently, the transfer device comprises at least one imaging element, for example at least one lens and/or at least one curved mirror, since, in the case of such imaging elements, for example, a geometry of the illumination on the sensor region can be dependent on a relative positioning, for example a distance, between the transfer device and the object. As used herein, the transfer device may be designed in such a way that the electromagnetic radiation which emerges from the object is transferred completely to the sensor region, for example is focused completely onto the sensor region, in particular if the object is arranged in a visual range of the detector.

Generally, the detector may further comprise at least one imaging device, i.e. a device capable of acquiring at least one image. The imaging device can be embodied in various ways. Thus, the imaging device can be for example part of the detector in a detector housing. Alternatively or additionally, however, the imaging device can also be arranged outside the detector housing, for example as a separate imaging device. Alternatively or additionally, the imaging device can also be connected to the detector or even be part of the detector. In a preferred arrangement, the stack of the transparent longitudinal optical sensors and the imaging device are aligned along a common optical axis along which the light beam travels. Thus, it may be possible to locate an imaging device in the optical path of the light beam in a manner that the light beam travels through the stack of the transparent longitudinal optical sensors until it impinges on the imaging device. However, other arrangements are possible.

As used herein, an “imaging device” is generally understood as a device which can generate a one-dimensional, a two-dimensional, or a three-dimensional image of the object or of a part thereof. In particular, the detector, with or without the at least one optional imaging device, can be completely or partly used as a camera, such as an IR camera, or an RGB camera, i.e. a camera which is designed to deliver three basic colors which are designated as red, green, and blue, on three separate connections. Thus, as an example, the at least one imaging device may be or may comprise at least one imaging device selected from the group consisting of: a pixelated organic camera element, preferably a pixelated organic camera chip; a pixelated inorganic camera element, preferably a pixelated inorganic camera chip, more preferably a CCD- or CMOS-chip; a monochrome camera element, preferably a monochrome camera chip; a multicolor camera element, preferably a multicolor camera chip; a full-color camera element, preferably a full-color camera chip. The imaging device may be or may comprise at least one device selected from the group consisting of a monochrome imaging device, a multi-chrome imaging device and at least one full color imaging device. A multi-chrome imaging device and/or a full color imaging device may be generated by using filter techniques and/or by using intrinsic color sensitivity or other techniques, as the skilled person will recognize. Other embodiments of the imaging device are also possible.

The imaging device may be designed to image a plurality of partial regions of the object successively and/or simultaneously. By way of example, a partial region of the object can be a one-dimensional, a two-dimensional, or a three-dimensional region of the object which is delimited for example by a resolution limit of the imaging device and from which electromagnetic radiation emerges. In this context, imaging should be understood to mean that the electromagnetic radiation which emerges from the respective partial region of the object is fed into the imaging device, for example by means of the at least one optional transfer device of the detector. The electromagnetic rays can be generated by the object itself, for example in the form of a luminescent radiation. Alternatively or additionally, the at least one detector may comprise at least one illumination source for illuminating the object.

In particular, the imaging device can be designed to image sequentially, for example by means of a scanning method, in particular using at least one row scan and/or line scan, the plurality of partial regions sequentially. However, other embodiments are also possible, for example embodiments in which a plurality of partial regions is simultaneously imaged. The imaging device is designed to generate, during this imaging of the partial regions of the object, signals, preferably electronic signals, associated with the partial regions. The signal may be an analogue and/or a digital signal. By way of example, an electronic signal can be associated with each partial region. The electronic signals can accordingly be generated simultaneously or else in a temporally staggered manner. By way of example, during a row scan or line scan, it is possible to generate a sequence of electronic signals which correspond to the partial regions of the object, which are strung together in a line, for example. Further, the imaging device may comprise one or more signal processing devices, such as one or more filters and/or analogue-digital-converters for processing and/or preprocessing the electronic signals.

Light emerging from the object can originate in the object itself, but can also optionally have a different origin and propagate from this origin to the object and subsequently toward the optical sensors. The latter case can be affected for example by at least one illumination source being used. The illumination source can be embodied in various ways. Thus, the illumination source can be for example part of the detector in a detector housing. Alternatively or additionally, however, the at least one illumination source can also be arranged outside a detector housing, for example as a separate light source. The illumination source can be arranged separately from the object and illuminate the object from a distance. Alternatively or additionally, the illumination source can also be connected to the object or even be part of the object, such that, by way of example, the electromagnetic radiation emerging from the object can also be generated directly by the illumination source. By way of example, at least one illumination source can be arranged on and/or in the object and directly generate the electromagnetic radiation by means of which the sensor region is illuminated. This illumination source can for example be or comprise an ambient light source and/or may be or may comprise an artificial illumination source. By way of example, at least one infrared emitter and/or at least one emitter for visible light and/or at least one emitter for ultraviolet light can be arranged on the object. By way of example, at least one light emitting diode and/or at least one laser diode can be arranged on and/or in the object. The illumination source can comprise in particular one or a plurality of the following illumination sources: a laser, in particular a laser diode, although in principle, alternatively or additionally, other types of lasers can also be used; a light emitting diode; an incandescent lamp; a neon light; a flame source; a heat source; an organic light source, in particular an organic light emitting diode; a structured light source. Alternatively or additionally, other illumination sources can also be used. It is particularly preferred if the illumination source is designed to generate one or more light beams having a Gaussian beam profile, as is at least approximately the case for example in many lasers. For further potential embodiments of the optional illumination source, reference may be made to one of WO 2012/110924 A1 and WO 2014/097181 A1. Still, other embodiments are feasible.

The at least one optional illumination source generally may emit light in at least one of: the ultraviolet spectral range, preferably in the range of 200 nm to 380 nm; the visible spectral range (380 nm to 780 nm); the infrared spectral range, preferably in the range of 780 nm to 3.0 micrometers. Most preferably, the at least one illumination source is adapted to emit light in the visible spectral range, preferably in the range of 500 nm to 780 nm, most preferably at 650 nm to 750 nm or at 690 nm to 700 nm. Herein, it is particularly preferred when the illumination source may exhibit a spectral range which may be related to the spectral sensitivities of the longitudinal sensors, particularly in a manner to ensure that the longitudinal sensor which may be illuminated by the respective illumination source may provide a sensor signal with a high intensity which may, thus, enable a high-resolution evaluation with a sufficient signal-to-noise-ratio.

Furthermore, the detector can have at least one modulation device for modulating the illumination, in particular for a periodic modulation, in particular a periodic beam interrupting device. A modulation of the illumination should be understood to mean a process in which a total power of the illumination is varied, preferably periodically, in particular with one or a plurality of modulation frequencies. In particular, a periodic modulation can be effected between a maximum value and a minimum value of the total power of the illumination. The minimum value can be 0, but can also be >0, such that, by way of example, complete modulation does not have to be effected. The modulation can be effected for example in a beam path between the object and the optical sensor, for example by the at least one modulation device being arranged in said beam path. Alternatively or additionally, however, the modulation can also be effected in a beam path between an optional illumination source—described in even greater detail below—for illuminating the object and the object, for example by the at least one modulation device being arranged in said beam path. A combination of these possibilities is also conceivable. The at least one modulation device can comprise for example a beam chopper or some other type of periodic beam interrupting device, for example comprising at least one interrupter blade or interrupter wheel, which preferably rotates at constant speed and which can thus periodically interrupt the illumination. Alternatively or additionally, however, it is also possible to use one or a plurality of different types of modulation devices, for example modulation devices based on an electro-optical effect and/or an acousto-optical effect. Once again alternatively or additionally, the at least one optional illumination source itself can also be designed to generate a modulated illumination, for example by said illumination source itself having a modulated intensity and/or total power, for example a periodically modulated total power, and/or by said illumination source being embodied as a pulsed illumination source, for example as a pulsed laser. Thus, by way of example, the at least one modulation device can also be wholly or partly integrated into the illumination source. Various possibilities are conceivable.

Accordingly, the detector can be designed in particular to detect at least two longitudinal sensor signals in the case of different modulations, in particular at least two longitudinal sensor signals at respectively different modulation frequencies. The evaluation device can be designed to generate the geometrical information from the at least two longitudinal sensor signals. As described in WO 2012/110924 A1 and WO 2014/097181 A1, it may, thus, be possible to resolve ambiguities and/or it is possible to take account of the fact that, for example, a total power of the illumination is generally unknown. By way of example, the detector can be designed to bring about a modulation of the illumination of the object and/or at least one sensor region of the detector, such as at least one sensor region of the at least one longitudinal optical sensor, with a frequency of 0.05 Hz to 1 MHz, such as 0.1 Hz to 10 kHz. As outlined above, for this purpose, the detector may comprise at least one modulation device, which may be integrated into the at least one optional illumination source and/or may be independent from the illumination source. Thus, at least one illumination source might, by itself, be adapted to generate the above-mentioned modulation of the illumination, and/or at least one independent modulation device may be present, such as at least one chopper and/or at least one device having a modulated transmissibility, such as at least one electro-optical device and/or at least one acousto-optical device.

However, according to the present invention, it may be advantageous to directly determine the longitudinal sensor signal without applying one or more modulation frequencies to the optical detector. As will be demonstrated below, an application of a modulation frequency may not be required under many relevant circumstances in order to acquire the desired longitudinal information about the object. As described above, it may also be possible to resolve ambiguities and/or to take into account the total power of the illumination by determining the baseline of a single individual optical sensor by varying the bias voltage as applied across the optical sensor. As a result, the optical detector may, thus, not be required to comprise a modulation device which may further contribute to the simple and cost-effective setup of the spatial detector.

In a preferred embodiment, the longitudinal optical sensor, given the same total power of the illumination, is dependent on the beam cross-section of the light beam in the sensor region, wherein the longitudinal sensor signal is, thus, substantially frequency-independent in a range of a modulation frequency of the light beam of 0 Hz to 500 Hz. Thereby, the term “substantially” describes an observation that an amplitude of the longitudinal sensor varies less than 10%, preferably less than 1% when the modulation frequency of the light beam is varied within the indicated frequency range. As described above, this description refers to the observation that the FiP-effect may also occur at low frequencies, in particular at 0 Hz, which indicates that no modulation frequency is present, apart from unavoidable naturally or technically occurring modulation frequencies in the vicinity surrounding the optical detector. Consequently, recording the at least one longitudinal sensor signal in the indicated frequency range allows determining the beam cross-section of the light beam in the sensor region and, thus, as described above, generating at least one item of information on a longitudinal position of the object.

In a further aspect of the present invention, an arrangement comprising at least two detectors according to any of the preceding embodiments is proposed. Herein, the at least two detectors preferably may have identical optical properties but might also be different with respect from each other. In addition, the arrangement may further comprise at least one illumination source. Herein, the at least one object might be illuminated by using at least one illumination source which generates primary light, wherein the at least one object elastically or inelastically reflects the primary light, thereby generating a plurality of light beams which propagate to one of the at least two detectors. The at least one illumination source may form or may not form a constituent part of each of the at least two detectors. By way of example, the at least one illumination source itself may be or may comprise an ambient light source and/or may be or may comprise an artificial illumination source. This embodiment is preferably suited for an application in which at least two detectors, preferentially two identical detectors, are employed for acquiring depth information, in particular, for the purpose to providing a measurement volume which extends the inherent measurement volume of a single detector.

In a further aspect of the present invention, a human-machine interface for exchanging at least one item of information between a user and a machine is proposed. The human-machine interface as proposed may make use of the fact that the above-mentioned detector in one or more of the embodiments mentioned above or as mentioned in further detail below may be used by one or more users for providing information and/or commands to a machine. Thus, preferably, the human-machine interface may be used for inputting control commands.

The human-machine interface comprises at least one detector according to the present invention, such as according to one or more of the embodiments disclosed above and/or according to one or more of the embodiments as disclosed in further detail below, wherein the human-machine interface is designed to generate at least one item of geometrical information of the user by means of the detector wherein the human-machine interface is designed to assign the geometrical information to at least one item of information, in particular to at least one control command.

In a further aspect of the present invention, an entertainment device for carrying out at least one entertainment function is disclosed. As used herein, an entertainment device is a device which may serve the purpose of leisure and/or entertainment of one or more users, in the following also referred to as one or more players. As an example, the entertainment device may serve the purpose of gaming, preferably computer gaming. Additionally or alternatively, the entertainment device may also be used for other purposes, such as for exercising, sports, physical therapy or motion tracking in general. Thus, the entertainment device may be implemented into a computer, a computer network or a computer system or may comprise a computer, a computer network or a computer system which runs one or more gaming software programs.

The entertainment device comprises at least one human-machine interface according to the present invention, such as according to one or more of the embodiments disclosed above and/or according to one or more of the embodiments disclosed below. The entertainment device is designed to enable at least one item of information to be input by a player by means of the human-machine interface. The at least one item of information may be transmitted to and/or may be used by a controller and/or a computer of the entertainment device.

In a further aspect of the present invention, a tracking system for tracking the position of at least one movable object is provided. As used herein, a tracking system is a device which is adapted to gather information on a series of past positions of the at least one object or at least one part of an object. Additionally, the tracking system may be adapted to provide information on at least one predicted future position of the at least one object or the at least one part of the object. The tracking system may have at least one track controller, which may fully or partially be embodied as an electronic device, preferably as at least one data processing device, more preferably as at least one computer or microcontroller. Again, the at least one track controller may comprise the at least one evaluation device and/or may be part of the at least one evaluation device and/or might fully or partially be identical to the at least one evaluation device.

The tracking system comprises at least one detector according to the present invention, such as at least one detector as disclosed in one or more of the embodiments listed above and/or as disclosed in one or more of the embodiments below. The tracking system further comprises at least one track controller. The tracking system may comprise one, two or more detectors, particularly two or more identical detectors, which allow for a reliable acquisition of depth information about the at least one object in an overlapping volume between the two or more detectors. The track controller is adapted to track a series of positions of the object, each position comprising at least one item of information on a position of the object at a specific point in time.

The tracking system may further comprise at least one beacon device connectable to the object. For a potential definition of the beacon device, reference may be made to WO 2014/097181 A1. The tracking system preferably is adapted such that the detector may generate an information on the position of the object of the at least one beacon device, in particular to generate the information on the position of the object which comprises a specific beacon device exhibiting a specific spectral sensitivity. Thus, more than one beacon exhibiting a different spectral sensitivity may be tracked by the detector of the present invention, preferably in a simultaneous manner. Herein, the beacon device may fully or partially be embodied as an active beacon device and/or as a passive beacon device. As an example, the beacon device may comprise at least one illumination source adapted to generate at least one light beam to be transmitted to the detector. Additionally or alternatively, the beacon device may comprise at least one reflector adapted to reflect light generated by an illumination source, thereby generating a reflected light beam to be transmitted to the detector.

In a further aspect of the present invention, a scanning system for determining at least one position of at least one object is provided. As used herein, the scanning system is a device which is adapted to emit at least one light beam being configured for an illumination of at least one dot located at at least one surface of the at least one object and for generating at least one item of information about the distance between the at least one dot and the scanning system. For the purpose of generating the at least one item of information about the distance between the at least one dot and the scanning system, the scanning system comprises at least one of the detectors according to the present invention, such as at least one of the detectors as disclosed in one or more of the embodiments listed above and/or as disclosed in one or more of the embodiments below.

Thus, the scanning system comprises at least one illumination source which is adapted to emit the at least one light beam being configured for the illumination of the at least one dot located at the at least one surface of the at least one object. As used herein, the term “dot” refers to a small area on a part of the surface of the object which may be selected, for example by a user of the scanning system, to be illuminated by the illumination source. Preferably, the dot may exhibit a size which may, on one hand, be as small as possible in order to allow the scanning system determining a value for the distance between the illumination source comprised by the scanning system and the part of the surface of the object on which the dot may be located as exactly as possible and which, on the other hand, may be as large as possible in order to allow the user of the scanning system or the scanning system itself, in particular by an automatic procedure, to detect a presence of the dot on the related part of the surface of the object.

For this purpose, the illumination source may comprise an artificial illumination source, in particular at least one laser source and/or at least one incandescent lamp and/or at least one semiconductor light source, for example, at least one light-emitting diode, in particular an organic and/or inorganic light-emitting diode. On account of their generally defined beam profiles and other properties of handleability, the use of at least one laser source as the illumination source is particularly preferred. Herein, the use of a single laser source may be preferred, in particular in a case in which it may be important to provide a compact scanning system that might be easily storable and transportable by the user. The illumination source may thus, preferably be a constituent part of the detector and may, therefore, in particular be integrated into the detector, such as into the housing of the detector. In a preferred embodiment, particularly the housing of the scanning system may comprise at least one display configured for providing distance-related information to the user, such as in an easy-to-read manner. In a further preferred embodiment, particularly the housing of the scanning system may, in addition, comprise at least one button which may be configured for operating at least one function related to the scanning system, such as for setting one or more operation modes. In a further preferred embodiment, particularly the housing of the scanning system may, in addition, comprise at least one fastening unit which may be configured for fastening the scanning system to a further surface, such as a rubber foot, a base plate or a wall holder, such comprising as magnetic material, in particular for increasing the accuracy of the distance measurement and/or the handleablity of the scanning system by the user.

In a particularly preferred embodiment, the illumination source of the scanning system may, thus, emit a single laser beam which may be configured for the illumination of a single dot located at the surface of the object. By using at least one of the detectors according to the present invention at least one item of information about the distance between the at least one dot and the scanning system may, thus, be generated. Hereby, preferably, the distance between the illumination system as comprised by the scanning system and the single dot as generated by the illumination source may be determined, such as by employing the evaluation device as comprised by the at least one detector. However, the scanning system may, further, comprise an additional evaluation system which may, particularly, be adapted for this purpose. Alternatively or in addition, a size of the scanning system, in particular of the housing of the scanning system, may be taken into account and, thus, the distance between a specific point on the housing of the scanning system, such as a front edge or a back edge of the housing, and the single dot may, alternatively, be determined.

Alternatively, the illumination source of the scanning system may emit two individual laser beams which may be configured for providing a respective angle, such as a right angle, between the directions of an emission of the beams, whereby two respective dots located at the surface of the same object or at two different surfaces at two separate objects may be illuminated. However, other values for the respective angle between the two individual laser beams may also be feasible. This feature may, in particular, be employed for indirect measuring functions, such as for deriving an indirect distance which may not be directly accessible, such as due to a presence of one or more obstacles between the scanning system and the dot or which may otherwise be hard to reach. By way of example, it may, thus, be feasible to determine a value for a height of an object by measuring two individual distances and deriving the height by using the Pythagoras formula. In particular for being able to keep a predefined level with respect to the object, the scanning system may, further, comprise at least one leveling unit, in particular an integrated bubble vial, which may be used for keeping the predefined level by the user.

As a further alternative, the illumination source of the scanning system may emit a plurality of individual laser beams, such as an array of laser beams which may exhibit a respective pitch, in particular a regular pitch, with respect to each other and which may be arranged in a manner in order to generate an array of dots located on the at least one surface of the at least one object. For this purpose, specially adapted optical elements, such as beam-splitting devices and mirrors, may be provided which may allow a generation of the described array of the laser beams. In particular, the illumination source may be directed to scan an area or a volume by using one or more movable mirrors to redirect the light beam in a periodic or non-periodic fashion. The illumination source may further be redirected using an array of micro-mirrors in order to provide in this manner a structured light source. The structured light source may be used to project optical features, such as points or fringes.

Thus, the scanning system may provide a static arrangement of the one or more dots placed on the one or more surfaces of the one or more objects. Alternatively, the illumination source of the scanning system, in particular the one or more laser beams, such as the above described array of the laser beams, may be configured for providing one or more light beams which may exhibit a varying intensity over time and/or which may be subject to an alternating direction of emission in a passage of time, in particular by moving one or more mirrors, such as the micro-mirrors comprised within the mentioned array of micro-mirrors. As a result, the illumination source may be configured for scanning a part of the at least one surface of the at least one object as an image by using one or more light beams with alternating features as generated by the at least one illumination source of the scanning device. In particular, the scanning system may, thus, use at least one row scan and/or line scan, such as to scan the one or more surfaces of the one or more objects sequentially or simultaneously. As non-limiting examples, the scanning system may be used in safety laser scanners, e.g. in production environments, and/or in 3D-scanning devices as used for determining the shape of an object, such as in connection to 3D-printing, body scanning, quality control, in construction applications, e.g. as range meters, in logistics applications, e.g. for determining the size or volume of a parcel, in household applications, e.g. in robotic vacuum cleaners or lawn mowers, or in other kinds of applications which may include a scanning step.

In a further aspect of the present invention, a camera for imaging at least one object is disclosed. The camera comprises at least one detector according to the present invention, such as disclosed in one or more of the embodiments given above or given in further detail below. Thus, the detector may be part of a photographic device, specifically of a digital camera. Specifically, the detector may be used for 3D photography, specifically for digital 3D photography. Thus, the detector may form a digital 3D camera or may be part of a digital 3D camera. As used herein, the term “photography” generally refers to the technology of acquiring image information of at least one object. As further used herein, a “camera” generally is a device adapted for performing photography. As further used herein, the term “digital photography” generally refers to the technology of acquiring image information of at least one object by using a plurality of light-sensitive elements adapted to generate electrical signals indicating an intensity of illumination, preferably digital electrical signals. As further used herein, the term “3D photography” generally refers to the technology of acquiring image information of at least one object in three spatial dimensions. Accordingly, a 3D camera is a device adapted for performing 3D photography. The camera generally may be adapted for acquiring a single image, such as a single 3D image, or may be adapted for acquiring a plurality of images, such as a sequence of images. Thus, the camera may also be a video camera adapted for video applications, such as for acquiring digital video sequences.

Thus, generally, the present invention further refers to a camera, specifically a digital camera, more specifically a 3D camera or digital 3D camera, for imaging at least one object. As outlined above, the term imaging, as used herein, generally refers to acquiring image information of at least one object. The camera comprises at least one detector according to the present invention. The camera, as outlined above, may be adapted for acquiring a single image or for acquiring a plurality of images, such as image sequence, preferably for acquiring digital video sequences. Thus, as an example, the camera may be or may comprise a video camera. In the latter case, the camera preferably comprises a data memory for storing the image sequence.

In a further aspect of the present invention, a method for determining a position of at least one object is disclosed. The method preferably may make use of at least one detector according to the present invention, such as of at least one detector according to one or more of the embodiments disclosed above or disclosed in further detail below. Thus, for optional embodiments of the method, reference might be made to the description of the various embodiments of the detector.

The method comprises the following steps, which may be performed in the given order or in a different order. Further, additional method steps might be provided which are not listed. Further, two or more or even all of the method steps might be performed simultaneously, at least partially. Further, two or more or even all of the method steps might be performed twice or even more than twice, repeatedly.

The method according to the present invention comprises the following steps:
generating at least one longitudinal sensor signal by using at least one longitudinal optical sensor, wherein the longitudinal sensor signal is dependent on an illumination of a sensor region of the longitudinal optical sensor by a light beam, wherein the longitudinal sensor signal, given the same total power of the illumination, is dependent on a beam cross-section of the light beam in the sensor region, wherein the longitudinal sensor signal is generated by at least one semiconducting material comprised in the sensor region, wherein a high-resistive material is present at a part of a surface of the semiconducting material, wherein the high-resistive material exhibits an electrical resistance which equals or exceeds the electrical resistance of the semiconducting material; and
generating at least one item of information on a longitudinal position of the object by evaluating the longitudinal sensor signal of the longitudinal optical sensor.

For further details concerning the method according to the present invention, reference may be made to the description of the optical detector as provided above and/or below.

In a further aspect of the present invention, a use of a detector according to the present invention is disclosed. Therein, a use of the detector for a purpose of determining a position, in particular a depth, of an object is proposed, in particular, for a purpose of use selected from the group consisting of: a distance measurement, in particular in traffic technology; a position measurement, in particular in traffic technology; an entertainment application; a security application; a human-machine interface application; a tracking application; a photography application; an imaging application or camera application; a mapping application for generating maps of at least one space; a homing or tracking beacon detector for vehicles; a distance and/or position measurement of objects with a thermal signature (hotter or colder than background); a machine vision application; a robotic application.

Further uses of the optical detector according to the present invention may also refer to combinations with applications for which optical devices have already been applied successfully, such as determining the presence or absence of an object; extending optical applications, e.g. camera exposure control, auto slide focus, automated rear view mirrors, electronic scales, automatic gain control, particularly in modulated light sources, automatic headlight dimmers, night (street) light controls, oil burner flame outs, or smoke detectors; or other applications, such as in densitometers, e.g. determining the density of toner in photocopy machines; or in colorimetric measurements.

Thus, generally, the devices according to the present invention, such as the detector, may be applied in various fields of uses. Specifically, the detector may be applied for a purpose of use, selected from the group consisting of: a position measurement in traffic technology; an entertainment application; a security application; a human-machine interface application; a tracking application; a photography application; a mapping application for generating maps of at least one space, such as at least one space selected from the group of a room, a building and a street; a mobile application; a webcam; an audio device; a dolby surround audio system; a computer peripheral device; a gaming application; a camera or video application; a security application; a surveillance application; an automotive application; a transport application; a medical application; a sports' application; a machine vision application; a vehicle application; an airplane application; a ship application; a spacecraft application; a building application; a construction application; a cartography application; a manufacturing application; a use in combination with at least one state-of-the-art sensing technology, such as a time-of-flight detector, radar, lidar, sonar, photogrammetry, stereo camera, ultrasonic sensors, or interferometry. Additionally or alternatively, applications in local and/or global positioning systems may be named, especially landmark-based positioning and/or navigation, specifically for use in cars or other vehicles (such as trains, motorcycles, bicycles, trucks for cargo transportation), robots or for use by pedestrians. Further, indoor positioning systems may be named as potential applications, such as for household applications and/or for robots used in manufacturing, logistics, surveillance, or maintenance technology.

Thus, firstly, the devices according to the present invention may be used in mobile phones, tablet computers, laptops, smart panels or other stationary or mobile or wearable computer or communication applications. Thus, the devices according to the present invention may be combined with at least one active light source, such as a light source emitting light in the visible range or infrared spectral range, in order to enhance performance. Thus, as an example, the devices according to the present invention may be used as cameras and/or sensors, such as in combination with mobile software for scanning and/or detecting environment, objects and living beings. The devices according to the present invention may even be combined with 2D cameras, such as conventional cameras, in order to increase imaging effects. The devices according to the present invention may further be used for surveillance and/or for recording purposes or as input devices to control mobile devices, especially in combination with voice and/or gesture recognition. Thus, specifically, the devices according to the present invention acting as human-machine interfaces, also referred to as input devices, may be used in mobile applications, such as for controlling other electronic devices or components via the mobile device, such as the mobile phone. As an example, the mobile application including at least one device according to the present invention may be used for controlling a television set, a game console, a music player or music device or other entertainment devices.

Further, the devices according to the present invention may be used in webcams or other peripheral devices for computing applications. Thus, as an example, the devices according to the present invention may be used in combination with software for imaging, recording, surveillance, scanning, or motion detection. As outlined in the context of the human-machine interface and/or the entertainment device, the devices according to the present invention are particularly useful for giving commands by facial expressions and/or body expressions. The devices according to the present invention can be combined with other input generating devices like e.g. mouse, keyboard, touchpad, microphone etc. Further, the devices according to the present invention may be used in applications for gaming, such as by using a webcam. Further, the devices according to the present invention may be used in virtual training applications and/or video conferences. Further, devices according to the present invention may be used to recognize or track hands, arms, or objects used in a virtual or augmented reality application, especially when wearing head mounted displays.

Further, the devices according to the present invention may be used in mobile audio devices, television devices and gaming devices, as partially explained above. Specifically, the devices according to the present invention may be used as controls or control devices for electronic devices, entertainment devices or the like. Further, the devices according to the present invention may be used for eye detection or eye tracking, such as in 2D- and 3D-display techniques, especially with transparent displays for augmented reality applications and/or for recognizing whether a display is being looked at and/or from which perspective a display is being looked at. Further, devices according to the present invention may be used to explore a room, boundaries, obstacles, in connection with a virtual or augmented reality application, especially when wearing a head-mounted display.

Further, the devices according to the present invention may be used in or as digital cameras such as DSC cameras and/or in or as reflex cameras such as SLR cameras. For these applications, reference may be made to the use of the devices according to the present invention in mobile applications such as mobile phones, as disclosed above.

Further, the devices according to the present invention may be used for security or surveillance applications. Thus, as an example, at least one device according to the present invention can be combined with one or more digital and/or analogue electronics that will give a signal if an object is within or outside a predetermined area (e.g. for surveillance applications in banks or museums). Specifically, the devices according to the present invention may be used for optical encryption. Detection by using at least one device according to the present invention can be combined with other detection devices to complement wavelengths, such as with IR, x-ray, UV-VIS, radar or ultrasound detectors. The devices according to the present invention may further be combined with an active infrared light source to allow detection in low light surroundings. The devices according to the present invention are generally advantageous as compared to active detector systems, specifically since the devices according to the present invention avoid actively sending signals which may be detected by third parties, as is the case e.g. in radar applications, ultrasound applications, LIDAR or similar active detector devices. Thus, generally, the devices according to the present invention may be used for an unrecognized and undetectable tracking of moving objects. Additionally, the devices according to the present invention generally are less prone to manipulations and irritations as compared to conventional devices.

Further, given the ease and accuracy of 3D detection by using the devices according to the present invention, the devices according to the present invention generally may be used for facial, body and person recognition and identification. Therein, the devices according to the present invention may be combined with other detection means for identification or personalization purposes such as passwords, finger prints, iris detection, voice recognition or other means. Thus, generally, the devices according to the present invention may be used in security devices and other personalized applications.

Further, the devices according to the present invention may be used as 3D barcode readers for product identification.

In addition to the security and surveillance applications mentioned above, the devices according to the present invention generally can be used for surveillance and monitoring of spaces and areas. Thus, the devices according to the present invention may be used for surveying and monitoring spaces and areas and, as an example, for triggering or executing alarms in case prohibited areas are violated. Thus, generally, the devices according to the present invention may be used for surveillance purposes in building surveillance or museums, optionally in combination with other types of sensors, such as in combination with motion or heat sensors, in combination with image intensifiers or image enhancement devices and/or photomultipliers. Further, the devices according to the present invention may be used in public spaces or crowded spaces to detect potentially hazardous activities such as commitment of crimes such as theft in a parking lot or unattended objects such as unattended baggage in an airport.

Further, the devices according to the present invention may advantageously be applied in camera applications such as video and camcorder applications. Thus, the devices according to the present invention may be used for motion capture and 3D-movie recording. Therein, the devices according to the present invention generally provide a large number of advantages over conventional optical devices. Thus, the devices according to the present invention generally require a lower complexity with regard to optical components. Thus, as an example, the number of lenses may be reduced as compared to conventional optical devices, such as by providing the devices according to the present invention having one lens only. Due to the reduced complexity, very compact devices are possible, such as for mobile use. Conventional optical systems having two or more lenses with high quality generally are voluminous, such as due to the general need for voluminous beam-splitters. Further, the devices according to the present invention generally may be used for focus/autofocus devices, such as autofocus cameras. Further, the devices according to the present invention may also be used in optical microscopy, especially in confocal microscopy.

Further, the devices according to the present invention generally are applicable in the technical field of automotive technology and transport technology. Thus, as an example, the devices according to the present invention may be used as distance and surveillance sensors, such as for adaptive cruise control, emergency brake assist, lane departure warning, surround view, blind spot detection, traffic sign detection, traffic sign recognition, lane recognition, rear cross traffic alert, light source recognition for adapting the head light intensity and range depending on approaching traffic or vehicles driving ahead, adaptive front-lighting systems, automatic control of high beam head lights, adaptive cut-off lights in front light systems, glare-free high beam front lighting systems, marking animals, obstacles, or the like by headlight illumination, rear cross traffic alert, and other driver assistance systems, such as advanced driver assistance systems, or other automotive and traffic applications. Further, devices according to the present invention may be used in driver assistance systems which may, particularly, be adapted for anticipating maneuvers of the driver beforehand for collision avoidance. Further, the devices according to the present invention can also be used for velocity and/or acceleration measurements, such as by analyzing a first and second time-derivative of position information gained by using the detector according to the present invention. This feature generally may be applicable in automotive technology, transportation technology or general traffic technology. Applications in other fields of technology are feasible. A specific application in an indoor positioning system may be the detection of positioning of passengers in transportation, more specifically to electronically control the use of safety systems such as airbags. Herein, the use of an airbag may, especially, be prevented in a case in which the passenger may be located within the vehicle in a manner that a use of the airbag might cause an injury, in particular a severe injury, with the passenger. Further, in vehicles such as cars, trains, planes or the like, especially in autonomous vehicles, devices according to the present invention may be used to determine whether a driver pays attention to the traffic or is distracted, or asleep, or tired, or incapable of driving, such as due to the consumption of alcohol or other drugs.

In these or other applications, generally, the devices according to the present invention may be used as standalone devices or in combination with other sensor devices, such as in combination with radar and/or ultrasonic devices. Specifically, the devices according to the present invention may be used for autonomous driving and safety issues. Further, in these applications, the devices according to the present invention may be used in combination with infrared sensors, radar sensors, which are sonic sensors, two-dimensional cameras or other types of sensors. In these applications, the generally passive nature of the devices according to the present invention is advantageous. Thus, since the devices according to the present invention generally do not require emitting signals, the risk of interference of active sensor signals with other signal sources may be avoided. The devices according to the present invention specifically may be used in combination with recognition software, such as standard image recognition software. Thus, signals and data as provided by the devices according to the present invention typically are readily processable and, therefore, generally require lower calculation power than established stereovision systems such as LI DAR. Given the low space demand, the devices according to the present invention such as cameras may be placed at virtually any place in a vehicle, such as on or behind a window screen, on a front hood, on bumpers, on lights, on mirrors or other places and the like. Various detectors according to the present invention such as one or more detectors based on the effect disclosed within the present invention can be combined, such as in order to allow autonomously driving vehicles or in order to increase the performance of active safety concepts. Thus, various devices according to the present invention may be combined with one or more other devices according to the present invention and/or conventional sensors, such as in the windows like rear window, side window or front window, on the bumpers or on the lights.

A combination of at least one device according to the present invention such as at least one detector according to the present invention with one or more rain detection sensors is also possible. This is due to the fact that the devices according to the present invention generally are advantageous over conventional sensor techniques such as radar, specifically during heavy rain. A combination of at least one device according to the present invention with at least one conventional sensing technique such as radar may allow for a software to pick the right combination of signals according to the weather conditions.

Further, the devices according to the present invention may generally be used as break assist and/or parking assist and/or for speed measurements. Speed measurements can be integrated in the vehicle or may be used outside the vehicle, such as in order to measure the speed of other cars in traffic control. Further, the devices according to the present invention may be used for detecting free parking spaces in parking lots.

Further, the devices according to the present invention may generally be used for vision, in particular for vision under difficult visibility conditions, such as in night vision, fog vision, or fume vision. For achieving this purpose, the optical detector may comprise a specifically selected material which may be sensitive at least within a wavelength range in which small particles, such as particles being present in smoke or fume, or small droplets, such as droplets being present in fog, mist or haze, may not reflect an incident light beam or only a small partition thereof. As generally know, the reflection of the incident light beam may be small or negligent in a case in which the wavelength of the incident beam exceeds the size of the particles or of the droplets, respectively. Further, might vision may be enabled by detecting thermal radiation being emitted by a bodies and objects. Thus, the optical detector which comprises the specifically selected material which may particularly be sensitive within the infrared (IR) spectral range, preferably within the near infrared (NIR) spectral range, may, thus, allow good visibility even at night, in fume, smoke, fog, mist, or haze.

Further, the devices according to the present invention may be used in the fields of medical systems and sports. Thus, in the field of medical technology, surgery robotics, e.g. for use in endoscopes, may be named, since, as outlined above, the devices according to the present invention may require a low volume only and may be integrated into other devices. Specifically, the devices according to the present invention having one lens, at most, may be used for capturing 3D information in medical devices such as in endoscopes. Further, the devices according to the present invention may be combined with an appropriate monitoring software, in order to enable tracking and analysis of movements. This may allow an instant overlay of the position of a medical device, such as an endoscope or a scalpel, with results from medical imaging, such as obtained from magnetic resonance imaging, x-ray imaging, or ultrasound imaging. These applications are specifically valuable e.g. in medical treatments where precise location information is important such as in brain surgery and long-distance diagnosis and tele-medicine. Further, the devices according to the present invention may be used in 3D-body scanning. Body scanning may be applied in a medical context, such as in dental surgery, plastic surgery, bariatric surgery, or cosmetic plastic surgery, or it may be applied in the context of medical diagnosis such as in the diagnosis of myofascial pain syndrome, cancer, body dysmorphic disorder, or further diseases. Body scanning may further be applied in the field of sports to assess ergonomic use or fit of sports equipment.

Body scanning may further be used in the context of clothing, such as to determine a suitable size and fitting of clothes. This technology may be used in the context of tailor-made clothes or in the context of ordering clothes or shoes from the internet or at a self-service shopping device such as a micro kiosk device or customer concierge device. Body scanning in the context of clothing is especially important for scanning fully dressed customers.

Further, the devices according to the present invention may be used in the context of people counting systems, such as to count the number of people in an elevator, a train, a bus, a car, or a plane, or to count the number of people passing a hallway, a door, an aisle, a retail store, a stadium, an entertainment venue, a museum, a library, a public location, a cinema, a theater, or the like. Further, the 3D-function in the people counting system may be used to obtain or estimate further information about the people that are counted such as height, weight, age, physical fitness, or the like. This information may be used for business intelligence metrics, and/or for further optimizing the locality where people may be counted to make it more attractive or safe. In a retail environment, the devices according to the present invention in the context of people counting may be used to recognize returning customers or cross shoppers, to assess shopping behavior, to assess the percentage of visitors that make purchases, to optimize staff shifts, or to monitor the costs of a shopping mall per visitor. Further, people counting systems may be used for anthropometric surveys. Further, the devices according to the present invention may be used in public transportation systems for automatically charging passengers depending on the length of transport. Further, the devices according to the present invention may be used in playgrounds for children, to recognize injured children or children engaged in dangerous activities, to allow additional interaction with playground toys, to ensure safe use of playground toys or the like.

Further, the devices according to the present invention may be used in construction tools, such as a range meter that determines the distance to an object or to a wall, to assess whether a surface is planar, to align or objects or place objects in an ordered manner, or in inspection cameras for use in construction environments or the like.

Further, the devices according to the present invention may be applied in the field of sports and exercising, such as for training, remote instructions or competition purposes. Specifically, the devices according to the present invention may be applied in the fields of dancing, aerobic, football, soccer, basketball, baseball, cricket, hockey, track and field, swimming, polo, handball, volleyball, rugby, sumo, judo, fencing, boxing, golf, car racing, laser tag, battlefield simulation etc. The devices according to the present invention can be used to detect the position of a ball, a bat, a sword, motions, etc., both in sports and in games, such as to monitor the game, support the referee or for judgment, specifically automatic judgment, of specific situations in sports, such as for judging whether a point or a goal actually was made.

Further, the devices according to the present invention may be used in the field of auto racing or car driver training or car safety training or the like to determine the position of a car or the track of a car, or the deviation from a previous track or an ideal track or the like.

The devices according to the present invention may further be used to support a practice of musical instruments, in particular remote lessons, for example lessons of string instruments, such as fiddles, violins, violas, celli, basses, harps, guitars, banjos, or ukuleles, keyboard instruments, such as pianos, organs, keyboards, harpsichords, harmoniums, or accordions, and/or percussion instruments, such as drums, timpani, marimbas, xylophones, vibraphones, bongos, congas, timbales, djembes or tablas.

The devices according to the present invention further may be used in rehabilitation and physiotherapy, in order to encourage training and/or in order to survey and correct movements. Therein, the devices according to the present invention may also be applied for distance diagnostics.

Further, the devices according to the present invention may be applied in the field of machine vision. Thus, one or more of the devices according to the present invention may be used e.g. as a passive controlling unit for autonomous driving and or working of robots. In combination with moving robots, the devices according to the present invention may allow for autonomous movement and/or autonomous detection of failures in parts. The devices according to the present invention may also be used for manufacturing and safety surveillance, such as in order to avoid accidents including but not limited to collisions between robots, production parts and living beings. In robotics, the safe and direct interaction of humans and robots is often an issue, as robots may severely injure humans when they are not recognized. Devices according to the present invention may help robots to position objects and humans better and faster and allow a safe interaction. Given the passive nature of the devices according to the present invention, the devices according to the present invention may be advantageous over active devices and/or may be used complementary to existing solutions like radar, ultrasound, 2D cameras, IR detection etc. One particular advantage of the devices according to the present invention is the low likelihood of signal interference. Therefore multiple sensors can work at the same time in the same environment, without the risk of signal interference. Thus, the devices according to the present invention generally may be useful in highly automated production environments like e.g. but not limited to automotive, mining, steel, etc. The devices according to the present invention can also be used for quality control in production, e.g. in combination with other sensors like 2-D imaging, radar, ultrasound, IR etc., such as for quality control or other purposes. Further, the devices according to the present invention may be used for assessment of surface quality, such as for surveying the surface evenness of a product or the adherence to specified dimensions, from the range of micrometers to the range of meters. Other quality control applications are feasible. In a manufacturing environment, the devices according to the present invention are especially useful for processing natural products such as food or wood, with a complex 3-dimensional structure to avoid large amounts of waste material. Further, devices according to the present invention may be used to monitor the filling level of tanks, silos etc. Further, devices according to the present invention may be used to inspect complex products for missing parts, incomplete parts, loose parts, low quality parts, or the like, such as in automatic optical inspection, such as of printed circuit boards, inspection of assemblies or sub-assemblies, verification of engineered components, engine part inspections, wood quality inspection, label inspections, inspection of medical devices, inspection of product orientations, packaging inspections, food pack inspections, or the like.

Further, the devices according to the present invention may be used in vehicles, trains, airplanes, ships, spacecraft and other traffic applications. Thus, besides the applications mentioned above in the context of traffic applications, passive tracking systems for aircraft, vehicles and the like may be named. The use of at least one device according to the present invention, such as at least one detector according to the present invention, for monitoring the speed and/or the direction of moving objects is feasible. Specifically, the tracking of fast moving objects on land, sea and in the air including space may be named. The at least one device according to the present invention, such as the at least one detector according to the present invention, specifically may be mounted on a still-standing and/or on a moving device. An output signal of the at least one device according to the present invention can be combined e.g. with a guiding mechanism for autonomous or guided movement of another object. Thus, applications for avoiding collisions or for enabling collisions between the tracked and the steered object are feasible. The devices according to the present invention generally are useful and advantageous due to the low calculation power required, the instant response and due to the passive nature of the detection system which generally is more difficult to detect and to disturb as compared to active systems, like e.g. radar. The devices according to the present invention are particularly useful but not limited to e.g. speed control and air traffic control devices. Further, the devices according to the present invention may be used in automated tolling systems for road charges.

The devices according to the present invention may, generally, be used in passive applications. Passive applications include guidance for ships in harbors or in dangerous areas, and for aircraft when landing or starting. Wherein, fixed, known active targets may be used for precise guidance. The same can be used for vehicles driving on dangerous but well defined routes, such as mining vehicles. Further, the devices according to the present invention may be used to detect rapidly approaching objects, such as cars, trains, flying objects, animals, or the like. Further, the devices according to the present invention can be used for detecting velocities or accelerations of objects, or to predict the movement of an object by tracking one or more of its position, speed, and/or acceleration depending on time.

Further, as outlined above, the devices according to the present invention may be used in the field of gaming. Thus, the devices according to the present invention can be passive for use with multiple objects of the same or of different size, color, shape, etc., such as for movement detection in combination with software that incorporates the movement into its content. In particular, applications are feasible in implementing movements into graphical output. Further, applications of the devices according to the present invention for giving commands are feasible, such as by using one or more of the devices according to the present invention for gesture or facial recognition. The devices according to the present invention may be combined with an active system in order to work under e.g. low light conditions or in other situations in which enhancement of the surrounding conditions is required. Additionally or alternatively, a combination of one or more devices according to the present invention with one or more IR or VIS light sources is possible. A combination of a detector according to the present invention with special devices is also possible, which can be distinguished easily by the system and its software, e.g. and not limited to, a special color, shape, relative position to other devices, speed of movement, light, frequency used to modulate light sources on the device, surface properties, material used, reflection properties, transparency degree, absorption characteristics, etc. The device can, amongst other possibilities, resemble a stick, a racquet, a club, a gun, a knife, a wheel, a ring, a steering wheel, a bottle, a ball, a glass, a vase, a spoon, a fork, a cube, a dice, a figure, a puppet, a teddy, a beaker, a pedal, a switch, a glove, jewelry, a musical instrument or an auxiliary device for playing a musical instrument, such as a plectrum, a drumstick or the like. Other options are feasible.

Further, the devices according to the present invention may be used to detect and or track objects that emit light by themselves, such as due to high temperature or further light emission processes. The light emitting part may be an exhaust stream or the like. Further, the devices according to the present invention may be used to track reflecting objects and analyze the rotation or orientation of these objects.

Further, the devices according to the present invention may generally be used in the field of building, construction and cartography. Thus, generally, one or more devices according to the present invention may be used in order to measure and/or monitor environmental areas, e.g. countryside or buildings. Therein, one or more devices according to the present invention may be combined with other methods and devices or can be used solely in order to monitor progress and accuracy of building projects, changing objects, houses, etc. The devices according to the present invention can be used for generating three-dimensional models of scanned environments, in order to construct maps of rooms, streets, houses, communities or landscapes, both from ground or air. Potential fields of application may be construction, cartography, real estate management, land surveying or the like. As an example, the devices according to the present invention may be used in vehicles capable of flight, such as drones or multicopters, in order to monitor buildings, chimneys, production sites, agricultural production environments such as fields, production plants, or landscapes, to support rescue operations, to support work in dangerous environments, to support fire brigades in a burning location indoors or outdoors, to find or monitor one or more persons, animals, or moving objects, or for entertainment purposes, such as a drone following and recording one or more persons doing sports such as skiing or cycling or the like, which could be realized by following a helmet, a mark, a beacon device, or the like. Devices according to the present invention could be used recognize obstacles, follow a predefined route, follow an edge, a pipe, a building, or the like, or to record a global or local map of the environment. Further, devices according to the present invention could be used for indoor or outdoor localization and positioning of drones, for stabilizing the height of a drone indoors where barometric pressure sensors are not accurate enough, or for the interaction of multiple drones such as concertized movements of several drones or recharging or refueling in the air or the like.

Further, the devices according to the present invention may be used within an interconnecting network of home appliances such as CHAIN (Cedec Home Appliances Interoperating Network) to interconnect, automate, and control basic appliance-related services in a home, e.g. energy or load management, remote diagnostics, pet related appliances, child related appliances, child surveillance, appliances related surveillance, support or service to elderly or ill persons, home security and/or surveillance, remote control of appliance operation, and automatic maintenance support. Further, the devices according to the present invention may be used in heating or cooling systems such as an air-conditioning system, to locate which part of the room should be brought to a certain temperature or humidity, especially depending on the location of one or more persons. Further, the devices according to the present invention may be used in domestic robots, such as service or autonomous robots which may be used for household chores. The devices according to the present invention may be used for a number of different purposes, such as to avoid collisions or to map the environment, but also to identify a user, to personalize the robot's performance for a given user, for security purposes, or for gesture or facial recognition. As an example, the devices according to the present invention may be used in robotic vacuum cleaners, floor-washing robots, dry-sweeping robots, ironing robots for ironing clothes, animal litter robots, such as cat litter robots, security robots that detect intruders, robotic lawn mowers, automated pool cleaners, rain gutter cleaning robots, window washing robots, toy robots, telepresence robots, social robots providing company to less mobile people, or robots translating and speech to sign language or sign language to speech. In the context of less mobile people, such as elderly persons, household robots with the devices according to the present invention may be used for picking up objects, transporting objects, and interacting with the objects and the user in a safe way. Further the devices according to the present invention may be used in robots operating with hazardous materials or objects or in dangerous environments. As a non-limiting example, the devices according to the present invention may be used in robots or unmanned remote-controlled vehicles to operate with hazardous materials such as chemicals or radioactive materials especially after disasters, or with other hazardous or potentially hazardous objects such as mines, unexploded arms, or the like, or to operate in or to investigate insecure environments such as near burning objects or post disaster areas, or for manned or unmanned rescue operations in the air, in the sea, underground, or the like.

Further, the devices according to the present invention may be used in household, mobile or entertainment devices, such as a refrigerator, a microwave, a washing machine, a window blind or shutter, a household alarm, an air condition devices, a heating device, a television, an audio device, a smart watch, a mobile phone, a phone, a dishwasher, a stove or the like, to detect the presence of a person, to monitor the contents or function of the device, or to interact with the person and/or share information about the person with further household, mobile or entertainment devices. Herein, the devices according to the present invention may be used to support elderly or disabled persons, blind persons, or persons with limited vision abilities, such as in household chores or at work such as in devices for holding, carrying, or picking objects, or in a safety system with optical and/or acoustical signals adapted for signaling obstacles in the environment.

The devices according to the present invention may further be used in agriculture, for example to detect and sort out vermin, weeds, and/or infected crop plants, fully or in parts, wherein crop plants may be infected by fungus or insects. Further, for harvesting crops, the devices according to the present invention may be used to detect animals, such as deer, which may otherwise be harmed by harvesting devices. Further, the devices according to the present invention may be used to monitor the growth of plants in a field or greenhouse, in particular to adjust the amount of water or fertilizer or crop protection products for a given region in the field or greenhouse or even for a given plant. Further, in agricultural biotechnology, the devices according to the present invention may be used to monitor the size and shape of plants.

Further, the devices according to the present invention may be combined with sensors to detect chemicals or pollutants, electronic nose chips, microbe sensor chips to detect bacteria or viruses or the like, Geiger counters, tactile sensors, heat sensors, or the like. This may for example be used in constructing smart robots which are configured for handling dangerous or difficult tasks, such as in treating highly infectious patients, handling or removing highly dangerous substances, cleaning highly polluted areas, such as highly radioactive areas or chemical spills, or for pest control in agriculture.

One or more devices according to the present invention can further be used for scanning of objects, such as in combination with CAD or similar software, such as for additive manufacturing and/or 3D printing. Therein, use may be made of the high dimensional accuracy of the devices according to the present invention, e.g. in x-, y- or z-direction or in any arbitrary combination of these directions, such as simultaneously. Within this regard, determining a distance of an illuminated spot on a surface which may provide reflected or diffusely scattered light from the detector may be performed virtually independent of the distance of the light source from the illuminated spot. This property of the present invention is in direct contrast to known methods, such as triangulation or such as time-of-flight (TOF) methods, wherein the distance between the light source and the illuminated spot must be known a priori or calculated a posteriori in order to be able to determine the distance between the detector and the illuminated spot. In contrast hereto, for the detector according to the present invention is may be sufficient that the spot is adequately illuminated. Further, the devices according to the present invention may be used for scanning reflective surfaces, such of metal surfaces, independent whether they may comprise a solid or a liquid surface. Further, the devices according to the present invention may be used in inspections and maintenance, such as pipeline inspection gauges. Further, in a production environment, the devices according to the present invention may be used to work with objects of a badly defined shape such as naturally grown objects, such as sorting vegetables or other natural products by shape or size or cutting products such as meat or objects that are manufactured with a precision that is lower than the precision needed for a processing step.

Further, the devices according to the present invention may be used in local navigation systems to allow autonomously or partially autonomously moving vehicles or multicopters or the like through an indoor or outdoor space. A non-limiting example may comprise vehicles moving through an automated storage for picking up objects and placing them at a different location. Indoor navigation may further be used in shopping malls, retail stores, museums, airports, or train stations, to track the location of mobile goods, mobile devices, baggage, customers or employees, or to supply users with a location specific information, such as the current position on a map, or information on goods sold, or the like.

Further, the devices according to the present invention may be used to ensure safe driving of motorcycles, such as driving assistance for motorcycles by monitoring speed, inclination, upcoming obstacles, unevenness of the road, or curves or the like. Further, the devices according to the present invention may be used in trains or trams to avoid collisions.

Further, the devices according to the present invention may be used in handheld devices, such as for scanning packaging or parcels to optimize a logistics process. Further, the devices according to the present invention may be used in further handheld devices such as personal shopping devices, RFID-readers, handheld devices for use in hospitals or health environments such as for medical use or to obtain, exchange or record patient or patient health related information, smart badges for retail or health environments, or the like.

As outlined above, the devices according to the present invention may further be used in manufacturing, quality control or identification applications, such as in product identification or size identification (such as for finding an optimal place or package, for reducing waste etc.). Further, the devices according to the present invention may be used in logistics applications. Thus, the devices according to the present invention may be used for optimized loading or packing containers or vehicles. Further, the devices according to the present invention may be used for monitoring or controlling of surface damages in the field of manufacturing, for monitoring or controlling rental objects such as rental vehicles, and/or for insurance applications, such as for assessment of damages. Further, the devices according to the present invention may be used for identifying a size of material, object or tools, such as for optimal material handling, especially in combination with robots. Further, the devices according to the present invention may be used for process control in production, e.g. for observing filling level of tanks. Further, the devices according to the present invention may be used for maintenance of production assets like, but not limited to, tanks, pipes, reactors, tools etc. Further, the devices according to the present invention may be used for analyzing 3D-quality marks. Further, the devices according to the present invention may be used in manufacturing tailor-made goods such as tooth inlays, dental braces, prosthesis, clothes or the like. The devices according to the present invention may also be combined with one or more 3D-printers for rapid prototyping, 3D-copying or the like. Further, the devices according to the present invention may be used for detecting the shape of one or more articles, such as for anti-product piracy and for anti-counterfeiting purposes.

Further, the devices according to the present invention may be used in the context of gesture recognition. In this context, gesture recognition in combination with devices according to the present invention may, in particular, be used as a human-machine interface for transmitting information via motion of a body, of body parts or of objects to a machine. Herein, the information may, preferably, be transmitted via a motion of hands or hand parts, such as fingers, in particular, by pointing at objects, applying sign language, such as for deaf people, making signs for numbers, approval, disapproval, or the like, by waving the hand, such as when asking someone to approach, to leave, or to greet a person, to press an object, to take an object, or, in the field of sports or music, in a hand or finger exercise, such as a warm-up exercise. Further, the information may be transmitted by motion of arms or legs, such as rotating, kicking, grabbing, twisting, rotating, scrolling, browsing, pushing, bending, punching, shaking, arms, legs, both arms, or both legs, or a combination of arms and legs, such as for a purpose of sports or music, such as for entertainment, exercise, or training function of a machine. Further, the information may be transmitted by motion of the whole body or major parts thereof, such as jumping, rotating, or making complex signs, such as sign language used at airports or by traffic police in order to transmit information, such as “turn right”, “turn left”, “proceed”, “slow down”, “stop”, or “stop engines”, or by pretending to swim, to dive, to run, to shoot, or the like, or by making complex motions or body positions such as in yoga, pilates, judo, karate, dancing, or ballet. Further, the information may be transmitted by using a real or mock-up device for controlling a virtual device corresponding to the mock-up device, such as using a mock-up guitar for controlling a virtual guitar function in a computer program, using a real guitar for controlling a virtual guitar function in a computer program, using a real or a mock-up book for reading an e-book or moving pages or browsing through in a virtual document, using a real or mock-up pen for drawing in a computer program, or the like. Further, the transmission of the information may be coupled to a feedback to the user, such as a sound, a vibration, or a motion.

In the context of music and/or instruments, devices according to the present invention in combination with gesture recognition may be used for exercising purposes, control of instruments, recording of instruments, playing or recording of music via use of a mock-up instrument or by only pretending to have a instrument present such as playing air guitar, such as to avoid noise or make recordings, or, for conducting of a virtual orchestra, ensemble, band, big band, choir, or the like, for practicing, exercising, recording or entertainment purposes or the like.

Further, in the context of safety and surveillance, devices according to the present invention in combination with gesture recognition may be used to recognize motion profiles of persons, such as recognizing a person by the way of walking or moving the body, or to use hand signs or movements or signs or movements of body parts or the whole body as access or identification control such as a personal identification sign or a personal identification movement.

Further, in the context of smart home applications or internet of things, devices according to the present invention in combination with gesture recognition may be used for central or non-central control of household devices which may be part of an interconnecting network of home appliances and/or household devices, such as refrigerators, central heating, air condition, microwave ovens, ice cube makers, or water boilers, or entertainment devices, such as television sets, smart phones, game consoles, video recorders, DVD players, personal computers, laptops, tablets, or combinations thereof, or a combination of household devices and entertainment devices.

Further, in the context of virtual reality or of augmented reality, devices according to the present invention in combination with gesture recognition may be used to control movements or function of the virtual reality application or of the augmented reality application, such as playing or controlling a game using signs, gestures, body movements or body part movements or the like, moving through a virtual world, manipulating virtual objects, practicing, exercising or playing sports, arts, crafts, music or games using virtual objects such as a ball, chess figures, go stones, instruments, tools, brushes.

Further, in the context of medicine, devices according to the present invention in combination with gesture recognition may be used to support rehabilitation training, remote diagnostics, or to monitor or survey surgery or treatment, to overlay and display medical images with positions of medical devices, or to overlay display prerecorded medical images such as from magnetic resonance tomography or x-ray or the like with images from endoscopes or ultra sound or the like that are recorded during an surgery or treatment.

Further, in the context of manufacturing and process automation, devices according to the present invention in combination with gesture recognition may be used to control, teach, or program robots, drones, unmanned autonomous vehicles, service robots, movable objects, or the like, such as for programming, controlling, manufacturing, manipulating, repairing, or teaching purposes, or for remote manipulating of objects or areas, such as for safety reasons, or for maintenance purposes.

Further, in the context of business intelligence metrics, devices according to the present invention in combination with gesture recognition may be used for people counting, surveying customer movements, areas where customers spend time, objects, customers test, take, probe, or the like.

Further, devices according to the present invention may be used in the context of do-it-yourself or professional tools, especially electric or motor driven tools or power tools, such as drilling machines, saws, chisels, hammers, wrenches, staple guns, disc cutters, metals shears and nibblers, angle grinders, die grinders, drills, hammer drills, heat guns, wrenches, sanders, engraivers, nailers, jig saws, buiscuit joiners, wood routers, planers, polishers, tile cutters, washers, rollers, wall chasers, lathes, impact drivers, jointers, paint rollers, spray guns, morticers, or welders, in particular, to support precision in manufacturing, keeping a minimum or maximum distance, or for safety measures.

Further, the devices according to the present invention may be used to aid visually impaired persons. Further, devices according to the present invention may be used in touch screen such as to avoid direct context such as for hygienic reasons, which may be used in retail environments, in medical applications, in production environments, or the like. Further, devices according to the present invention may be used in agricultural production environments such as in stable cleaning robots, egg collecting machines, milking machines, harvesting machines, farm machinery, harvesters, forwarders, combine harvesters, tractors, cultivators, ploughs, destoners, harrows, strip tills, broadcast seeders, planters such as potato planters, manure spreaders, sprayers, sprinkler systems, swathers, balers, loaders, forklifts, mowers, or the like.

Further, devices according to the present invention may be used for selection and/or adaption of clothing, shoes, glasses, hats, prosthesis, dental braces, for persons or animals with limited communication skills or possibilities, such as children or impaired persons, or the like. Further, devices according to the present invention may be used in the context of warehouses, logistics, distribution, shipping, loading, unloading, smart manufacturing, industry 4.0, or the like. Further, in a manufacturing context, devices according to the present invention may be used in the context of processing, dispensing, bending, material handling, or the like.

The devices according to the present invention may be combined with one or more other types of measurement devices. Thus, the devices according to the present invention may be combined with one or more other types of sensors or detectors, such as a time of flight (TOF) detector, a stereo camera, a lightfield camera, a lidar, a radar, a sonar, an ultrasonic detector, or interferometry. When combining devices according to the present invention with one or more other types of sensors or detectors, the devices according to the present invention and the at least one further sensor or detector may be designed as independent devices, with the devices according to the present invention being separate from the at least one further sensor or detector. Alternatively, the devices according to the present invention and the at least one further sensor or detector may fully or partially be integrated or designed as a single device.

Thus, as a non-limiting example, the devices according to the present invention may further comprise a stereo camera. As used herein, a stereo camera is a camera which is designed for capturing images of a scene or an object from at least two different perspectives. Thus, the devices according to the present invention may be combined with at least one stereo camera.

The stereo camera's functionality is generally known in the art, since stereo cameras generally are known to the skilled person. The combination with the devices according to the present invention may provide additional distance information. Thus, the devices according to the present invention may be adapted, in addition to the stereo camera's information, to provide at least one item of information on a longitudinal position of at least one object within a scene captured by the stereo camera. Information provided by the stereo camera, such as distance information obtained by evaluating triangulation measurements performed by using the stereo camera, may be calibrated and/or validated by using the devices according to the present invention. Thus, as an example, the stereo camera may be used to provide at least one first item of information on the longitudinal position of the at least one object, such as by using triangulation measurements, and the devices according to the present invention may be used to provide at least one second item of information on the longitudinal position of the at least one object. The first item of information and the second item of information may be used to improve accuracy of the measurements. Thus, the first item of information may be used for calibrating the second item of information or vice a versa. Consequently, the devices according to the present invention, as an example, may form a stereo camera system, having the stereo camera and the devices according to the present invention, wherein the stereo camera system is adapted to calibrate the information provided by the stereo camera by using the information provided by devices according to the present invention.

Consequently, additionally or alternatively, the devices according to the present invention may be adapted to use the second item of information, provided by the devices according to the present invention, for correcting the first item of information, provided by the stereo camera.

Additionally or alternatively, the devices according to the present invention may be adapted to use the second item of information, provided by the devices according to the present invention, for correcting optical distortion of the stereo camera. Further, the devices according to the present invention may adapted to calculate stereo information provided by the stereo camera, and the second item of information provided by devices according to the present invention may be used for speeding up the calculation of the stereo information.

As an example, the devices according to the present invention may be adapted to use at least one virtual or real object within a scene captured by the devices according to the present invention for calibrating the stereo camera. As an example, one or more objects and/or areas and/or spots may be used for calibration. As an example, the distance of at least one object or spot may be determined by using the devices according to the present invention, and distance information provided by the stereo camera may be calibrated by using this distance is determined by using the devices according to the present invention. For instance, at least one active light spot of the devices according to the present invention may be used as a calibration point for the stereo camera. The active light spot, as an example, may move freely in the picture.

The devices according to the present invention may be adapted to continuously or discontinuously calibrate the stereo camera by using information provided by the active distance sensor. Thus, as an example, the calibration may take place at regular intervals, continuously or occasionally.

Further, typical stereo cameras exhibit measurement errors or uncertainties which are dependent on the distance of the object. This measurement error may be reduced when combined with information provided by the devices according to the present invention.

Combinations of stereo cameras with other types of distance sensors are generally known in the art. Thus, in D. Scaramuzza et al., IEEE/RSJ International Conference on Intelligent Robots and Systems, 2007. IROS 2007. Pages 4164-4169, an extrinsic self calibration of a camera and a 3D laser range finder from natural scenes is disclosed. Similarly, in D. Klimentjew et al., 2010 IEEE Conference on Multisensor Fusion and Integration for Intelligent Systems (MFI), pages 236-241, a multi sensor fusion of camera and 3D laser range finder for object recognition is disclosed. As the skilled person will recognize, the laser range finder in these setups known in the art may simply be replaced or complemented by at least one device according to the present invention, without altering the methods and advantages disclosed by these prior art documents. For potential setups of the stereo camera, reference may be made to these prior art documents. Still, other setups and embodiments of the at least one optional stereo camera are feasible.

Preferably, for further potential details of the optical detector, the method, the human-machine interface, the entertainment device, the tracking system, the camera and the various uses of the detector, in particular with regard to the transfer device, the longitudinal optical sensors, the evaluation device and, if applicable, to the transversal optical sensor, the modulation device, the illumination source and the imaging device, specifically with respect to the potential materials, setups and further details, reference may be made to one or more of WO 2012/110924 A1, US 2012/206336 A1, WO 2014/097181 A1, and US 2014/291480 A1, the full content of all of which is herewith included by reference.

The above-described detector, the method, the human-machine interface and the entertainment device and also the proposed uses have considerable advantages over the prior art. Thus, generally, a simple and, still, efficient detector for an accurate determining a position of at least one object in space may be provided. Therein, as an example, three-dimensional coordinates of an object or a part thereof may be determined in a fast and efficient way.

As compared to devices known in the art, the detector as proposed provides a high degree of simplicity, specifically with regard to an optical setup of the detector. Thus, in principle, by using an optical detector which comprises a sensor region having at least one semiconducting material, wherein at a part of a surface of the semiconducting material a high-resistive material is provided, in combination with a variation of the cross-section of an incident light beam impinging on this semiconducting material being adjacent to the high-resistive material in conjunction with an appropriate evaluation device is sufficient for reliable high precision position detection. This high degree of simplicity, in combination with the possibility of high precision measurements, is specifically suited for machine control, such as in human-machine interfaces and, more preferably, in gaming. Thus, cost-efficient entertainment devices may be provided which may be used for a large number of gaming purposes.

Further specific advantages of the present invention may refer to a high responsivity of the longitudinal optical sensor to both very low light levels (moonlight) and to very high light levels (direct sunlight), wherein the responsivity may exhibit a wide dynamic range due to a flexible adjustment of the bias voltage level over a wide range. The flexible adjustment of the bias voltage level over a wide range may further be employed for determining a baseline of the optical sensor which exhibits the advantage that a single optical sensor may be sufficient within the optical detector to unambiguously determine the sensor signal by taking into account the baseline of the optical sensor. Further, no modulation of the incident light beam may be required. Also, the resulting longitudinal sensor signal may exhibit a comparatively low noise level, in particular in comparison with the optical sensors comprising a photoconductive material as disclosed in PCT patent application No. PCT/EP2016/051817, filed Jan. 28, 2016.

Summarizing, in the context of the present invention, the following embodiments are regarded as particularly preferred:

### EMBODIMENT 1

A detector for an optical detection of at least one object, comprising:
at least one longitudinal optical sensor, wherein the longitudinal optical sensor has at least one sensor region, wherein the longitudinal optical sensor is designed to generate at least one longitudinal sensor signal in a manner dependent on an illumination of the sensor region by a light beam, wherein the longitudinal sensor signal, given the same total power of the illumination, exhibits a dependency on a beam cross-section of the light beam in the sensor region, wherein the longitudinal sensor signal is generated by at least one semiconducting material comprised in the sensor region, wherein a high-resistive material is present at a part of a surface of the semiconducting material, wherein the high-resistive material exhibits an electrical resistance which equals or exceeds the electrical resistance of the semiconducting material; and
at least one evaluation device, wherein the evaluation device is designed to generate at least one item of information on a longitudinal position of the object by evaluating the longitudinal sensor signal of the longitudinal optical sensor.

### EMBODIMENT 2

The detector according to the preceding embodiment, wherein the high-resistive material is separated from the semiconducting material by at least one of a boundary, an interface and/or a junction.

### EMBODIMENT 3

The detector according to any one of the preceding embodiments, wherein the at least one of the boundary, interface and/or junction comprises the high-resistive material.

### EMBODIMENT 4

The detector according to any one of the two preceding embodiments, wherein the boundary, the interface and/or the junction exhibit a scaling behavior with respect to the electrically conducting properties of the semiconducting material and the high-resistive material located at both sides of the boundary, the interface and/or the junction.

### EMBODIMENT 5

The detector according to the preceding embodiment, wherein the scaling behavior at the boundary, the interface and/or the junction comprises an alteration of the electrical resistance between the semiconducting material and the high-resistive material within the boundary, the interface and/or the junction in a nonlinear form.

### EMBODIMENT 6

The detector according to any one of the preceding embodiments, wherein the high-resistive material is selected from at least one of a high-resistive layer, a high-resistive coating, a high-resistive depletion zone, a high-resistive tunneling barrier, a high-resistive band-to-band interface, a high-resistive Schottky barrier.

### EMBODIMENT 7

The detector according to any one of the preceding embodiments, wherein the semiconducting material comprises an inorganic semiconducting material, an organic semiconducting material, or a combination thereof.

### EMBODIMENT 8

The detector according to the preceding embodiment, wherein the inorganic semiconducting material comprises one or more of selenium, tellurium, a selenium-tellurium alloy, a metal oxide, a group IV element or compound, a III-V compound, a II-VI compound, and a chalcogenide.

### EMBODIMENT 9

The detector according to the preceding embodiment, wherein the metal oxide is selected from a group comprising copper (II) oxide (CuO), copper (I) oxide (CuO₂), nickel oxide (NiO), zinc oxide (ZnO), silver oxide (Ag₂O), manganese oxide (MnO), titanium dioxide (TiO₂), barium oxide (BaO), lead oxide (PbO), cerium oxide (CeO₂), bismuth oxide (Bi₂O₃), and cadmium oxide (CdO).

### EMBODIMENT 10

The detector according to any one of the preceding embodiments, wherein the group IV element or compound is be selected from a group comprising doped diamond (C), doped silicon (Si), silicon carbide (SiC), and silicon germanium (SiGe).

### EMBODIMENT 11

The detector according to any one of the preceding embodiments, wherein the III-V compound is selected from a group comprising indium antimonide (InSb), boron nitride (BN), boron phosphide (BP), boron arsenide (BAs), aluminum nitride (AlN), aluminum phosphide (AlP), aluminum arsenide (AlAs), aluminum antimonide (AlSb), indium nitride (InN), indium phosphide (InP), indium arsenide (InAs), indium antimonide (InSb), gallium nitride (GaN), gallium phosphide (GaP), gallium arsenide (GaAs), and gallium antimonide (GaSb).

### EMBODIMENT 12

The detector according to any one of the preceding embodiments, wherein the II-VI compound is selected from a group comprising cadmium sulfide (CdS), cadmium selenide (CdSe), cadmium telluride (CdTe), zinc sulfide (ZnS), zinc selenide (ZnSe), zinc telluride (ZnTe), mercury sulfide (HgS), mercury selenide (HgSe), mercury telluride (HgTe), cadmium zinc telluride (CdZnTe), mercury cadmium telluride (HgCdTe), mercury zinc telluride (HgZnTe), and mercury zinc selenide (CdZnSe).

### EMBODIMENT 13

The detector according to the preceding embodiments, wherein the chalcogenide is selected from a group comprising sulfide chalcogenides, selenide chalcogenides, telluride chalcogenides, ternary chalcogenides, quaternary and higher chalcogenides.

### EMBODIMENT 14

The detector according to the preceding embodiment, wherein the sulfide chalcogenide is selected from a group comprising lead sulfide (PbS), cadmium sulfide (CdS), zinc sulfide (ZnS), mercury sulfide (HgS), silver sulfide (Ag₂S), manganese sulfide (MnS), bismuth trisulfide (Bi₂S₃), antimony trisulfide (Sb₂S₃), arsenic trisulfide (As₂S₃), tin (II) sulfide (SnS), tin (IV) disulfide (SnS₂), indium sulfide (In₂S₃), copper sulfide (CuS), cobalt sulfide (CoS), nickel sulfide (NiS), molybdenum disulfide (MoS₂), iron disulfide (FeS₂), and chromium trisulfide (CrS₃).

### EMBODIMENT 15

The detector according to any one of the two preceding embodiments, wherein the selenide chalcogenide is selected from a group comprising lead selenide (PbSe), cadmium selenide (CdSe), zinc selenide (ZnSe), bismuth triselenide (Bi₂Se₃), mercury selenide (HgSe), antimony triselenide (Sb₂Se₃), arsenic triselenide (As₂Se₃), nickel selenide (NiSe), thallium selenide (TlSe), copper selenide (CuSe), molybdenum diselenide (MoSe₂), tin selenide (SnSe), and cobalt selenide (CoSe), and indium selenide (In₂Se₃).

### EMBODIMENT 16

The detector according to any one of the three preceding embodiments, wherein the telluride chalcogenide is selected from a group comprising lead telluride (PbTe), cadmium telluride (CdTe), zinc telluride (ZnTe), mercury telluride (HgTe), bismuth tritelluride (Bi₂Te₃), arsenic tritelluride (As₂Te₃), antimony tritelluride (Sb₂Te₃), nickel telluride (NiTe), thallium telluride (TlTe), copper telluride (CuTe), molybdenum ditelluride (MoTe₂), tin telluride (SnTe), and cobalt telluride (CoTe), silver telluride (Ag₂Te), and indium telluride (In₂Te₃).

### EMBODIMENT 17

The detector according to any one of the four preceding embodiments, wherein the ternary chalcogenide is selected from a group comprising mercury cadmium telluride (HgCdTe), mercury zinc telluride (HgZnTe), mercury cadmium sulfide (HgCdS), lead cadmium sulfide (PbCdS), lead mercury sulfide (PbHgS), copper indium disulfide (CuInS₂), cadmium sulfoselenide (CdSSe), zinc sulfoselenide (ZnSSe), thallous sulfoselenide (TlSSe), cadmium zinc sulfide (CdZnS), cadmium chromium sulfide (CdCr₂S₄), mercury chromium sulfide (HgCr₂S₄), copper chromium sulfide (CuCr₂S₄), cadmium lead selenide (CdPbSe), copper indium diselenide (CuInSe₂), indium gallium arsenide (InGaAs), lead oxide sulfide (Pb₂OS), lead oxide selenide (Pb₂OSe), lead sulfoselenide (PbSSe), arsenic selenide telluride (As₂Se₂Te), indium gallium phosphide (InGaP), gallium arsenide phosphide (GaAsP), aluminium gallium phosphide (AlGaP), cadmium selenite (CdSeO₃), cadmium zinc telluride (CdZnTe), and cadmium zinc selenide (CdZnSe).

### EMBODIMENT 18

The detector according to any one of the preceding embodiments, wherein the organic semiconducting material comprises a compound selected from the group comprising phthalocyanines, naphthalocyanines, subphthalocyanines, perylenes, anthracenes, pyrenes, oligo- and polythiophenes, fullerenes, indigoid dyes, bis-azo pigments, squarylium dyes, thiapyrilium dyes, azulenium dyes, dithioketo-pyrrolopyrroles, quinacridones, dibromoanthanthrone, polyvinylcarbazole, derivatives and combinations thereof.

### EMBODIMENT 19

The detector according to any one of the preceding embodiments, wherein the semiconducting material is embedded between at least two electrodes.

### EMBODIMENT 20

The detector according to the preceding embodiment, wherein the optical detector is adapted to generate the longitudinal sensor signal by measuring one or more of an electrical current or an electrical voltage across at least a part of the sensor region by using the electrodes.

### EMBODIMENT 21

The detector according to any one of the two preceding embodiments, wherein at least one of the electrodes is transparent with respect to a wavelength of the light beam.

### EMBODIMENT 22

The detector according to any one of the preceding embodiments, wherein the semiconducting material comprises at least one of an n-type semiconducting material and a p-type semiconducting material.

### EMBODIMENT 23

The detector according to the preceding embodiment, wherein the semiconducting material further comprises an i-type semiconducting material being located between the n-type semiconducting material and the p-type semiconducting material.

### EMBODIMENT 24

The detector according to any one of the preceding embodiments, wherein the semiconducting material is provided in form of a semiconducting amorphous, monocrystalline, nanocrystalline or microcrystalline solid.

### EMBODIMENT 25

The detector according to any one of the preceding embodiments, wherein the semiconducting material is provided in form of a semiconducting layer, wherein the semiconducting layer comprises two opposing surface areas.

### EMBODIMENT 26

The detector according to the preceding embodiment, wherein the semiconducting layer comprises a semiconducting microcrystalline phase, wherein the semiconducting microcrystalline phase is, preferably, selected from silicon.

### EMBODIMENT 27

The detector according to any one of the two preceding embodiments, wherein the semiconducting layer comprises semiconducting microcrystalline needles, wherein at least a part of the needles are oriented perpendicular to the surface areas of the semiconducting layer.

### EMBODIMENT 28

The detector according to any one of the three preceding embodiments, wherein at least one of the two surface areas of the semiconducting layer is adjacent to a high-resistive layer, wherein the electrical resistance of the high-resistive layer exceeds the electrical resistance of the adjacent semiconducting layer.

### EMBODIMENT 29

The detector according to any one of the preceding embodiments, wherein at least one of the two surface areas of the semiconducting layer is adjacent to a metal layer or to at least one layer comprising a transparent conducting oxide.

### EMBODIMENT 30

The detector according to the preceding embodiment, wherein a high-resistive depletion zone is present between the semiconducting layer and the adjacent metal layer.

### EMBODIMENT 31

The detector according to any one of the preceding embodiments, wherein the semiconducting material comprises at least one n-type semiconducting layer and at least one p-type semiconducting layer.

### EMBODIMENT 32

The detector according to the preceding embodiment, wherein the n-type semiconducting material and/or the p-type semiconducting material in the semiconducting layer is arranged as a plurality of n-type semiconducting regions and/or of p-type semiconducting regions located within the semiconducting layer.

### EMBODIMENT 33

The detector according to any one of the two preceding embodiments, wherein the at least one boundary, interface and/or junction is located between, on one hand, at least one of the plurality of the n-type semiconducting regions and the n-type semiconducting layer and, on the other hand, at least one of the plurality of the p-type semiconducting regions and the p-type semiconducting layer.

### EMBODIMENT 34

The detector according to the preceding embodiment, wherein a plurality of boundaries, interfaces and/or junctions is located within the semiconducting layer.

### EMBODIMENT 35

The detector according to the preceding embodiment, wherein the plurality of the boundaries, the interfaces and/or the junctions is located in a one-dimensional or two-dimensional arrangement within the semiconducting layer.

### EMBODIMENT 36

The detector according to any one of the three preceding embodiments, wherein two adjacent boundaries, interfaces and/or junctions are separated by an insulating layer.

### EMBODIMENT 37

The detector according to any one of the four preceding embodiments, wherein an i-type semiconducting layer is located at the boundary, the interface and/or the junction between, on one hand, at least one of the plurality of the n-type semiconducting regions and the n-type semiconducting layer and, on the other hand, at least one of the plurality of the p-type semiconducting regions and the p-type semiconducting layer.

### EMBODIMENT 38

The detector according to any one of the twelve preceding embodiments, wherein the semiconducting layer is embedded between at least two electrode layers.

### EMBODIMENT 39

The detector according to the preceding embodiment, wherein a bias voltage is applied across the two electrode layers.

### EMBODIMENT 40

The detector according to the preceding embodiment, wherein the bias voltage is configured for tuning the dependency of the longitudinal sensor signal on the beam cross-section of the light beam in the sensor region.

### EMBODIMENT 41

The detector according to the preceding embodiment, wherein the bias voltage is configured for switching on or switching off the FiP-effect of the longitudinal optical sensor.

### EMBODIMENT 42

The detector according to any one of the four preceding embodiments, wherein one of the surface areas of the semiconducting layer is adjacent to the high-resistive layer.

### EMBODIMENT 43

The detector according to the preceding embodiment, wherein the other of the surface areas of the semiconducting layer is adjacent to one of the electrode layers.

### EMBODIMENT 44

The detector according to any one of the two preceding embodiments, wherein the high-resistive layer is adjacent to the other of the electrode layers.

### EMBODIMENT 45

The detector according to any one of the seven preceding embodiments, wherein one of the electrode layers is a split electrode.

### EMBODIMENT 46

The detector according to the preceding embodiment, wherein the split electrode comprises at least two separate partial electrodes.

### EMBODIMENT 47

The detector according to any one of the two preceding embodiments, wherein the at least two partial electrodes are arranged at different locations on a medium-resistive layer.

### EMBODIMENT 48

The detector according to the preceding embodiment, wherein the electrical resistivity of the medium-resistive layer exceeds the electrical resistivity of the partial electrode but falls below the electrical resistivity of the high-resistive layer.

### EMBODIMENT 49

The detector according to any one of the three preceding embodiments, wherein the at least two partial electrodes are applied on the same side of the medium-resistive layer.

### EMBODIMENT 50

The detector according to any one of the four preceding embodiments, wherein the at least two partial electrodes are used as part of a transversal optical sensor, the transversal optical sensor being adapted to determine a transversal position of the light beam traveling from the object to the detector, the transversal position being a position in at least one dimension perpendicular to an optical axis of the detector, the transversal optical sensor being adapted to generate at least one transversal sensor signal.

### EMBODIMENT 51

The detector according to the any one of the four preceding embodiments, wherein the at least two partial electrodes are concurrently used as part of a transversal optical sensor and as part of a longitudinal optical sensor.

### EMBODIMENT 52

The detector according to any one of the two preceding embodiments, wherein the evaluation device is further designed to generate at least one item of information on a transversal position of the object by evaluating the transversal sensor signal.

### EMBODIMENT 53

The detector according to any one of the six preceding embodiments, wherein electrical currents through the partial electrodes are dependent on a position of the light beam in the sensor region, wherein the transversal optical sensor is adapted to generate the transversal sensor signal in accordance with the electrical currents through the partial electrodes.

### EMBODIMENT 54

The detector according to the preceding embodiment, wherein the detector is adapted to derive the information on the transversal position of the object from at least one ratio of the currents through the partial electrodes.

### EMBODIMENT 55

The detector according to the preceding embodiment, wherein a part of a surface of the semiconducting particles is covered by a high-resistive coating, wherein the electrical resistance of the high-resistive coating exceeds the electrical resistance of the semiconducting particles.

### EMBODIMENT 56

The detector according to any of the preceding embodiments, wherein the longitudinal optical sensor is a transparent optical sensor.

### EMBODIMENT 57

The detector according to any of the preceding embodiments, wherein the sensor region of the longitudinal optical sensor is exactly one continuous sensor region, wherein the longitudinal sensor signal is a uniform sensor signal for the entire sensor region.

### EMBODIMENT 58

The detector according to any of the preceding embodiments, wherein the sensor region of the longitudinal optical sensor is formed by a surface of the respective device, wherein the surface faces towards the object or faces away from the object.

### EMBODIMENT 59

The detector according to any of the preceding embodiments, wherein the optical detector is adapted to generate the longitudinal sensor signal by one or more of measuring an electrical resistance or a conductivity of at least one part of the sensor region.

### EMBODIMENT 60

The detector according to the preceding embodiment, wherein the optical detector is adapted to generate the longitudinal sensor signal by performing at least one current-voltage measurement and/or at least one voltage-current-measurement.

### EMBODIMENT 61

The detector according to any of the preceding embodiments, wherein the evaluation device is designed to generate the at least one item of information on the longitudinal position of the object from at least one predefined relationship between the geometry of the illumination and a relative positioning of the object with respect to the detector, preferably taking account of a known power of the illumination and optionally taking account of a modulation frequency with which the illumination is modulated.

### EMBODIMENT 62

The detector according to any of the preceding embodiments, wherein the detector furthermore has at least one modulation device for modulating the illumination.

### EMBODIMENT 63

The detector according to any the preceding embodiment, wherein the light beam is a modulated light beam.

### EMBODIMENT 64

The detector according to the preceding embodiment, wherein the detector is designed to detect at least two longitudinal sensor signals in the case of different modulations, in particular at least two sensor signals at respectively different modulation frequencies, wherein the evaluation device is designed to generate the at least one item of information on the longitudinal position of the object by evaluating the at least two longitudinal sensor signals.

### EMBODIMENT 65

The detector according to any of the preceding embodiments, wherein the longitudinal optical sensor is furthermore designed in such a way that the longitudinal sensor signal, given the same total power of the illumination, is dependent on a modulation frequency of a modulation of the illumination.

### EMBODIMENT 66

The detector according to the preceding embodiment, wherein the light beam is a non-modulated continuous-wave light beam.

### EMBODIMENT 67

The detector according to any one of the preceding embodiments, furthermore comprising at least one illumination source.

### EMBODIMENT 68

The detector according to the preceding embodiment, wherein the illumination source is selected from: an illumination source, which is at least partly connected to the object and/or is at least partly identical to the object; an illumination source which is designed to at least partly illuminate the object with a primary radiation.

### EMBODIMENT 69

The detector according to the preceding embodiment, wherein the light beam is generated by a reflection of the primary radiation on the object and/or by light emission by the object itself, stimulated by the primary radiation.

### EMBODIMENT 70

The detector according to the preceding embodiment, wherein the spectral sensitivities of the longitudinal optical sensor is covered by the spectral range of the illumination source.

### EMBODIMENT 71

The detector according to any of the preceding embodiments, wherein the detector has at least two longitudinal optical sensors, wherein the longitudinal optical sensors are stacked.

### EMBODIMENT 72

The detector according to the preceding embodiment, wherein the longitudinal optical sensors are stacked along the optical axis.

### EMBODIMENT 73

The detector according to any of the two preceding embodiments, wherein the longitudinal optical sensors form a longitudinal optical sensor stack, wherein the sensor regions of the longitudinal optical sensors are oriented perpendicular to the optical axis.

### EMBODIMENT 74

The detector according to any of the three preceding embodiments, wherein the longitudinal optical sensors are arranged such that a light beam from the object illuminates all longitudinal optical sensors, preferably sequentially, wherein at least one longitudinal sensor signal is generated by each longitudinal optical sensor.

### EMBODIMENT 75

The detector according to any of the preceding embodiments, wherein the evaluation device is adapted to normalize the longitudinal sensor signals and to generate the information on the longitudinal position of the object independent from an intensity of the light beam.

### EMBODIMENT 76

The detector according to the preceding embodiment, wherein the evaluation device is adapted to recognize whether the light beam widens or narrows, by comparing the longitudinal sensor signals of different longitudinal sensors.

### EMBODIMENT 77

The detector according to any of the preceding embodiments, wherein the evaluation device is adapted to generate the at least one item of information on the longitudinal position of the object by determining a diameter of the light beam from the at least one longitudinal sensor signal.

### EMBODIMENT 78

The detector according to the preceding embodiment, wherein the evaluation device is adapted to compare the diameter of the light beam with known beam properties of the light beam in order to determine the at least one item of information on the longitudinal position of the object, preferably from a known dependency of a beam diameter of the light beam on at least one propagation coordinate in a direction of propagation of the light beam and/or from a known Gaussian profile of the light beam.

### EMBODIMENT 79

The detector according to any one of the preceding embodiments, wherein the detector further comprises at least one imaging device.

### EMBODIMENT 80

The detector according to the preceding claim, wherein the imaging device is located in a position furthest away from the object.

### EMBODIMENT 81

The detector according to any of the two preceding embodiments, wherein the light beam passes through the at least one longitudinal optical sensor before illuminating the imaging device.

### EMBODIMENT 82

The detector according to any of the three preceding embodiments, wherein the imaging device comprises a camera.

### EMBODIMENT 83

The detector according to any of the four preceding embodiments, wherein the imaging device comprises at least one of: an inorganic camera; a monochrome camera; a multichrome camera; a full-color camera; a pixelated inorganic chip; a pixelated organic camera; a CCD chip, preferably a multi-color CCD chip or a full-color CCD chip; a CMOS chip; an IR camera; an RGB camera.

### EMBODIMENT 84

An arrangement comprising at least two detectors according to any of the preceding embodiments.

### EMBODIMENT 85

The arrangement according to any of the two preceding embodiments, wherein the arrangement further comprises at least one illumination source.

### EMBODIMENT 86

A human-machine interface for exchanging at least one item of information between a user and a machine, in particular for inputting control commands, wherein the human-machine interface comprises at least one detector according to any of the preceding embodiments relating to a detector, wherein the human-machine interface is designed to generate at least one item of geometrical information of the user by means of the detector wherein the human-machine interface is designed to assign to the geometrical information at least one item of information, in particular at least one control command.

### EMBODIMENT 87

The human-machine interface according to the preceding embodiment, wherein the at least one item of geometrical information of the user is selected from the group consisting of: a position of a body of the user; a position of at least one body part of the user; an orientation of a body of the user; an orientation of at least one body part of the user.

### EMBODIMENT 88

The human-machine interface according to any of the two preceding embodiments, wherein the human-machine interface further comprises at least one beacon device connectable to the user, wherein the human-machine interface is adapted such that the detector may generate an information on the position of the at least one beacon device.

### EMBODIMENT 89

The human-machine interface according to the preceding embodiment, wherein the beacon device comprises at least one illumination source adapted to generate at least one light beam to be transmitted to the detector.

### EMBODIMENT 90

An entertainment device for carrying out at least one entertainment function, in particular a game, wherein the entertainment device comprises at least one human-machine interface according to any of the preceding embodiments referring to a human-machine interface, wherein the entertainment device is designed to enable at least one item of information to be input by a player by means of the human-machine interface, wherein the entertainment device is designed to vary the entertainment function in accordance with the information.

### EMBODIMENT 91

A tracking system for tracking the position of at least one movable object, the tracking system comprising at least one detector according to any of the preceding embodiments referring to a detector, the tracking system further comprising at least one track controller, wherein the track controller is adapted to track a series of positions of the object, each comprising at least one item of information on a position of the object at a specific point in time.

### EMBODIMENT 92

The tracking system according to the preceding embodiment, wherein the tracking system further comprises at least one beacon device connectable to the object, wherein the tracking system is adapted such that the detector may generate an information on the position of the object of the at least one beacon device.

### EMBODIMENT 93

A scanning system for determining at least one position of at least one object, the scanning system comprising at least one detector according to any of the preceding embodiments relating to a detector, the scanning system further comprising at least one illumination source adapted to emit at least one light beam configured for an illumination of at least one dot located at at least one surface of the at least one object, wherein the scanning system is designed to generate at least one item of information about the distance between the at least one dot and the scanning system by using the at least one detector.

### EMBODIMENT 94

The scanning system according to the preceding embodiment, wherein the illumination source comprises at least one artificial illumination source, in particular at least one laser source and/or at least one incandescent lamp and/or at least one semiconductor light source.

### EMBODIMENT 95

The scanning system according to any one of the two preceding embodiments, wherein the illumination source emits a plurality of individual light beams, in particular an array of light beams exhibiting a respective pitch, in particular a regular pitch.

### EMBODIMENT 96

The scanning system according to any one of the three preceding embodiments, wherein the illumination source comprises at least one movable mirror adapted to redirect the light beam through space.

### EMBODIMENT 97

The scanning system according to the preceding embodiment, wherein the illumination source comprises at least one micro-mirror array configured for projecting a set of optical features, in particular points or fringes.

### EMBODIMENT 98

The scanning system according to any one of the three preceding embodiments, wherein the scanning system comprises at least one housing.

### EMBODIMENT 99

The scanning system according to the preceding embodiment, wherein the at least one item of information about the distance between the at least one dot and the scanning system distance is determined between the at least one dot and a specific point on the housing of the scanning system, in particular a front edge or a back edge of the housing.

### EMBODIMENT 100

The scanning system according to any one of the two preceding embodiments, wherein the housing comprises at least one of a display, a button, a fastening unit, a leveling unit.

### EMBODIMENT 101

A camera for imaging at least one object, the camera comprising at least one detector according to any one of the preceding embodiments referring to a detector.

### EMBODIMENT 102

A method for an optical detection of at least one object, in particular using a detector according to any of the preceding embodiments relating to a detector, comprising the following steps:
generating at least one longitudinal sensor signal by using at least one longitudinal optical sensor, wherein the longitudinal sensor signal is dependent on an illumination of a sensor region of the longitudinal optical sensor by a light beam, wherein the longitudinal sensor signal, given the same total power of the illumination, is dependent on a beam cross-section of the light beam in the sensor region, wherein the longitudinal sensor signal is generated by at least one semiconducting material comprised in the sensor region, wherein a high-resistive material is present at a part of a surface of the semiconducting material, wherein the high-resistive material exhibits an electrical resistance which equals or exceeds the electrical resistance of the semiconducting material; and
generating at least one item of information on a longitudinal position of the object by evaluating the longitudinal sensor signal of the longitudinal optical sensor.

### EMBODIMENT 103

The use of a detector according to any of the preceding embodiments relating to a detector for a purpose of determining a position, in particular a depth of an object.

### EMBODIMENT 104

The use of a detector according to the previous embodiment, for a purpose of use, selected from the group consisting of: a distance measurement, in particular in traffic technology; a position measurement, in particular in traffic technology; an entertainment application; a security application; a human-machine interface application; a tracking application; a photography application; an imaging application or camera application; a mapping application for generating maps of at least one space; a homing or tracking beacon detector for vehicles; a distance and/or position measurement of objects with a thermal signature (hotter or colder than background); a machine vision application; a robotic application.

### BRIEF DESCRIPTION OF THE FIGURES

Further optional details and features of the invention are evident from the description of preferred exemplary embodiments which follows in conjunction with the dependent claims. In this context, the particular features may be implemented alone or with features in combination. The invention is not restricted to the exemplary embodiments. The exemplary embodiments are shown schematically in the figures. Identical reference numerals in the individual figures refer to identical elements or elements with identical function, or elements which correspond to one another with regard to their functions.

Specifically, in the figures:

FIG. 1 shows an exemplary embodiment of a detector comprising a longitudinal optical sensor having a sensor region according to the present invention;

FIGS. 2A and 2B show two different exemplary embodiments of the sensor region for the longitudinal optical sensor in the optical detector according to the present invention;

FIGS. 3A to 3C show a number of further exemplary embodiments of the sensor region for the longitudinal optical sensor in the optical detector according to the present invention;

FIGS. 4 A and 4B show a further exemplary embodiment of the sensor region for the longitudinal optical sensor in the optical detector according to the present invention;

FIGS. 5A to 5D show equivalent circuit diagrams being are intended for representing of the sensor region;

FIGS. 6A and 6B show calculated results (FIG. 6A) and experimental results (FIG. 6B) which demonstrate a dependency of the “FiP-effect” on a bias voltage across the sensor region;

FIG. 7 shows exemplary embodiments of a detector system, a camera, a human-machine interface, an entertainment device, and a tracking system, which comprise a detector according to the present invention; and

FIGS. 8A and 8B show a further exemplary embodiment of the sensor region for the longitudinal optical sensor in the optical detector according to the present invention.

### EXEMPLARY EMBODIMENTS

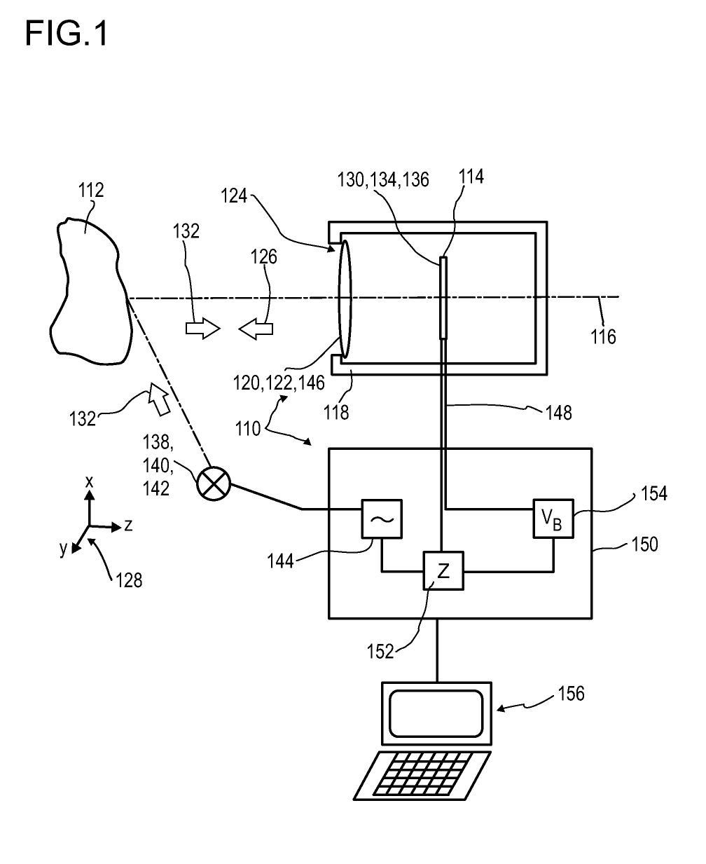

FIG. 1 illustrates, in a highly schematic illustration, an exemplary embodiment of an optical detector 110 according to the present invention, for determining a position of at least one object 112. The optical detector 110 comprises at least one longitudinal optical sensor 114, which, in this particular embodiment, is arranged along an optical axis 116 of the optical detector 110. Specifically, the optical axis 116 may be an axis of symmetry and/or rotation of the setup of the longitudinal optical sensors 114. The longitudinal optical sensors 114 may be located inside a housing 118 of the detector 110. Further, at least one transfer device 120 may be comprised, preferably a refractive lens 122. An opening 124 in the housing 118, which may, particularly, be located concentrically with regard to the optical axis 116, preferably defines a direction of view 126 of the detector 110. A coordinate system 128 may be defined, in which a direction parallel or antiparallel to the optical axis 116 is defined as a longitudinal direction, whereas directions perpendicular to the optical axis 116 may be defined as transversal directions. In the coordinate system 128, as symbolically depicted in FIG. 1, a longitudinal direction is denoted by z and transversal directions are denoted by x and y, respectively. However, other types of coordinate systems 128 are feasible.

Further, the longitudinal optical sensor 114 is designed to generate at least one longitudinal sensor signal in a manner dependent on an illumination of a sensor region 130 by a light beam 132. Thus, according to the FiP-effect, the longitudinal sensor signal, given the same total power of the illumination, is dependent on a beam cross-section of the light beam 132 in the respective sensor region 130, as will be outlined in further detail below. According to the present invention, the longitudinal sensor signal is generated by using at least one semiconducting material 134 comprised in the sensor region 130. As will be explained below in more detail, the semiconducting material 134 may, preferably, be provided in form of a semiconducting layer 136. However, other arrangements may also be feasible. Irrespective of a form selected for the semiconducting material 134, at least a part of a surface of the semiconducting material 134 experiences an electrical resistance which exhibits a value which exceeds the value of the electrical resistance of the semiconducting material 134. Particularly preferred arrangements which are employed in order to provide this specific feature will be presented below in more detail. Preferably, the sensor region 130 of the longitudinal optical sensor 114 may be transparent or translucent with respect to the light beam 132 travelling from the object 112 to the sensor region 130. However, the sensor region 130 of the longitudinal optical sensor 114 may also be intransparent, in particular in an embodiment in which the respective longitudinal optical sensor 114 may be a single longitudinal optical sensor 114 or may be a last longitudinal optical sensor 114 in a stack of longitudinal optical sensors 114.

The light beam 132 for illumining the sensor region 130 of the longitudinal optical sensor 114 may be generated by a light-emitting object 112. Alternatively or in addition, the light beam 132 may be generated by a separate illumination source 138, which may include an ambient light source and/or an artificial light source, such as a light-emitting diode 140, being adapted to illuminate the object 112 in a manner that the object 112 may be able to reflect at least a part of the light generated by the illumination source 138 such that the light beam 132 may be configured to reach the sensor region 130 of the longitudinal optical sensor 114, preferably by entering the housing 118 of the optical detector 110 through the opening 124 along the optical axis 116. In a specific embodiment, the illumination source 138 may be a modulated light source 142, wherein one or more modulation properties of the modulated light source 142 may be controlled by at least one optional modulation device 144. Alternatively or in addition, the modulation may be effected in a beam path between the illumination source 138 and the object 112 and/or between the object 112 and the longitudinal optical sensor 114, such as by employing a modulated transfer device 146. Further possibilities may be conceivable.

Via at least one signal lead 148, the longitudinal sensor signal may be transmitted to an evaluation device 150, which will be explained in further detail below. The evaluation device 150 is, generally, designed to generate at least one item of information on a longitudinal position of the object 112 by evaluating the longitudinal sensor signal of the longitudinal optical sensor 114. For this purpose, the evaluation device 150 may comprise one or more electronic devices and/or one or more software components, in order to evaluate the sensor signals, which are symbolically denoted by a longitudinal evaluation unit 152 (denoted by “z”). As will be explained below in more detail, the evaluation device 150 may be adapted to determine the at least one item of information on the longitudinal position of the object 112 by comparing more than one longitudinal sensor signals of the longitudinal optical sensor 114.

As explained above, the longitudinal sensor upon impingement by the light beam 132 of the longitudinal optical sensor 114 is generated by using the semiconducting material 134 in the sensor region 130, wherein at least a specific part of the surface of the semiconducting material 134 experiences an electrical resistance above the electrical resistance of the semiconducting material 134. In order to actually determine the longitudinal sensor signal as generated by the optical detector 110, the evaluation device 150 is adapted to measure one or more of an electrical resistance or a conductivity of at least one part of the sensor region via one or more of the at least one signal lead 148. In a particularly preferred embodiment, a bias voltage source 154 may also be provided which may be configured to provide a bias voltage to the semiconducting material 134 in the sensor region 130. As will be shown below, a variation of a value of the bias voltage may especially be employed for tuning the kind of the dependency of the longitudinal sensor signal on the beam cross-section of the light beam 132 in the sensor region 130.

Generally, the evaluation device 150 may be part of a data processing device 156 and/or may comprise one or more data processing devices 156. The evaluation device 150 may be fully or partially integrated into the housing 118 and/or may fully or partially be embodied as a separate device which is electrically connected in a wireless or, as depicted here in FIG. 1, in a wire-bound fashion to the longitudinal optical sensor 114. The evaluation device 150 may further comprise one or more additional components, such as one or more electronic hardware components and/or one or more software components, such as one or more measurement units and/or one or more evaluation units and/or one or more controlling units (not depicted in FIG. 1) and/or the modulation device 144 adapted to control the modulation properties of the modulated light source 142.

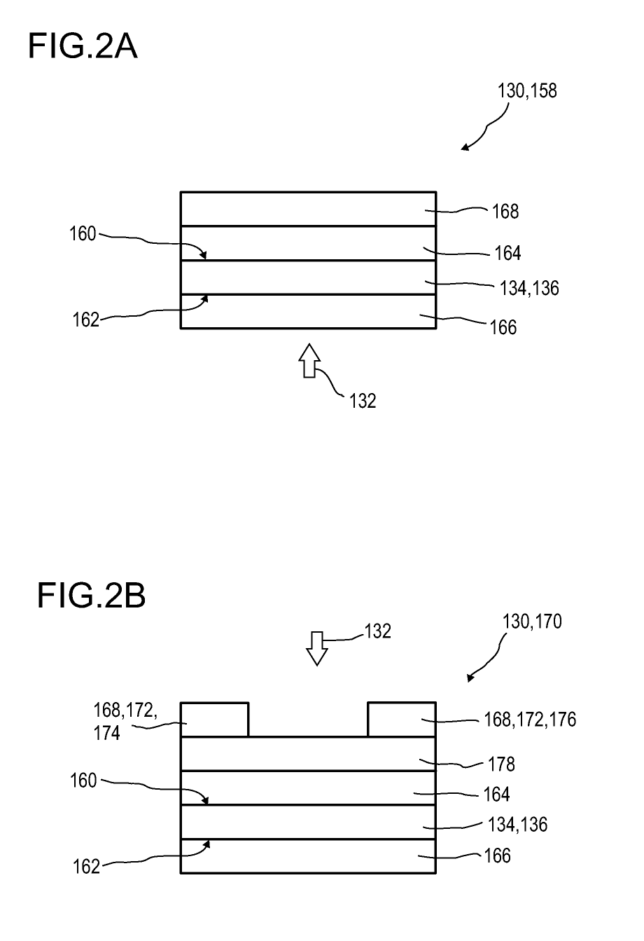

FIGS. 2 A to 4 present a number of exemplary embodiments of the longitudinal optical sensor 114 according to the present invention. However, further embodiments may be feasible, in particular such embodiments which may combine one or more features as presented in a first one of the mentioned Figures with other features as depicted in a second one of the mentioned Figures. Alternatively or in addition, suitable additional features which are known to the skilled person may be introduced in any one of the mentioned Figures.

In a basic embodiment as schematically displayed in FIG. 2A the longitudinal optical sensor 114 comprises a first electronic configuration 158 in the sensor region 130, wherein the first electronic configuration 158 comprises the semiconducting material 134 in the form of the semiconducting layer 136. As a consequence of this form, the semiconducting layer 136 comprises a first surface area 160 and a second surface area 162, wherein the first surface area 160 and the second surface area 162 are located on opposing sides of the laterally extended semiconducting layer 136. As schematically depicted in FIG. 2 A, the first surface area 160 of the semiconducting layer 136 is adjacent to a high-resistive layer 164, wherein the high-resistive layer 164 has a value for the electrical resistance which exceeds the value of the electrical resistance of the semiconducting layer 136. Consequently, in the first electronic configuration 158 the electrical resistance which shows a value above the value of the electrical resistance of the semiconducting material 134 is provided at the first surface area 160 of the semiconducting layer 136. As described above, this arrangement allows generating an additional electrical field within the semiconducting layer 136. Since the photocurrent in the sensor region 130 may be attributed to charge carriers within the semiconducting material 134, the additional electrical field may lead to a recombination of charge carriers, whereby the number of charge carriers available within the semiconducting layer 136 is diminished.

Consequently, in the area of the sensor region 130 which is illuminated by the incident light beam 132, the number of available charge carriers is reduced. Since the intensity of the additional electrical field within the semiconducting material 134 depends on the power of the illumination of the semiconducting layer 136, the intensity of the additional field per illuminated area increases with decreasing size of the illuminated area. As a result, the photocurrent in the semiconducting material 134 exhibits a dependency on the area in the sensor region 130 illuminated by the incident light beam 132, i.e. on a beam cross-section of the light beam 132 impinging onto the sensor region 130. Thus, given the same total power of the illumination, the longitudinal sensor signal which depends on the number of charge carriers in the semiconducting material 134, exhibits a dependency on the beam cross-section of the incident light beam 132 within the sensor region 130. This result, however, describes the desired FiP-effect observed in the optical detector 110 according to the present invention.

As further shown in FIG. 2A, the semiconducting layer 136 is embedded in the first electronic configuration 158 between a first electrode 166 and a second electrode 168 in a manner that the second surface area 162 is directly adjacent to the first electrode 166 while the first surface area 160 which is directly adjacent to the high-resistive layer 164 is, thus, only indirectly in the vicinity of the second electrode 168 since it is separated from the second electrode 168 by the high-resistive layer 164. According to their denomination, the electrical resistance of both the first electrode 166 and the second electrode 168 is below the electrical resistance of both the semiconducting layer 136 and the high-resistive layer 164, thus, allowing a high lateral conductivity within both electrode layers 166, 168. Further, both electrode layers 166, 168 are employed in measuring one or more of an electrical current or an electrical voltage across at least a part of the sensor region 130.

Therefore, suitable electrode materials which may be employed for the electrode layers 166, 168 may, thus, include metallic or semiconducting layers which exhibit the above-mentioned high values for the electrical resistance. However, in order to allow photons comprised in the incident light beam 132 to impinge on at the semiconducting layer 136 without experiencing a considerable loss, at least one of the electrodes 166, 168 may, preferably, be transparent with respect to a wavelength of the light beam 132. As shown in FIG. 2A, the incident light beam 132 may reach the first electronic configuration 158 by impinging on the first electrode 166 which is, in this specific embodiment, selected from an electrically highly conductive and simultaneously transparent substance, in particular from indium tin oxide (ITO, or tin-doped indium oxide). However, according to the actual wavelength of the incident light beam 132 other suitable materials may be selected as the electrode materials for one or both of the electrode layers 166, 168.

FIG. 2B schematically displays another embodiment in which the longitudinal optical sensor 114 comprises a second electronic configuration 170 in the sensor region 130. Similar to the first configuration 158, the second electronic configuration 170 comprises the semiconducting material 134 in the form of the semiconducting layer 136, having the first surface area 160 and the second surface area 162, wherein the first surface area 160 is adjacent to the high-resistive layer 164 and wherein the second surface area 162 is adjacent to the first electrode 166.

However, in contrast to the first configuration 158 according to FIG. 2A, in the second electronic configuration 170 as shown in FIG. 2B the second electrode 168 comprises a split electrode 172, wherein the split electrode 172 has at least two partial electrodes 174, 176. In addition, the second electronic configuration 170 comprises a medium-resistive layer 178 which is, preferably, located between the second electrode 168 and the high-resistive layer 164 in a manner that the at least two partial electrodes 174, 176 are applied on the same side of the medium-resistive layer 178. According to its denomination, the medium-resistive layer 178 is selected to have an electrical resistivity exceeding the electrical resistivity of the second electrode 168 but falling below the electrical resistivity of the high-resistive layer 164 and, thus, constituting a voltage divider between the partial electrodes 174, 176 of the split electrode 172. Since, as schematically depicted in FIG. 2B, the light beam 132 in the second electronic configuration 170 may impinge on the second electrode 168, the partial electrode 174, 176 may not be required to comprise a transparent electrode material whereas rather both the medium-resistive layer 178 and the high-resistive layer 164 may be selected for their transparent properties which may be intended for allowing the incident light beam 132 to reach the semiconducting material 134 in the semiconducting layer 136.

As a consequence of the second electronic configuration 170 as shown in FIG. 2B, the optical sensor 114 may be adapted to provide the longitudinal sensor signal and, in addition or alternatively, a transversal sensor signal. Whereas a sum of electrical currents through all the partial electrodes 174, 176 of the split electrode 172 may be taken into account for determining the longitudinal sensor signal in a manner as described elsewhere herein, a ratio in accordance with the electrical currents through at least two of the partial electrodes 174, 176 of the split electrode 172 may be used for generating the transversal sensor signal. Thus, the optical sensor 114 may simultaneously be adapted to determine a transversal position of the light beam 132 traveling from the object 110 to the sensor region 130, wherein the transversal position is a position in at least one dimension perpendicular to the optical axis 16 of the optical detector 110. Similar to the longitudinal sensor signal, the least one transversal sensor signal as generated by the optical sensor 114 may, thus, further be transmitted to the evaluation device 150 via the at least one signal lead 148. In addition, the evaluation device is further designed to generate at least one item of information on the transversal position of the object 112 by evaluating the transversal sensor signal, thereby taking into account the ratio of the electrical currents through the at least two partial electrodes 174, 176 of the split electrode 172.

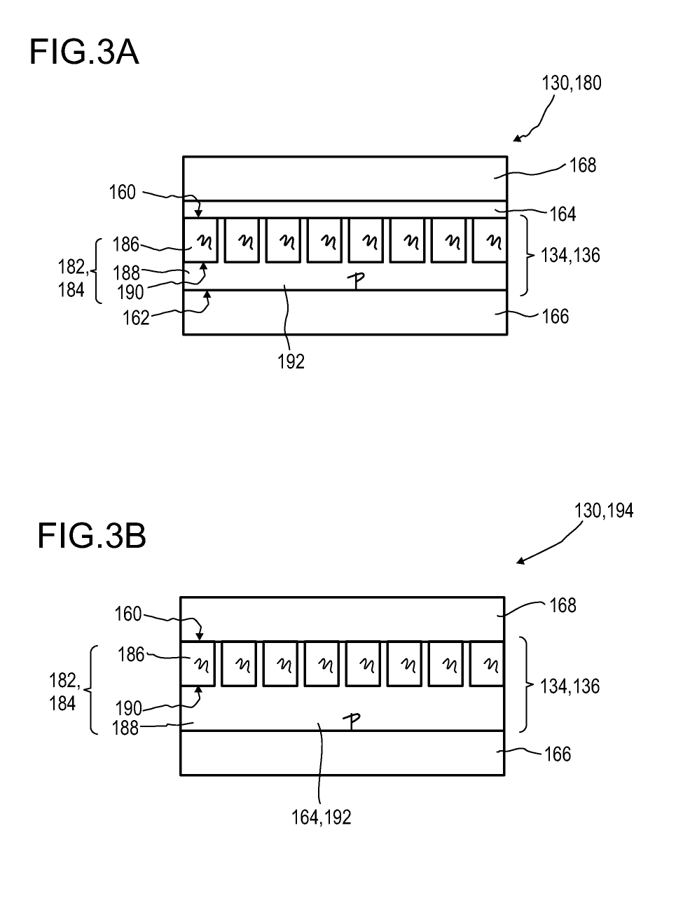

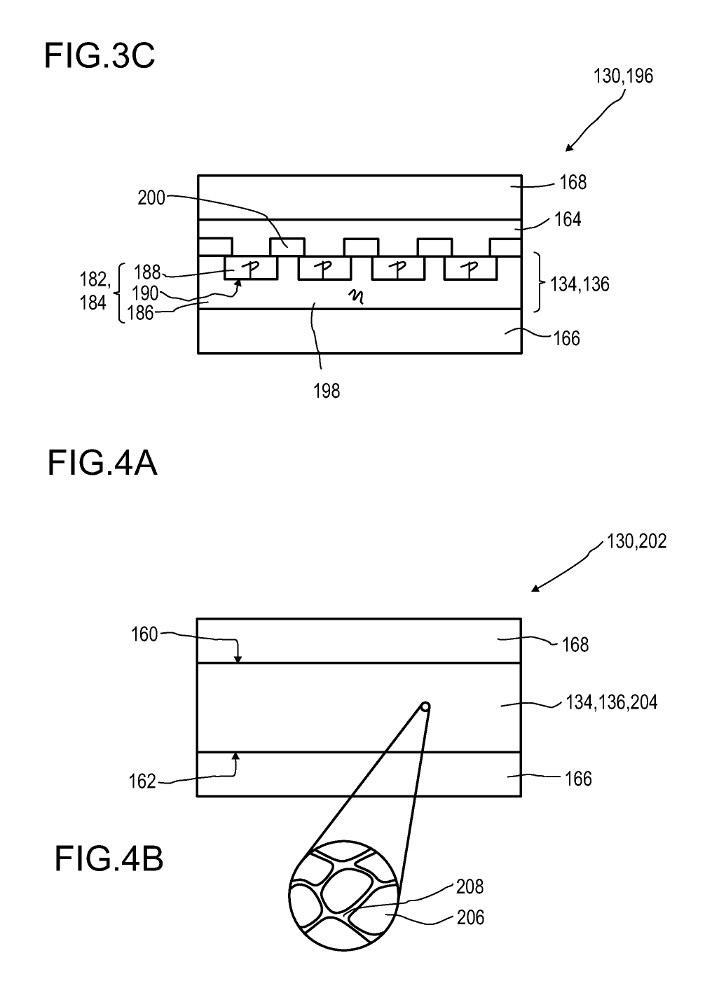

FIGS. 3A to 3C present further exemplary embodiments of the longitudinal optical sensor 114 according to the present invention. As schematically depicted in FIG. 3A, in a third electronic configuration 180 which may further be present within the sensor region 130 of the longitudinal optical sensor 114 and which is similar to the first electronic configuration 158 as shown in FIG. 1, the semiconducting material 134 in the semiconducting layer 136 may be arranged in a form of a diode array 182 of small area diodes 184. Herein, each diode 184 within the diode array 182 may comprise both an n-type semiconducting material 186 and a p-type semiconducting material 188 which may be separated by a junction 190, in particular by a p-n junction. In addition, an i-type semiconducting material (not depicted here) may further be located between the n-type semiconducting material 186 and the p-type semiconducting material 188. As further shown in FIG. 3B, the p-type semiconducting material 188 of two or more, such as all, of the diodes 184 within the diode array 182 might, preferably, be arranged in a manner that they may form a joint p-type semiconducting layer 192 which might be commonly used by the two or more, such as by all, of the diodes 184 within the diode array 182. Alternatively or in addition, the semiconducting material 134 within the semiconducting layer 136 might be arranged in a manner that it may comprise further electronic components, in particular one or more of bipolar transistors, field effect transistors, and charge coupled wells.

Similar to the basic embodiment as shown in FIG. 2A, the semiconducting layer 136 in the third electronic configuration 180 as depicted in FIG. 3A is embedded between the first electrode 166 and the second electrode 168 in a manner that the second surface area 162 of the semiconducting layer 136 is directly adjacent to the first electrode 166 while the first surface area 160 of the semiconducting layer 136 is directly adjacent to the high-resistive layer 164 which is, further, adjacent to the second electrode 168.

As shown in FIG. 3B, in a fourth electronic configuration 194 which may further be present within the sensor region 130 of the longitudinal optical sensor 114, the semiconducting material 134 in the semiconducting layer 136 may be arranged in a form of a diode array 182 of small area diodes 184 similar to the third electronic configuration 180 as depicted in FIG. 3A. However, in a case in which the electrical resistivity of the p-type semiconducting material 188 exceeds the electrical resistivity of the n-type semiconducting material 186, the joint p-type semiconducting layer 192, which may also here be commonly used by the two or more, such as by all, of the diodes 184 within the diode array 182, may, in addition, also be used as the high-resistive layer 164 of the fourth electronic configuration 194. The fourth electronic configuration 194 as depicted here in FIG. 3B may, thus, suggest an opportunity for providing an electronic configuration within the sensor region 130 of the optical detector 110 which may not comprise a separate high-resistive layer 164. As a result, the fourth electronic configuration 194 may this be produced with less effort, in particular due to a reduced number of different kinds of materials as employed within the device.

In both the third electronic configuration 180 and the fourth electronic configuration 194 the n-type semiconducting material 186 and of the p-type semiconducting material 188 within the semiconducting layer 136 may be arranged in an altered fashion, in particular in a reversed order, wherein the n-type semiconducting material 186 is located at the location of the p-type semiconducting material 188 as shown in FIGS. 3 A and 3B and vice-versa. Such an example is schematically depicted in a fifth electronic configuration 196 in FIG. 3C, wherein the n-type semiconducting material 186 of two or more, such as all, of the diodes 184 within the diode array 182 might, preferably, be arranged in a manner that they may form a joint n-type semiconducting layer 198 which might be commonly used by the two or more, such as by all, of the diodes 184 within the diode array 182.

On the contrary, the p-type semiconducting material 188 of each of the diodes 184 of the diode array 182 remains in a separate arrangement, wherein the separate arrangement is additionally ensured by further providing insulating pads 200, which may comprise an insulating material, such as silicon dioxide (SiO₂). Herein, the insulating pads 200 may provide an insulating barrier between the respective p-type semiconducting materials 188 of two adjacent diodes 184 within the diode array 182. As a result of the separate arrangement, a response of one of the diodes 184 could, preferably, be localized within the semiconducting layer 136 compared to a case without the separate arrangement in which the response of the diodes 184 within the diode array 182 might, on the other hand, be smeared over a larger area.

For further details concerning a feature in any one of FIGS. 3A to 3C reference may be made to any one of FIG. 2A or 2B.

FIGS. 4A and 4B schematically present a further exemplary embodiment of the longitudinal optical sensor 114 according to the present invention comprising a sixth electronic configuration 202. In the sixth electronic configuration 202, the semiconducting material 134 is arranged within the semiconducting layer 136 in a form of an amorphous semiconducting phase 204. As shown in FIG. 4A, the first surface area 160 of the semiconducting layer 136 is directly adjacent to the second electrode 168 while the second surface area 162 of the semiconducting layer 136 is directly adjacent to the first electrode 166. The enlarged segment in FIG. 4B emphasizes that the amorphous semiconducting phase 204 comprises semiconducting particles 206 which are, preferably, homogenous or crystalline and which are separated from each other by a high-resistive phase 208. Herein the high-resistive phase 208 provides the electrical resistance at the surface of the semiconducting particles 206 which exceeds the electrical resistance of the semiconducting material 134 within the bulk of the semiconducting particles 206. In addition, the sixth electronic configuration 202 may, in a further embodiment (not depicted here), additionally comprise a separate high-resistive layer 164 which may, similar to the depiction in FIG. 2A, be located between the semiconducting layer 136 and the second electrode 168. Alternatively, further embodiments in which the semiconducting layer 136 comprises the form of the amorphous semiconducting phase 204 may be feasible.

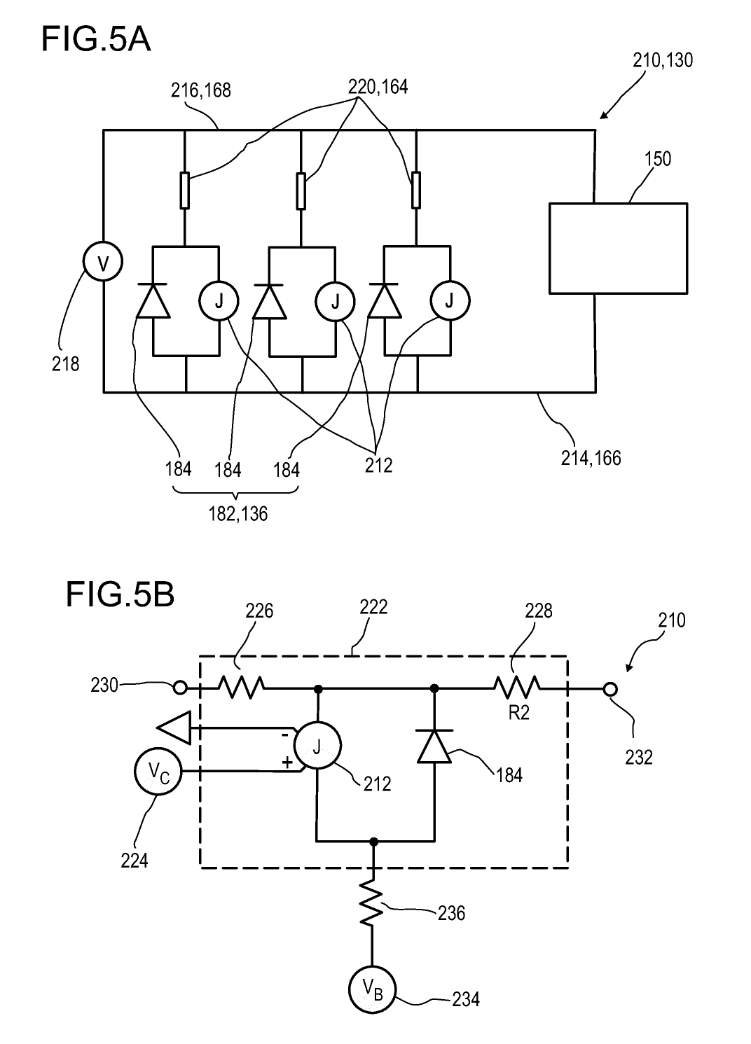

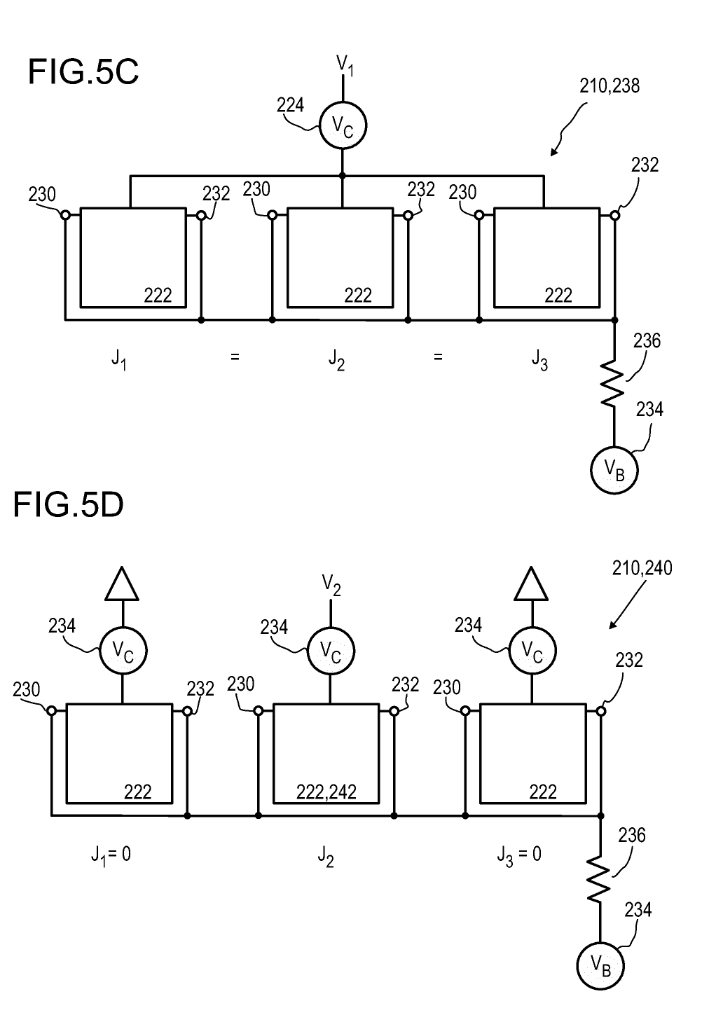

In particular in order to explain the underlying phenomena which are assumed to be at least predominantly involved in the present invention, FIG. 5A to 5D show diagrams comprising equivalent circuits 210 which are intended to represent at least a part of the sensor region 130.

As a preferred example, each of the diodes 184 within the diode array 182, which is, for example, known from FIG. 3A, are depicted by the common “diode symbol” in FIG. 5A. Herein, the three exemplary diodes 184 are placed in a linear, parallel arrangement within the equivalent circuit 210. In order to model the effect of the incident light beam 132 on diodes 184, a current source 212, also denoted by the symbol “J”, is connected in parallel with each of the three diodes 184. In order to model the basic embodiment as schematically shown in FIGS. 2A and 3A, the three diodes 184 within the diode array 182 which are intended to represent the semiconducting layer 136 are connected via first leads 214 and via second leads 216 with a voltage meter 218, wherein the first leads 214 represent the first electrode 166 while the second leads 216 represent the second electrode 168 of the basic embodiment. Further similar to the basic embodiment of both FIGS. 2A and 3A, each of the three diodes 184 each being arranged in parallel with the current source 212 is directly connected to the first leads 214, thus representing the fact that the semiconducting layer 136 is adjacent to the first electrode 166 in the equivalent circuit 210. In an analogous manner, each of the three diodes 184 each being arranged in parallel with the current source 212 is further connected to the second leads 216 via separate resistors 220, thus representing the fact that the semiconducting layer 136 is adjacent to the high-resistive layer 164 further being in the vicinity to the second electrode 168. As indicated here, the resistors 220 are used to model the high-resistive layer 164 within the equivalent circuit 210. Further in addition to the part the sensor region 130, the evaluation device 150 is shown here schematically.

Model simulations have been performed by using the equivalent circuit 210 of FIG. 5A which is shown in FIG. 5B with more details. Herein, only a single sensor element 222 of the sensor region 130, wherein the sensor element 222 is intended to cover an area of 100 μm×100 μm within the sensor region 130, is schematically represented by the single diode 184 being arranged in parallel with the current source 212. As shown in more detail, the current source 212 is driven by a control voltage Vc 224 which, thus, allows simulating different photocurrents within the semiconducting material 134 as comprised within the sensor element 222, such as in the sensor element 222 with the mentioned area of 100 μm×100 μm. In addition, a series resistance of the sensor element 222 may be modelled by using one or both of model resistors 226, 228. Desired simulation results may, thus, be acquired by recording at least one value for the longitudinal sensor signal as acquired by one or both of the left contact 230 and the right contact 232 of the equivalent circuit 210. Further, a bias voltage V_{B} 234 might be applied via a further resistor 236 to the equivalent circuit 210 of the sensor element 222.

By using the equivalent circuit 210 of FIGS. 5A and 5B, the following two different simulations have been performed.

In a first simulation, the same control voltage 234 having a value of V₁ has, as schematically depicted in FIG. 5C, been applied equally to all of the three separate sensor elements 222. Consequently, the same photocurrent J₁=J₂=J₃ has been simulated in each of the three separate sensor elements 222. By this way, a defocused situation 238 of the incident light beam 132 could be modelled, wherein the light beam 132 may impinge the sensor region 232 in a more or less homogeneous manner, thus generating a longitudinal sensor signal in each of the three separate sensor elements 222.

In a second simulation according to FIG. 5D, a focused situation 240 has been modelled on the other hand by applying the control voltage 234 having a value of V₂ only to the central sensor element 242, by which application the photocurrent J₂ may only be present in the central sensor element 242 while in the two other sensor elements 222 no photocurrent J₁=J₃=0 could be obtained. As a result, the simulation according to FIG. 5D models the focused situation 240 in which the incident light beam 132 may only generate a photocurrent and, thus, a longitudinal sensor signal, within the central sensor element 242 whereas no longitudinal sensor signal may be provided by the two other sensor elements 222. Therefore, this result models the focused situation 240 within the addressed part of the sensor region 130.

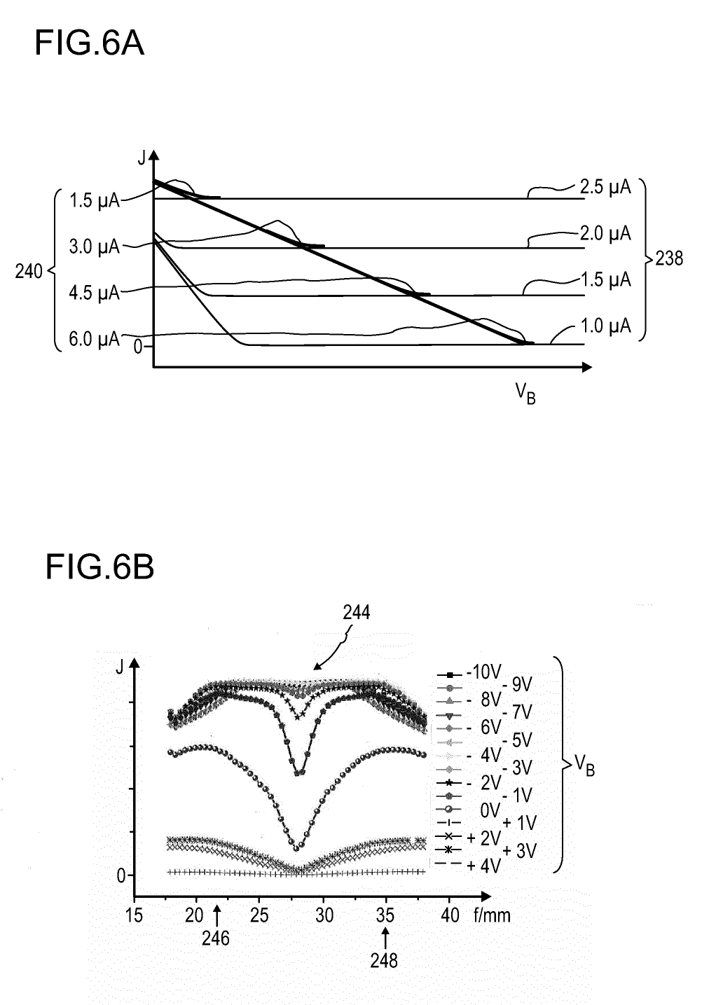

In FIG. 6A, results of the simulations which are based on the two different situations modelled according to the configurations as schematically depicted in FIGS. 5C and 5D are presented.

Accordingly, the value for the photocurrent J may depend on both a value selected for the control voltage V_{C}, whereby the occurrence of the defocused situation 238 or of the focused situation 240 has been adjusted, and a value which has been selected for the bias voltage V_{B}. Consequently, the simulation according to FIGS. 5A to 5D suggests that a device may be provided which may, depending on the detailed circumstances, allow the occurrence or the disappearance of the FiP-effect.

This result could experimentally be verified by using the optical detector 110 according to the present invention, such as the optical detector 110 as schematically depicted in FIG. 1. In particular, by employing the bias voltage source 154, the bias voltage V_{B} across the sensor region 130 could be varied for demonstrating the occurrence and the disappearance of the FiP-effect. As shown in FIG. 6B, a course 244 of the normalized photocurrent J as generated in the sensor region 130 of the optical detector 110 depends on value which has actually been selected for the bias voltage V_{B}. For a selected value of the bias voltage V_{B} across the sensor region 130, the focus of the refractive lens 122 has been varied and the corresponding photocurrent J has been recorded.

As can be derived from respective results as displayed in FIG. 6B, for the bias voltage V_{B}=−4 V no FiP-effect could be recorded. For this specific value of the bias voltage V_{B}, the course 244 does not exhibit any dependency of the normalized photocurrent J within the sensor region 130 on the focus of the refractive lens 122 and, thus, behaves in a manner as known from classical sensors as defined above. The only effect which can, nevertheless, be observed here is a decrease of the normalized photocurrent J below a first focus value 246 of approx. 22 mm and above a second focus value 248 of approx. 34 mm. This effect, however, reflects the spatial limits of the sensor region 130, wherein the area of the light spot exceeds the area of the entire sensor region 130 which, therefore, results in a decrease of intensity of the normalized photocurrent J. This decrease demonstrates that the device which has been used for this experiment can still be considered as a photodetector.

As can further be derived from FIG. 6B, for the other values of the selected bias voltages apart from V_{B}=−4 V, the FiP-effect can still be observed, in a most pronounced manner in a case in which the bias voltage was selected to be V_{B}=0 V. However, for different experiments different values for the described effects may be feasible. As defined above, a “negative FiP-effect” can be observed FIG. 6B. In correspondence to the definition of the positive FiP-effect, the negative FiP-effect describes an observation of a minimum of the longitudinal sensor signal when the sensor region is, as demonstrated here, impinged by the light beam 132 with the smallest available beam cross-section.

Consequently, selecting the value for the bias voltage V_{B} across the sensor region 130 the optical detector 110 according to the present invention allows shifting a threshold for the FiP-effect and, thus, adjusting the occurrence or the disappearance of the FiP-effect in an arbitrary manner. This effect may, as already described above, rather usefully be employed in a number of circumstances, in particular, in a situation in which the same optical detector 110 may be used under considerably different illumination conditions. Furthermore, as already described above, the optical detector 110 may also be employed for determining its baseline by varying the bias voltage accordingly. The baseline as derived in such a manner may, subsequently, be taken into account for an unambiguous determination of the longitudinal sensor signal by the allocation of the single longitudinal optical sensor 114.

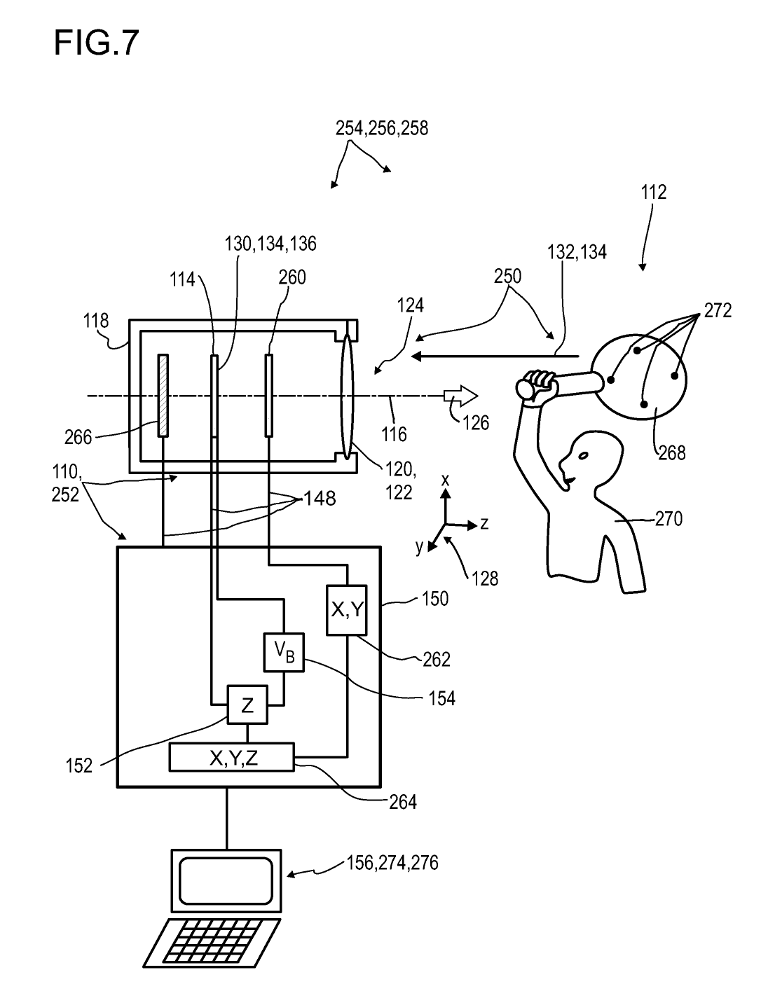

As an example, FIG. 7 shows an exemplary embodiment of a detector system 250, comprising at least one optical detector 110, such as the optical detector 110 as disclosed in one or more of the embodiments shown in FIGS. 1 to 6. Herein, the optical detector 110 may be employed as a camera 252, specifically for 3D imaging, which may be made for acquiring images and/or image sequences, such as digital video clips. Further, FIG. 7 shows an exemplary embodiment of a human-machine interface 254, which comprises the at least one detector 110 and/or the at least one detector system 250, and, further, an exemplary embodiment of an entertainment device 256 comprising the human-machine interface 254. FIG. 7 further shows an embodiment of a tracking system 258 adapted for tracking a position of at least one object 112, which comprises the detector 110 and/or the detector system 250.

With regard to the optical detector 110 and to the detector system 250, reference may be made to the full disclosure of this application. Basically, all potential embodiments of the detector 110 may also be embodied in the embodiment shown in FIG. 7. The evaluation device 150 may be connected to each of the at least two longitudinal optical sensors 114, in particular, by the signal leads 148. Further, a use of two or, preferably, three longitudinal optical sensors 114 may support the evaluation of the longitudinal sensor signals without any remaining ambiguity. However, as described above, by varying the bias voltage V_{B} across the sensor region 130, a single allocation of the longitudinal optical sensor 114 may be sufficient to determine the longitudinal sensor signals without ambiguity.

The evaluation device 150 may further be connected to the at least one optional transversal optical sensor 260, in particular, by the signal leads 148. By way of example, the signal leads 148 may be provided and/or one or more interfaces, which may be wireless interfaces and/or wire-bound interfaces. Further, the signal leads 148 may comprise one or more drivers and/or one or more measurement devices for generating sensor signals and/or for modifying sensor signals. Further, again, the at least one transfer device 120 may be provided, in particular as the refractive lens 122 or convex mirror. The optical detector 110 may further comprise the at least one housing 118 which, as an example, may encase one or more of components 114, 260.

Further, the evaluation device 150 may fully or partially be integrated into the optical sensors 114, 260 and/or into other components of the optical detector 110. The evaluation device 150 may also be enclosed into housing 118 and/or into a separate housing. The evaluation device 150 may comprise one or more electronic devices and/or one or more software components, in order to evaluate the sensor signals, which are symbolically denoted by the longitudinal evaluation unit 152 (denoted by “z”) and a transversal evaluation unit 262 (denoted by “xy”). By combining results derived by these evolution units 154, 156, a position information 264, preferably a three-dimensional position information, may be generated (denoted by “x, y, z”).

Similar to the embodiment according to FIG. 1, a bias voltage source 154 may be provided configured to provide a bias voltage V_{B}.

Further, the optical detector 110 and/or to the detector system 250 may comprise an imaging device 266 which may be configured in various ways. Thus, as depicted in FIG. 7, the imaging device 266 can for example be part of the detector 110 within the detector housing 118. Herein, the imaging device signal may be transmitted by one or more imaging device signal leads 148 to the evaluation device 150 of the detector 110. Alternatively, the imaging device 266 may be separately located outside the detector housing 118. The imaging device 266 may be fully or partially transparent or intransparent. The imaging device 266 may be or may comprise an organic imaging device or an inorganic imaging device. Preferably, the imaging device 266 may comprise at least one matrix of pixels, wherein the matrix of pixels may particularly be selected from the group consisting of: an inorganic semiconductor sensor device such as a CCD chip and/or a CMOS chip; an organic semiconductor sensor device.

In the exemplary embodiment as shown in FIG. 7, the object 112 to be detected, as an example, may be designed as an article of sports equipment and/or may form a control element 268, the position and/or orientation of which may be manipulated by a user 270. Thus, generally, in the embodiment shown in FIG. 7 or in any other embodiment of the detector system 250, the human-machine interface 254, the entertainment device 256 or the tracking system 258, the object 112 itself may be part of the named devices and, specifically, may comprise the at least one control element 268, specifically, wherein the at least one control element 268 has one or more beacon devices 272, wherein a position and/or orientation of the control element 268 preferably may be manipulated by user 270. As an example, the object 112 may be or may comprise one or more of a bat, a racket, a club or any other article of sports equipment and/or fake sports equipment. Other types of objects 112 are possible. Further, the user 270 may be considered as the object 112, the position of which shall be detected. As an example, the user 270 may carry one or more of the beacon devices 272 attached directly or indirectly to his or her body.

The optical detector 110 may be adapted to determine at least one item on a longitudinal position of one or more of the beacon devices 272 and, optionally, at least one item of information regarding a transversal position thereof, and/or at least one other item of information regarding the longitudinal position of the object 112 and, optionally, at least one item of information regarding a transversal position of the object 112. Particularly, the optical detector 110 may be adapted for identifying colors and/or for imaging the object 112, such as different colors of the object 112, more particularly, the color of the beacon devices 272 which might comprise different colors. The opening 124 in the housing 118, which, preferably, may be located concentrically with regard to the optical axis 116 of the detector 110, may preferably define a direction of a view 126 of the optical detector 110.

The optical detector 110 may be adapted for determining the position of the at least one object 112. Additionally, the optical detector 110, specifically an embodiment including the camera 252, may be adapted for acquiring at least one image of the object 112, preferably a 3D-image.

As outlined above, the determination of a position of the object 112 and/or a part thereof by using the optical detector 110 and/or the detector system 250 may be used for providing a human-machine interface 254, in order to provide at least one item of information to a machine 274. In the embodiments schematically depicted in FIG. 7, the machine 274 may be or may comprise at least one computer and/or a computer system comprising the data processing device 156. Other embodiments are feasible. The evaluation device 150 may be a computer and/or may comprise a computer and/or may fully or partially be embodied as a separate device and/or may fully or partially be integrated into the machine 274, particularly the computer. The same holds true for a track controller 276 of the tracking system 258, which may fully or partially form a part of the evaluation device 150 and/or the machine 274.

Similarly, as outlined above, the human-machine interface 254 may form part of the entertainment device 256. Thus, by means of the user 270 functioning as the object 112 and/or by means of the user 270 handling the object 112 and/or the control element 268 functioning as the object 112, the user 270 may input at least one item of information, such as at least one control command, into the machine 274, particularly the computer, thereby varying the entertainment function, such as controlling the course of a computer game.

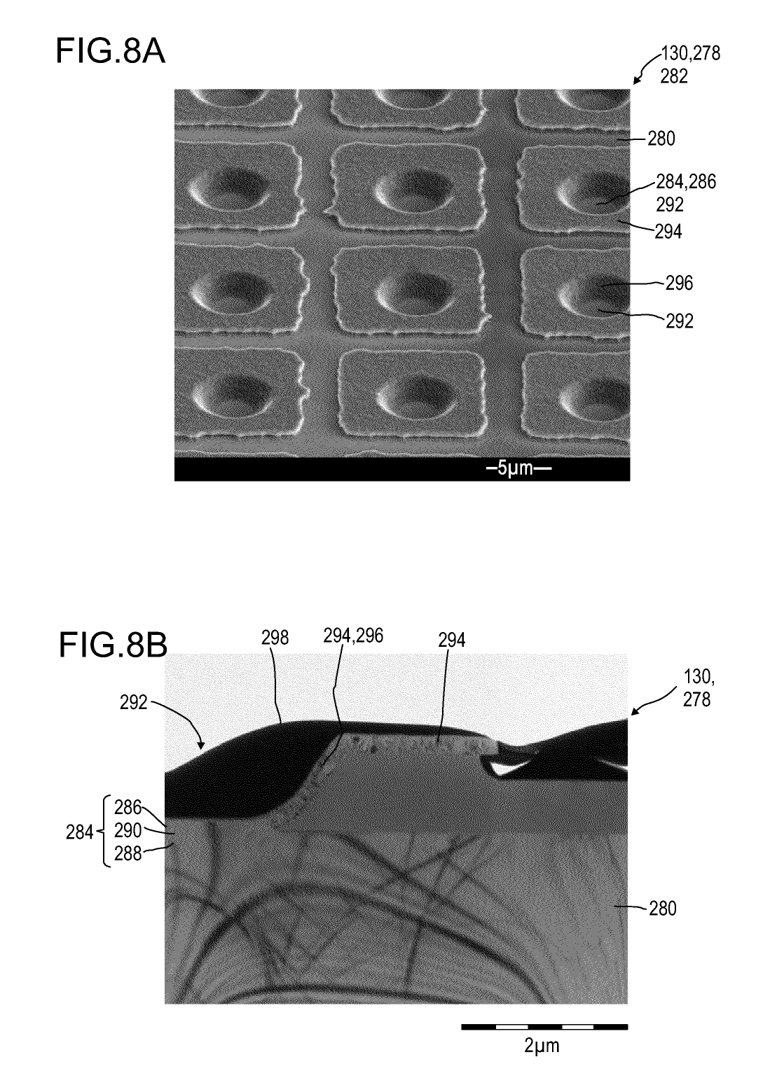

FIGS. 8A and 8B present further exemplary embodiments of the longitudinal optical sensor 114 according to the present invention. Herein, FIGS. 8A and 8B show SEM images as an aerial view (FIG. 8A) and as a lateral focused ion beam cut (FIG. 8B), respectively, of a seventh electronic configuration 278 that may further be present within the sensor region 130 of the longitudinal optical sensor 114.

In this particular embodiment, an insulating layer 280 comprises the insulating material silicon dioxide (SiO₂) as a substrate. On top of the insulating layer 280 a diode array 282 of small area diodes 284 is located in a manner that adjacent small area diodes 284 are separated by the insulating layer 280. As can, particularly, be derived from FIG. 8B, each diode 284 within the diode array 282 comprises both a p-type semiconducting material 286 and an n-type semiconducting material 288 which are, additionally, separated by a junction 290, in particular by a p-n junction. In addition, an i-type semiconducting material (not depicted here) may further be located between the p-type semiconducting material 286 and the n-type semiconducting material 288. It may be noted here that the p-type semiconducting material 286 and the n-type semiconducting material 288 are hardly distinguishable in the SEM image of FIG. 8B since they comprise silicon as the same semiconducting base material while they only differ by their respective kind of doping which, typically, results in a hardly observable effect in the SEM. It may further be noted that, due to geometrical considerations, only the p-type semiconducting material 286 which completely covers the n-type semiconducting material 288 on the bottom of wells 292 of the small area diodes 284 is visible in the aerial view of FIG. 8A.

Further, a highly conductive layer 294 which, in this particular embodiment, comprises polycrystalline silicon (Si) may cover sides 296 of the wells 292 and may, further, surround the wells 292 at a top surface of the insulating layer 280. Thus, this particular embodiment may, preferably, allow receiving an electrically conducting beam, in particular a beam of electrically conducting particles, preferably electrons, which may impinge on the sensor region 130 and may, thereby, be capable of generating an electrical contact between the electrically conducting beam and the small area diodes 284 within the diode array 282. By providing this electrical contact to the small area diodes 284, the electrically conducting beam may, similarly, act as a means for transporting at least a part of the longitudinal sensor signal from the sensor region 282 to the evaluation device 150. Herein, the extended form of the highly conductive layer 294 with respect to the wells 292 in the arrangement as illustrated in FIG. 8A may, particularly, be adapted in order to contribute to enhancing an opportunity of the electrically conducting beam to actually achieving the electrical contact with the small area diodes 284. Further, FIG. 8B shows a coating 298 comprising platinum (Pt) which may be required here for recording the corresponding SEM image.

As outlined above, the optical detector 110 may have a straight beam path or a tilted beam path, an angulated beam path, a branched beam path, a deflected or split beam path or other types of beam paths. Further, the light beam 132 may propagate along each beam path or partial beam path once or repeatedly, unidirectionally or bidirectionally. Thereby, the components listed above or the optional further components listed in further detail below may fully or partially be located in front of the longitudinal optical sensors 114 and/or behind the longitudinal optical sensors 114.

### LIST OF REFERENCE NUMBERS

110 detector
112 object
114 longitudinal optical sensor
116 optical axis
118 housing
120 transfer device
122 refractive lens
124 opening
126 direction of view
128 coordinate system
130 sensor region
132 light beam
134 semiconducting material
136 semiconducting layer
138 illumination source
140 light-emitting diode
142 modulated illumination source
144 modulation device
146 modulated transfer device
148 signal leads
150 evaluation device
152 longitudinal evaluation unit
154 bias voltage source
156 data processing device
158 first electronic configuration
160 first surface area
162 second surface area
164 high-resistive layer
166 first electrode
168 second electrode
170 second electronic configuration
172 split electrode
174 first partial electrode
176 second partial electrode
178 medium-resistive layer
180 third electronic configuration
182 diode
184 diode array
186 n-type semiconducting material
188 p-type semiconducting material
190 junction (p-n junction)
192 p-type semiconducting layer
194 fourth electronic configuration
196 fifth electronic configuration
198 n-type semiconducting layer
200 insulating pads
202 sixth electronic configuration
204 amorphous semiconducting phase
206 semiconducting particles
208 high-resistive phase
210 equivalent circuit
212 current source
214 first leads
216 second leads
218 voltage meter V
220 resistor
222 sensor element
224 control voltage V_{C}
226 resistor
228 resistor
230 left contact
232 right contact
234 bias voltage V_{B}
236 resistor
238 defocused condition
240 focused condition
242 central sensor element
244 course of normalized photocurrent J
246 first focus value
248 second focus value
250 detector system
252 camera
254 human-machine interface
256 entertainment device
258 tracking system
260 transversal optical sensor
262 transversal evaluation unit
264 position information
266 imaging device
268 control element
270 user
272 beacon device
274 machine
276 track controller
278 seventh electronic configuration
280 insulating layer
282 diode array
284 diode
286 p-type semiconducting material
288 n-type semiconducting material
290 junction (p-n junction)
292 well
294 highly conductive layer
296 side
298 coating

1. A detector for an optical detection of at least one object, comprising:
at least one longitudinal optical sensor, wherein the longitudinal optical sensor has at least one sensor region, wherein the longitudinal optical sensor is designed to generate at least one longitudinal sensor signal in a manner dependent on an illumination of the sensor region by a light beam, wherein the longitudinal sensor signal, given the same total power of the illumination, exhibits a dependency on a beam cross-section of the light beam in the sensor region, wherein the longitudinal sensor signal is generated by at least one semiconducting material comprised in the sensor region, wherein a high-resistive material is present at a part of a surface of the semiconducting material, wherein the high-resistive material exhibits an electrical resistance which equals or exceeds the electrical resistance of the semiconducting material; and
at least one evaluation device, wherein the evaluation device is designed to generate at least one item of information on a longitudinal position of the object by evaluating the longitudinal sensor signal of the longitudinal optical sensor.

2. The detector according to claim 1, wherein the high-resistive material is separated from the semiconducting material by at least one of a boundary, an interface and/or a junction, and/or, wherein at least one of the boundary, the interface and/or the junction comprises the high-resistive material.

3. The detector according to claim 1, wherein the semiconducting material is in the form of a semiconducting layer wherein the semiconducting layer comprises two opposing surface areas.

4. The detector according to claim 3, wherein the semiconducting layer comprises semiconducting microcrystalline needles, wherein at least a part of the needles are oriented perpendicular to the two surface areas of the semiconducting layer.

5. The detector according to claim 3, wherein at least one of the two surface areas of the semiconducting layer is adjacent to a high-resistive layer, wherein the electrical resistance of the high-resistive layer exceeds the electrical resistance of the adjacent semiconducting layer.

6. The detector according to claim 3, wherein at least one of the two surface areas of the semiconducting layer is adjacent to a metal layer, wherein a high-resistive depletion zone is present between the semiconducting layer and the adjacent metal layer.

7. The detector according to claim 2, wherein the semiconducting material comprises at least one n-type semiconducting material and at least one p-type semiconducting material, wherein the at least one junction is located between the n-type semiconducting material and the p-type semiconducting material.

8. The detector according to claim 7, wherein an i-type semiconducting material is located at the junction between the n-type semiconducting material and the p-type semiconducting material.

9. The detector according to claim 7, wherein a plurality of junctions is located within the semiconducting material.

10. The detector according to claim 7, wherein two adjacent junctions are separated by an insulating layer.

11. The detector according to claim 5, wherein the semiconducting layer is embedded between at least two electrode layers.

12. The detector according to claim 11, wherein a bias voltage is applied across the two electrode layers.

13. The detector according to claim 12, wherein the bias voltage is configured for tuning the dependency of the longitudinal sensor signal on the beam cross-section of the light beam in the sensor region.

14. The detector according to claim 11, wherein the one of the two surface areas of the semiconducting layer is adjacent to the high-resistive layer and the other of the two surface areas of the semiconducting layer is adjacent to one of the two electrode layers.

15. The detector according to claim 14, wherein the high-resistive layer is adjacent to the other of the two electrode layers.

16. The detector according to claim 11, wherein one of the two electrode layers is a split electrode, wherein the split electrode comprises at least two separate partial electrodes.

17. The detector according to claim 16, wherein the at least two partial electrodes are arranged at different locations on a medium-resistive layer, wherein the medium resistive layer is adjacent to the high-resistive layer, wherein the electrical resistivity of the medium-resistive layer exceeds the electrical resistivity of the partial electrode but falls below the electrical resistivity of the high-resistive layer.

18. The detector according to claim 17, wherein the at least two partial electrodes are applied on the same side of the medium-resistive layer.

19. The detector according to claim 16, wherein the at least two partial electrodes are used as a transversal optical sensor, the transversal optical sensor being adapted to determine a transversal position of the light beam traveling from the object to the detector, the transversal position being a position in at least one dimension perpendicular an optical axis of the detector, the transversal optical sensor being adapted to generate at least one transversal sensor signal, wherein the evaluation device is further designed to generate at least one item of information on a transversal position of the object by evaluating the transversal sensor signal.

20. The detector according to claim 1, wherein the semiconducting material is in the form of a semiconducting monocrystalline, amorphous, nanocrystalline or microcrystalline phase, wherein the semiconducting phase comprises semiconducting particles, wherein a part of a surface of the semiconducting particles is covered by a high-resistive coating, wherein the electrical resistance of the high-resistive coating exceeds the electrical resistance of the semiconducting particles.

21. The detector according to claim 20, wherein the semiconducting phase comprises monocrystalline, amorphous, nanocrystalline or microcrystalline silicon.

22. The detector according to claim 1, wherein the light beam is a non-modulated continuous-wave light beam.

23. The detector according to claim 1, further comprising at least one illumination source.

24. The detector according to claim 1, further comprising at least one imaging device.

25. A camera for imaging at least one object, the camera comprising at least one detector according to claim 1.

26. A human-machine interface for exchanging at least one item of information between a user and a machine, wherein the human-machine interface comprises at least one detector according to claim 1, wherein the human-machine interface is designed to generate at least one item of geometrical information of the user with the detector, wherein the human-machine interface is designed to assign to the geometrical information at least one item of information.

27. An entertainment device for carrying out at least one entertainment function, wherein the entertainment device comprises at least one human-machine interface according to claim 26, wherein the entertainment device is designed to enable at least one item of information to be input by a user with the human-machine interface, wherein the entertainment device is designed to vary the entertainment function in accordance with the information.

28. A tracking system for tracking the position of at least one movable object, the tracking system comprising at least one detector according to claim 1, the tracking system further comprising at least one track controller, wherein the track controller is adapted to track a series of positions of the object, each position comprising at least one item of information on at least a longitudinal position of the object at a specific point in time.

29. A scanning system for determining at least one position of at least one object, the scanning system comprising at least one detector according to claim 1, the scanning system further comprising at least one illumination source adapted to emit at least one light beam configured for an illumination of at least one dot located at at least one surface of the at least one object, wherein the scanning system is designed to generate at least one item of information about the distance between the at least one dot and the scanning system by using the at least one detector.

30. A method for an optical detection of at least one object, the method comprising:
generating at least one longitudinal sensor signal with at least one longitudinal optical sensor, wherein the longitudinal sensor signal is dependent on an illumination of a sensor region of the longitudinal optical sensor by a light beam, wherein the longitudinal sensor signal, given the same total power of the illumination, is dependent on a beam cross-section of the light beam in the sensor region, wherein the longitudinal sensor signal is generated by at least one semiconducting material comprised in the sensor region, wherein a high-resistive material is present at a part of a surface of the semiconducting material, wherein the high-resistive material exhibits an electrical resistance which equals or exceeds the electrical resistance of the semiconducting material; and
generating at least one item of information on a longitudinal position of the object by evaluating the longitudinal sensor signal of the longitudinal optical sensor.

31. A detection method, comprising detecting with the detector according to claim 1 in at least one application selected from the group consisting of: a distance measurement; a position measurement; an entertainment application; a security application; a human-machine interface application; a tracking application; a photography application; an imaging application or camera application; a mapping application for generating maps of at least one space; a homing or tracking beacon detector for vehicles; a distance and/or position measurement of objects with a thermal signature; a machine vision application; and a robotic application.
